(19) United States
(12) Patent Application Publication
(10) Pub. No.: US 2024/0259083 A1
(43) Pub. Date: Aug. 1, 2024

(54) COMMUNICATION METHOD AND APPARATUS

(71) Applicant: HUAWEI TECHNOLOGIES CO., LTD., Shenzhen (CN)

(72) Inventors: Yue ZHOU, Shenzhen (CN); Ying CHEN, Hangzhou (CN); Hejia LUO, Hangzhou (CN)

(21) Appl. No.: 18/619,573

(22) Filed: Mar. 28, 2024

Related U.S. Application Data
(63) Continuation of application No. PCT/CN2022/120882, filed on Sep. 23, 2022.

(30) Foreign Application Priority Data
Sep. 30, 2021 (CN) 202111166020.2

(51) Int. Cl. H04B 7/10; H04W 72/044; H04W 72/231; H04W 72/232

(52) U.S. Cl. CPC H04B 7/10; H04W 72/046; H04W 72/231; H04W 72/232

(57) ABSTRACT

Communication methods and apparatus are provided. A communication method includes: A second communication apparatus determines second indication information, and sends the second indication information, wherein the second indication information indicates a polarization manner of a neighboring cell of a cell in which a first communication apparatus in an inactive state is located, and the polarization manner of the neighboring cell comprises one or more of left hand circular polarization, right hand circular polarization, linear polarization, or cross polarization multiplexing.

### CROSS-REFERENCE TO RELATED APPLICATIONS

This application is a continuation of International Application No. PCT/CN2022/120882, filed on Sep. 23, 2022, which claims priority to Chinese Patent Application No. 202111166020.2, filed on June Sep. 30, 2021. The disclosures of the aforementioned applications are hereby incorporated by reference in their entireties.

### TECHNICAL FIELD

This application relates to the field of communication technologies, and in particular, to a communication method and apparatus.

### BACKGROUND

In response to an electromagnetic wave being propagated in space, in response to a direction of an electric field vector being fixed or rotated according to a specific rule, the electromagnetic wave is referred to as a polarized electromagnetic wave. In response to the direction of the electric field vector of the electromagnetic wave being perpendicular to a horizontal plane, the electromagnetic wave is referred to as a vertically polarized electromagnetic wave; or in response to the direction of the electric field vector of the electromagnetic wave being parallel to the horizontal plane, the electromagnetic wave is referred to as a horizontally polarized electromagnetic wave; or in response to the electric field vector of the electromagnetic wave changing to form a circle, the electromagnetic wave is referred to as a circularly polarized electromagnetic wave. As shown in FIG. 1, the circularly polarized electromagnetic wave is classified into a left hand circularly polarized (LHCP) electromagnetic wave and a right hand circularly polarized (RHCP) electromagnetic wave based on a rotation direction of the circle formed by change of the electric field vector of the electromagnetic wave.

In a communication system, according to a polarization direction of an electromagnetic wave transmitted between devices, two devices communicate with each other in different polarization manners. For example, a network device and a terminal device communicate with each other in a vertical polarization manner, which specifically means that an electromagnetic wave transmitted between the network device and the terminal device is a vertically polarized electromagnetic wave.

Currently, in a process in which a network device schedules a polarization manner of a terminal device in a cell (cell), scheduling is still inflexible and spectral efficiency is low. Therefore, the process of scheduling the polarization manner of the terminal device is to be further optimized.

### SUMMARY

Embodiments described herein provide a communication method and apparatus, so that scheduling of a polarization manner is more flexible, thereby improving spectral efficiency.

To achieve the foregoing objectives, at least one embodiment uses the following technical solutions.

According to a first aspect, at least one embodiment provides a communication method. The method is applied to a second communication apparatus. The second communication apparatus is, for example, a network device. The network device is, for example, an access network device (for example, a base station or a satellite). The communication method includes: The second communication apparatus determines first indication information, and sends the first indication information, where the first indication information is carried in terminal-level information, the first indication information indicates a first polarization manner of a first communication apparatus, and the first polarization manner includes any one of left hand circular polarization, right hand circular polarization, linear polarization, or cross polarization multiplexing.

With reference to the communication method in the first aspect, the first indication information is used to schedule the polarization manner of the first communication apparatus and is carried in the terminal-level information, such as radio resource control (RRC) signaling and downlink control information (DCI). In this way, the second communication apparatus schedules the polarization manner of the first communication apparatus at a terminal level, that is, the second communication apparatus adjusts a polarization manner of the first communication apparatus, so that scheduling of the polarization manner of the first communication apparatus is more flexible, and a scheduling granularity is finer, thereby improving spectral efficiency.

The terminal-level information is also referred to as terminal-level signaling, or referred to as user equipment specific (UE specific) signaling, or referred to as UE-level information, or a similar concept. This is not limited in at least one embodiment.

In at least one embodiment, the communication method according to the first aspect further includes: The second communication apparatus determines second indication information, and sends the second indication information, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing. In this way, based on the second indication information, the first communication apparatus obtains the polarization manner of the neighboring cell in advance, that is, obtains, in advance, the polarization manner used in response to signal quality of the neighboring cell being measured. In this case, during cell handover, the first communication apparatus measures the signal quality of the neighboring cell based on the polarization manner of the neighboring cell indicated by the second indication information, and then implement cell handover. This improves a cell handover success rate, avoid requesting the polarization manner of the neighboring cell again from the second communication apparatus during handover, and accelerate cell handover.

Linear polarization includes any one of horizontal polarization, vertical polarization, +450 polarization, and −45° polarization. Cross polarization multiplexing includes any one of horizontal and vertical cross polarization multiplexing, ±45° cross polarization multiplexing, and left hand circular polarization and right hand circular polarization cross polarization multiplexing (LHCP & RHCP Multiplexing). In other words, the first polarization manner includes any one of left hand circular polarization, right hand circular polarization, horizontal polarization, vertical polarization, +45° polarization, −45° polarization, horizontal and vertical cross polarization multiplexing, ±45° cross polarization multiplexing, and left hand circular polarization and right hand circular polarization cross polarization multiplexing. In addition, elements included in the polarization manner, of the neighboring cell, indicated by the second indication information are the same as those included in the first polarization manner. Details are not described herein again.

Optionally, the second indication information further indicates a polarization manner of a neighboring cell of a cell in which the first communication apparatus in a first status is located, the first status includes a connected (connected) state or an inactive (inactive) state, and the second indication information is carried in terminal-level information. In this way, based on the second indication information, the first communication apparatus in the connected state or the inactive state obtains the polarization manner of the neighboring cell in advance, that is, obtains, in advance, the polarization manner used in response to signal quality of the neighboring cell being measured. In this case, during cell handover, the first communication apparatus measures the signal quality of the neighboring cell based on the polarization manner of the neighboring cell indicated by the second indication information, and then implement cell handover. This improves a cell handover success rate, avoid requesting the polarization manner of the neighboring cell again from the second communication apparatus during handover, and accelerate cell handover.

Optionally, the second indication information further indicates a polarization manner of a neighboring cell of a cell in which the first communication apparatus in a second status is located, the second status includes an inactive state or an idle (idle) state, and the second indication information is carried in cell-level information. In this way, based on the second indication information, the first communication apparatus in the inactive state or the idle state obtains the polarization manner of the neighboring cell in advance, that is, obtains, in advance, the polarization manner used in response to signal quality of the neighboring cell being measured. In this case, during cell reselection, the first communication apparatus measures the signal quality of the neighboring cell based on the polarization manner of the neighboring cell indicated by the second indication information, and then implement cell reselection. This improves a cell reselection success rate, avoid requesting the polarization manner of the neighboring cell from the second communication apparatus again during reselection, and accelerates cell reselection. Optionally, the cell-level information is a system information block (SIB).

In at least one embodiment, the first indication information includes a mapping relationship between a plurality of synchronization signal and physical broadcast channel block (SSB) indexes (indexes) and a plurality of polarization manners. In other words, the second communication apparatus configures a correspondence between an SSB index and a polarization manner for the first communication apparatus in advance, and the second communication apparatus further implicitly indicates the polarization manner of the first communication apparatus by using the SSB index. This further simplifies complexity of indicating the polarization manner of the first communication apparatus by the second communication apparatus.

In at least one embodiment, the first indication information further indicates duration of the first polarization manner. In other words, the second communication apparatus indicates duration in which the first communication apparatus works in the first polarization manner. After the duration indicated by the first indication information expires, the first communication apparatus restores to a previous polarization manner. In this way, the second communication apparatus no longer indicates, by using one piece of indication signaling, the first communication apparatus to restore to the previous polarization manner. This reduces signaling overheads, avoid that the second communication apparatus waits for a long time for feedback, from the first communication apparatus, of the indication signaling, and further improve flexibility of scheduling the polarization manner of the first communication apparatus.

In at least one embodiment, the first indication information is determined based on one or more of the following: a polarization manner supported by the first communication apparatus, channel state information (CSI) of channels in different polarization manners measured by the first communication apparatus, a service usage of the first communication apparatus, a polarization manner expected by the first communication apparatus, a weather condition between the first communication apparatus and the second communication apparatus, or a crosstalk (crosstalk) status between orthogonally polarized channels. In this way, the second communication apparatus determines, with reference to a plurality of types of information, a polarization manner that is more appropriate for the first communication apparatus, and schedule the polarization manner for the first communication apparatus by using the first indication information. This enables, in one aspect, the first communication apparatus to work in a better polarization manner, and improve communication quality, and reduce power consumption, in another aspect, scheduling of the polarization manner of the first communication apparatus is more flexible, and a scheduling granularity is finer, thereby improving spectral efficiency.

In at least one embodiment, the terminal-level information is RRC signaling.

Optionally, the terminal-level information is alternatively any one of a media access control control element (MAC CE), a channel state information reference signal (CSI-RS), DCI, or the like.

In at least one embodiment, the first indication information is one or more of a carrier (carrier) of the CSI-RS, and a resource element (resource element, RE), and the one or more of the carrier and the resource element indicate the first polarization manner. The carrier is also understood as a carrier wave, and this is not limited herein.

In at least one embodiment, the communication method according to the first aspect further includes: The second communication apparatus determines third indication information, and sends the third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing. In this way, based on the third indication information, the first communication apparatus obtains the polarization manner of the adjacent beam in advance, that is, obtains, in advance, the polarization manner used in response to signal quality of the adjacent beam is measured. Therefore, during beam handover, the first communication apparatus measures the signal quality of the adjacent beam based on the polarization manner of the adjacent beam indicated by the third indication information, and then implements beam handover. This improves a beam handover success rate, avoid requesting the polarization manner of the adjacent beam from the second communication apparatus during handover, and accelerate beam handover.

In at least one embodiment, the first indication information indicates a first polarization manner corresponding to a first resource of the first communication apparatus, and the first resource includes a time-frequency domain resource. In this way, resource elements corresponding to different polarization manners but have a same time-frequency resource is allocated to different first communication apparatuses. This avoids interference between the communication apparatuses, improves resource utilization, improves communication efficiency, and improves resource scheduling flexibility.

According to a second aspect, at least one embodiment provides a communication method. The method is applied to a first communication apparatus. The first communication apparatus is, for example, a terminal device. The terminal device is, for example, a mobile phone, a car, or an internet of things (IoT) device. The communication method includes: The first communication apparatus receives first indication information from a second communication apparatus, where the first indication information indicates a first polarization manner of the first communication apparatus, the first polarization manner includes any one of left hand circular polarization, right hand circular polarization, linear polarization, or cross polarization multiplexing, and the first indication information is carried in terminal-level information. The first communication apparatus communicates with the second communication apparatus based on the first polarization manner.

In at least one embodiment, the communication method according to the second aspect further includes: The first communication apparatus receives second indication information from the second communication apparatus, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information. Optionally, the cell-level information is an SIB.

In at least one embodiment, the first indication information includes a mapping relationship between a plurality of SSB indexes and a plurality of polarization manners.

In at least one embodiment, the first indication information further indicates duration of the first polarization manner.

In at least one embodiment, the first indication information is determined based on one or more of the following: a polarization manner supported by the first communication apparatus, channel state information of channels in different polarization manners measured by the first communication apparatus, a service usage of the first communication apparatus, a polarization manner expected by the first communication apparatus, a weather condition between the first communication apparatus and the second communication apparatus, or a crosstalk status between orthogonally polarized channels.

In at least one embodiment, the terminal-level information is RRC signaling.

Optionally, the terminal-level information is alternatively any one of a MAC CE, a CSI-RS, DCI, or the like.

In at least one embodiment, the communication method according to the second aspect further includes: The first communication apparatus receives third indication information from the second communication apparatus, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing.

In at least one embodiment, the first indication information indicates a first polarization manner corresponding to a first resource of the first communication apparatus, and the first resource includes a time-frequency domain resource.

For technical effect of the communication method according to the second aspect, refer to the technical effect of the communication method according to the first aspect. Details are not described herein again.

According to a third aspect, at least one embodiment provides a communication method. The method is applied to a second communication apparatus. The second communication apparatus is, for example, an access network device (for example, a base station). The communication method includes: The second communication apparatus determines fourth indication information, and sends the fourth indication information, where the fourth indication information indicates a second polarization manner of a first beam, and the second polarization manner includes any one of left hand circular polarization, right hand circular polarization, linear polarization, or cross polarization multiplexing.

With reference to the communication method according to the third aspect, the fourth indication information indicates the second polarization manner of the first beam. In this way, the second communication apparatus schedules a polarization manner of a first communication apparatus at a beam level, that is, the second communication apparatus adjusts a polarization manner of the first communication apparatus in a beam, so that scheduling of the polarization manner of the first communication apparatus is more flexible, and a scheduling granularity is finer, thereby improving spectral efficiency.

In at least one embodiment, the fourth indication information includes an SSB index, and the SSB index corresponds to the second polarization manner; or the fourth indication information includes a CSI-RS time-frequency location, and the CSI-RS time-frequency location corresponds to the second polarization manner.

In at least one embodiment, the communication method according to the third aspect further includes: The second communication apparatus sends a first mapping relationship, where the first mapping relationship includes a mapping relationship between at least one SSB index and at least one polarization manner, or the first mapping relationship includes a mapping relationship between at least one CSI-RS time-frequency location and at least one polarization manner.

In at least one embodiment, the fourth indication information is carried in any one of RRC, DCI, or a MAC CE.

In at least one embodiment, the communication method according to the third aspect further includes: The second communication apparatus determines second indication information, and sends the second indication information, where the second indication information indicates a polarization manner of a neighboring cell of a cell in which a first communication apparatus is located, and the polarization manner of the neighboring cell includes one or more of left hand circular polarization, right hand circular polarization, linear polarization, or cross polarization multiplexing. In this way, based on the second indication information, the first communication apparatus obtains the polarization manner of the neighboring cell in advance, that is, obtains, in advance, the polarization manner used in response to signal quality of the neighboring cell being measured. In this case, during cell handover, the first communication apparatus measures the signal quality of the neighboring cell based on the polarization manner of the neighboring cell indicated by the second indication information, and then implement cell handover. This improves a cell handover success rate, avoid requesting the polarization manner of the neighboring cell again from the second communication apparatus during handover, and accelerate cell handover.

Linear polarization includes any one of horizontal polarization, vertical polarization, +450 polarization, and −45° polarization. Cross polarization multiplexing includes any one of horizontal and vertical cross polarization multiplexing, ±45° cross polarization multiplexing, and left hand circular polarization and right hand circular polarization cross polarization multiplexing. In other words, the second polarization manner includes any one of left hand circular polarization, right hand circular polarization, horizontal polarization, vertical polarization, +45° polarization, −45° polarization, horizontal and vertical cross polarization multiplexing, ±450 cross polarization multiplexing, and left hand circular polarization and right hand circular polarization cross polarization multiplexing. In addition, elements included in the polarization manner, of the neighboring cell, indicated by the second indication information are the same as those included in the second polarization manner. Details are not described herein again.

Optionally, the second indication information further indicates a polarization manner of a neighboring cell of a cell in which the first communication apparatus in a first status is located, the first status includes a connected state or an inactive state, and the second indication information is carried in terminal-level information. In this way, based on the second indication information, the first communication apparatus in the connected state or the inactive state obtains the polarization manner of the neighboring cell in advance, that is, obtains, in advance, the polarization manner used in response to signal quality of the neighboring cell being measured. In this case, during cell handover, the first communication apparatus measures the signal quality of the neighboring cell based on the polarization manner of the neighboring cell indicated by the second indication information, and then implement cell handover. This improves a cell handover success rate, avoid requesting the polarization manner of the neighboring cell again from the second communication apparatus during handover, and accelerate cell handover.

Optionally, the second indication information further indicates a polarization manner of a neighboring cell of a cell in which the first communication apparatus in a second status is located, the second status includes an inactive state or an idle state, and the second indication information is carried in cell-level information. In this way, based on the second indication information, the first communication apparatus in the inactive state or the idle state obtains the polarization manner of the neighboring cell in advance, that is, obtains, in advance, the polarization manner used in response to signal quality of the neighboring cell being measured. Therefore, during cell reselection, the first communication apparatus measures the signal quality of the neighboring cell based on the polarization manner of the neighboring cell indicated by the second indication information, and then implement cell reselection. This improves a cell reselection success rate, avoid requesting the polarization manner of the neighboring cell from the second communication apparatus again during reselection, and accelerates cell reselection.

In at least one embodiment, the fourth indication information further indicates duration of the second polarization manner. In other words, the second communication apparatus indicates duration in which all first communication apparatuses in the first beam work in the second polarization manner. After the duration indicated by the fourth indication information expires, all the first communication apparatuses in the first beam restores to a previous polarization manner. In this way, the second communication apparatus no longer indicates, by using one piece of indication signaling, the first communication apparatus in the first beam to restore to the previous polarization manner. This reduces signaling overheads, and further improves flexibility of scheduling the polarization manner of the first communication apparatus.

In at least one embodiment, the fourth indication information is determined based on one or more of the following: polarization manners supported by all first communication apparatuses in the first beam, channel state information of channels in different polarization manners measured by all the first communication apparatuses in the first beam, service usage of all the first communication apparatuses in the first beam, polarization manners expected by all the first communication apparatuses in the first beam, a weather condition in a coverage area of the first beam, or a crosstalk status between all orthogonally polarized channels in the first beam. In this way, the second communication apparatus determines, with reference to a plurality of types of information, a polarization manner that is more appropriate for all the first communication apparatuses in the first beam, and schedule the polarization manner for all the first communication apparatuses in the first beam by using the fourth indication information. This enables, in one aspect, all the first communication apparatuses in the first beam to work in a better polarization manner, improve communication quality, and reduce power consumption, in another aspect, scheduling of the polarization manner for all the first communication apparatuses in the first beam is more flexible, and a scheduling granularity is finer, thereby improving spectral efficiency.

In at least one embodiment, the communication method according to the third aspect further includes: The second communication apparatus determines third indication information, and sends the third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing. In this way, based on the third indication information, the first communication apparatus obtains the polarization manner of the adjacent beam in advance, that is, obtains, in advance, the polarization manner used in response to signal quality of the adjacent beam being used. Therefore, during beam handover, the first communication apparatus measures the signal quality of the adjacent beam based on the polarization manner of the adjacent beam indicated by the third indication information, and then implements beam handover. This improves a beam handover success rate, avoids requesting the polarization manner of the adjacent beam from the second communication apparatus during handover, and accelerates beam handover.

According to a fourth aspect, at least one embodiment provides a communication method. The method is applied to a first communication apparatus. The first communication apparatus is, for example, a mobile phone, a car, or an internet of things device. The communication method includes: The first communication apparatus receives fourth indication information from a second communication apparatus, where the fourth indication information indicates a second polarization manner of a first beam, and the second polarization manner includes any one of left hand circular polarization, right hand circular polarization, linear polarization, or cross polarization multiplexing; and communicates with the second communication apparatus based on the second polarization manner.

In at least one embodiment, the fourth indication information includes an SSB index, and the SSB index corresponds to the second polarization manner; or the fourth indication information includes a CSI-RS time-frequency location, and the CSI-RS time-frequency location corresponds to the second polarization manner.

In at least one embodiment, the communication method according to the fourth aspect further includes: The first communication apparatus receives a first mapping relationship from the second communication apparatus, where the first mapping relationship includes a mapping relationship between at least one SSB index and at least one polarization manner, or the first mapping relationship includes a mapping relationship between at least one CSI-RS time-frequency location and at least one polarization manner.

In at least one embodiment, the fourth indication information is carried in any one of RRC, DCI, or a MAC CE.

In at least one embodiment, the communication method according to the fourth aspect further includes: The first communication apparatus receives second indication information from the second communication apparatus, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information.

In at least one embodiment, the fourth indication information further indicates duration of the second polarization manner.

In at least one embodiment, the fourth indication information is determined based on one or more of the following: polarization manners supported by all first communication apparatuses in the first beam, channel state information of channels in different polarization manners measured by all the first communication apparatuses in the first beam, service usage of all the first communication apparatuses in the first beam, polarization manners expected by all the first communication apparatuses in the first beam, a weather condition in a coverage area of the first beam, or a crosstalk status between all orthogonally polarized channels in the first beam.

In at least one embodiment, the communication method according to the fourth aspect further includes: The first communication apparatus receives third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing.

For technical effect of the communication method according to the fourth aspect, refer to the technical effect of the communication method according to the third aspect. Details are not described herein again.

According to a fifth aspect, a second communication apparatus is provided. The second communication apparatus includes a processing module and a transceiver module. The processing module is configured to determine first indication information, where the first indication information is carried in terminal-level information, the first indication information indicates a first polarization manner of a first communication apparatus, and the first polarization manner includes any one of left hand circular polarization, right hand circular polarization, linear polarization, or cross polarization multiplexing. The transceiver module is configured to send the first indication information.

In at least one embodiment, the processing module is further configured to determine second indication information, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing. The transceiver module is further configured to send the second indication information.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information. Optionally, the cell-level information is an SIB.

In at least one embodiment, the first indication information includes a mapping relationship between a plurality of SSB indexes and a plurality of polarization manners.

In at least one embodiment, the first indication information further indicates duration of the first polarization manner.

In at least one embodiment, the first indication information is determined based on one or more of the following: a polarization manner supported by the first communication apparatus, CSI of channels in different polarization manners measured by the first communication apparatus, a service usage of the first communication apparatus, a polarization manner expected by the first communication apparatus, a weather condition between the first communication apparatus and the second communication apparatus, or a crosstalk status between orthogonally polarized channels.

In at least one embodiment, the terminal-level information is RRC signaling.

Optionally, the terminal-level information is alternatively any one of a MAC CE, a CSI-RS, DCI, or the like.

In at least one embodiment, the first indication information is one or more of a carrier of the CSI-RS and an RE, and the one or more of the carrier and the resource element indicate the first polarization manner.

In at least one embodiment, the processing module is further configured to determine third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing. The transceiver module is further configured to send the third indication information.

In at least one embodiment, the first indication information indicates a first polarization manner corresponding to a first resource of the first communication apparatus, and the first resource includes a time-frequency domain resource.

Optionally, the transceiver module includes a receiving module and a sending module. The receiving module is configured to implement a receiving function of the second communication apparatus according to the fifth aspect, and the sending module is configured to implement a sending function of the second communication apparatus according to the fifth aspect.

Optionally, the second communication apparatus according to the fifth aspect further includes a storage module, and the storage module stores a program or instructions. In response to the processing module executing the program or the instructions, the second communication apparatus performs the communication method according to the first aspect.

The second communication apparatus according to the fifth aspect is a network device. For example, the network device is an access network device (like a base station or a satellite), or is a chip (system) or another part or component disposed in the network device, or is a second communication apparatus including the network device. This is not limited in at least one embodiment.

In addition, for technical effect of the second communication apparatus according to the fifth aspect, refer to the technical effect of the communication method according to the first aspect. Details are not described herein again.

According to a sixth aspect, a first communication apparatus is provided. The first communication apparatus includes a transceiver module and a processing module. The transceiver module is configured to receive first indication information from a second communication apparatus, where the first indication information indicates a first polarization manner of the first communication apparatus, the first polarization manner includes any one of left hand circular polarization, right hand circular polarization, linear polarization, or cross polarization multiplexing, and the first indication information is carried in terminal-level information. The processing module is configured to communicate with the second communication apparatus in the first polarization manner.

In at least one embodiment, the transceiver module is further configured to receive second indication information from the second communication apparatus, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information. Optionally, the cell-level information is an SIB.

In at least one embodiment, the first indication information includes a mapping relationship between a plurality of SSB indexes and a plurality of polarization manners.

In at least one embodiment, the first indication information further indicates duration of the first polarization manner.

In at least one embodiment, the first indication information is determined based on one or more of the following: a polarization manner supported by the first communication apparatus, channel state information of channels in different polarization manners measured by the first communication apparatus, a service usage of the first communication apparatus, a polarization manner expected by the first communication apparatus, a weather condition between the first communication apparatus and the second communication apparatus, or a crosstalk status between orthogonally polarized channels.

In at least one embodiment, the terminal-level information is RRC signaling.

Optionally, the terminal-level information is alternatively any one of a MAC CE, a CSI-RS, DCI, or the like.

In at least one embodiment, the transceiver module is further configured to receive third indication information from the second communication apparatus, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing.

In at least one embodiment, the first indication information indicates a first polarization manner corresponding to a first resource of the first communication apparatus, and the first resource includes a time-frequency domain resource.

Optionally, the transceiver module includes a receiving module and a sending module. The receiving module is configured to implement a receiving function of the first communication apparatus according to the sixth aspect, and the sending module is configured to implement a sending function of the first communication apparatus according to the sixth aspect.

Optionally, the first communication apparatus according to the sixth aspect further includes a storage module, and the storage module stores a program or instructions. In response to the processing module executing the program or the instructions, the first communication apparatus performs the communication method according to the second aspect.

The first communication apparatus according to the sixth aspect is a terminal device. The terminal device is, for example, a mobile phone, a car, or an internet of things device, or is a chip (system) or another part or component disposed in the terminal device, or is a first communication apparatus including the terminal device. This is not limited in at least one embodiment.

In addition, for technical effect of the first communication apparatus according to the sixth aspect, refer to the technical effect of the communication method according to the second aspect. Details are not described herein again.

According to a seventh aspect, a second communication apparatus is provided. The second communication apparatus includes a processing module and a transceiver module. The processing module is configured to determine fourth indication information, where the fourth indication information indicates a second polarization manner of a first beam, and the second polarization manner includes any one of left hand circular polarization, right hand circular polarization, linear polarization, or cross polarization multiplexing. The transceiver module is configured to send the fourth indication information.

In at least one embodiment, the fourth indication information includes an SSB index, and the SSB index corresponds to the second polarization manner; or the fourth indication information includes a CSI-RS time-frequency location, and the CSI-RS time-frequency location corresponds to the second polarization manner.

In at least one embodiment, the transceiver module is further configured to send a first mapping relationship, where the first mapping relationship includes a mapping relationship between at least one SSB index and at least one polarization manner, or the first mapping relationship includes a mapping relationship between at least one CSI-RS time-frequency location and at least one polarization manner.

In at least one embodiment, the fourth indication information is carried in any one of RRC, DCI, or a MAC CE.

In at least one embodiment, the processing module is further configured to determine second indication information, where the second indication information indicates a polarization manner of a neighboring cell of a cell in which a first communication apparatus is located, and the polarization manner of the neighboring cell includes one or more of left hand circular polarization, right hand circular polarization, linear polarization, or cross polarization multiplexing. The transceiver module is further configured to send the second indication information.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information.

In at least one embodiment, the fourth indication information further indicates duration of the second polarization manner.

In at least one embodiment, the fourth indication information is determined based on one or more of the following: polarization manners supported by all first communication apparatuses in the first beam, channel state information of channels in different polarization manners measured by all the first communication apparatuses in the first beam, service usage of all the first communication apparatuses in the first beam, polarization manners expected by all the first communication apparatuses in the first beam, a weather condition in a coverage area of the first beam, or a crosstalk status between all orthogonally polarized channels in the first beam.

In at least one embodiment, the processing module is further configured to determine third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing. The transceiver module is further configured to send the third indication information.

Optionally, the transceiver module includes a receiving module and a sending module. The receiving module is configured to implement a receiving function of the second communication apparatus according to the seventh aspect, and the sending module is configured to implement a sending function of the second communication apparatus according to the seventh aspect.

Optionally, the second communication apparatus according to the seventh aspect further includes a storage module, and the storage module stores a program or instructions. In response to the processing module executing the program or the instructions, the second communication apparatus performs the communication method according to the third aspect.

The second communication apparatus according to the seventh aspect is a network device. For example, the network device is an access network device (like a base station or a satellite), or is a chip (system) or another part or component disposed in the network device, or is a second communication apparatus including the network device. This is not limited in at least one embodiment.

In addition, for technical effect of the second communication apparatus according to the seventh aspect, refer to the technical effect of the communication method according to the third aspect. Details are not described herein again.

According to an eighth aspect, a first communication apparatus is provided. The first communication apparatus includes a transceiver module and a processing module. The transceiver module is configured to receive fourth indication information from a second communication apparatus, where the fourth indication information indicates a second polarization manner of a first beam, and the second polarization manner includes any one of left hand circular polarization, right hand circular polarization, linear polarization, or cross polarization multiplexing. The processing module is configured to communicate with the second communication apparatus based on the second polarization manner.

In at least one embodiment, the fourth indication information includes an SSB index, and the SSB index corresponds to the second polarization manner; or the fourth indication information includes a CSI-RS time-frequency location, and the CSI-RS time-frequency location corresponds to the second polarization manner.

In at least one embodiment, the transceiver module is further configured to receive second indication information from the second communication apparatus, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing.

In at least one embodiment, the fourth indication information is carried in any one of RRC, DCI, or a MAC CE.

In at least one embodiment, the transceiver module is further configured to receive the second indication information from the second communication apparatus, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information.

In at least one embodiment, the fourth indication information further indicates duration of the second polarization manner.

In at least one embodiment, the fourth indication information is determined based on one or more of the following: polarization manners supported by all first communication apparatuses in the first beam, channel state information of channels in different polarization manners measured by all the first communication apparatuses in the first beam, service usage of all the first communication apparatuses in the first beam, polarization manners expected by all the first communication apparatuses in the first beam, a weather condition in a coverage area of the first beam, or a crosstalk status between all orthogonally polarized channels in the first beam.

In at least one embodiment, the transceiver module is further configured to receive third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing.

Optionally, the transceiver module includes a receiving module and a sending module. The receiving module is configured to implement a receiving function of the first communication apparatus according to the eighth aspect, and the sending module is configured to implement a sending function of the first communication apparatus according to the eighth aspect.

Optionally, the first communication apparatus according to the eighth aspect further includes a storage module, and the storage module stores a program or instructions. In response to the processing module executing the program or the instructions, the first communication apparatus performs the communication method according to the fourth aspect.

The first communication apparatus according to the eighth aspect is a terminal device. The terminal device is, for example, a mobile phone, a car, or an internet of things device, or is a chip (system) or another part or component disposed in the terminal device, or is a first communication apparatus including the terminal device. This is not limited in at least one embodiment.

In addition, for technical effect of the first communication apparatus according to the eighth aspect, refer to the technical effect of the communication method according to the fourth aspect. Details are not described herein again.

According to a ninth aspect, a communication apparatus is provided. The communication apparatus is configured to perform the communication method according to any one of the implementations of the first aspect to the fourth aspect.

In at least one embodiment, the communication apparatus according to the ninth aspect is a terminal device or a network device, or is a chip (system) or another part or component disposed in the terminal device or the network device, or is an apparatus including the terminal device or the network device. This is not limited in at least one embodiment. The network device is configured to perform the communication method according to implementations of the first aspect and the third aspect, and the terminal device is configured to perform the communication method according to implementations of the second aspect and the fourth aspect.

The communication apparatus according to the ninth aspect includes a corresponding module, unit, or means (means) for implementing the communication method according to any one of the first aspect to the fourth aspect. The module, unit, or means is implemented by hardware, or is implemented by software, or is implemented by hardware executing corresponding software. The hardware or software includes one or more modules or units configured to perform functions related to the foregoing communication methods.

According to a tenth aspect, a communication apparatus is provided. The communication apparatus includes a processor, and the processor is configured to perform the communication method according to implementations of the first aspect to the fourth aspect.

In at least one embodiment, the communication apparatus according to the tenth aspect further includes a transceiver. The transceiver is a transceiver circuit or an interface circuit. The transceiver is used by the communication apparatus according to the tenth aspect to communicate with another communication apparatus.

In at least one embodiment, the communication apparatus according to the tenth aspect further includes a memory. The memory and the processor are integrated together, or are disposed separately. The memory is configured to store a computer program and/or data related to the communication method according to any one of the first aspect to the fourth aspect.

In at least one embodiment, the communication apparatus according to the tenth aspect is a terminal device or a network device, or is a chip (system) or another part or component disposed in the terminal device or the network device, or is an apparatus including the terminal device or the network device. This is not limited in at least one embodiment. The network device is configured to perform the communication method according to implementations of the first aspect and the third aspect, and the terminal device is configured to perform the communication method according to implementations of the second aspect and the fourth aspect.

According to an eleventh aspect, a communication apparatus is provided. The communication apparatus includes a processor, the processor is coupled to a memory, and the processor is configured to execute a computer program stored in the memory, so that the communication apparatus performs the communication method according to implementations of the first aspect to the fourth aspect.

In at least one embodiment, the communication apparatus according to the eleventh aspect further includes a transceiver. The transceiver is a transceiver circuit or an interface circuit. The transceiver is used by the communication apparatus according to the eleventh aspect to communicate with another communication apparatus.

In at least one embodiment, the communication apparatus according to the eleventh aspect is a terminal device or a network device, or is a chip (system) or another part or component disposed in the terminal device or the network device, or is an apparatus including the terminal device or the network device. This is not limited in at least one embodiment. The network device is configured to perform the communication method according to implementations of the first aspect and the third aspect, and the terminal device is configured to perform the communication method according to implementations of the second aspect and the fourth aspect.

According to a twelfth aspect, a communication apparatus is provided. The communication apparatus includes a processor and an interface circuit. The interface circuit is configured to receive code instructions and transmit the code instructions to the processor. The processor is configured to run the code instructions to perform the communication method according to any one of the implementations of the first aspect to the fourth aspect.

In at least one embodiment, the communication apparatus according to the twelfth aspect further includes a memory. The memory and the processor are integrated together, or are disposed separately. The memory is configured to store a computer program and/or data related to the communication method according to any one of the first aspect to the fourth aspect.

In at least one embodiment, the communication apparatus according to the twelfth aspect is a terminal device or a network device, or is a chip (system) or another part or component disposed in the terminal device or the network device, or is an apparatus including the terminal device or the network device. This is not limited in at least one embodiment. The network device is configured to perform the communication method according to implementations of the first aspect and the third aspect, and the terminal device is configured to perform the communication method according to implementations of the second aspect and the fourth aspect.

According to a thirteenth aspect, a communication apparatus is provided. The communication apparatus includes a processor and a storage medium. The storage medium stores instructions. In response to the instructions being run by the processor, the communication method according to implementations of the first aspect to the fourth aspect is implemented.

In at least one embodiment, the communication apparatus according to the thirteenth aspect is a terminal device or a network device, or is a chip (system) or another part or component disposed in the terminal device or the network device, or is an apparatus including the terminal device or the network device. This is not limited in at least one embodiment. The network device is configured to perform the communication method according to implementations of the first aspect and the third aspect, and the terminal device is configured to perform the communication method according to implementations of the second aspect and the fourth aspect.

According to a fourteenth aspect, a processor is provided. The processor is configured to perform the communication method according to implementations of the first aspect to the fourth aspect.

According to a fifteenth aspect, a communication system is provided. The communication system includes a terminal device and a network device. The network device includes an access network device and a core network device. The network device is configured to perform the communication method according to implementations of the first aspect and the third aspect, and the terminal device is configured to perform the communication method according to implementations of the second aspect and the fourth aspect.

According to a sixteenth aspect, a computer-readable storage medium is provided. The computer-readable storage medium includes a computer program or instructions. In response to the computer program or the instructions being run by a processor, the communication method according to implementations of the first aspect to the fourth aspect is implemented.

According to a seventeenth aspect, a computer program product is provided. The computer program product includes instructions. In response to the instructions being run by a processor, the communication method according to implementations of the first aspect to the fourth aspect is implemented.

According to an eighteenth aspect, a chip is provided. The chip includes a processing logic circuit and an interface circuit. There are one or more processing logic circuits, and there is a plurality of interface circuits.

The interface circuit is configured to receive code instructions and transmit the code instructions to the processing logic circuit. The processing logic circuit is configured to run the code instructions to perform the communication method according to any one of the implementations of the first aspect to the fourth aspect.

Optionally, the chip includes a memory. The memory and the processing logic circuit are integrated together, or are disposed separately. The memory is configured to store a computer program and/or data related to the communication method according to any one of the first aspect to the fourth aspect.

In at least one embodiment, the chip according to the eighteenth aspect is located in a terminal device or a network device, or is located in a terminal device or a network device in a communication system. In response to being located in the network device, the chip is configured to perform the communication method according to implementations of the first aspect and the third aspect. In response to being located in the terminal device, the chip is configured to perform the communication method according to implementations of the second aspect and the fourth aspect.

For technical effect brought by any implementation of the fifth aspect to the eighteenth aspect, refer to the technical effect brought by corresponding implementations of any one of the first aspect to the fourth aspect. Details are not described herein again.

In at least one embodiment, based on the implementations according to the foregoing aspects, the implementations are combined to provide more implementations.

### BRIEF DESCRIPTION OF DRAWINGS

FIG. 1 is a schematic diagram of circular polarization according to at least one embodiment;

FIG. 2 is a schematic diagram of four-color multiplexing according to at least one embodiment;

FIG. 3 is a schematic diagram of an architecture of a communication system according to at least one embodiment;

FIG. 4 is a schematic diagram of another architecture of a communication system according to at least one embodiment;

FIG. 5 is a schematic diagram of a structure of a communication apparatus according to at least one embodiment;

FIG. 6 is a schematic flowchart 1 of a communication method according to at least one embodiment;

FIG. 7 is a schematic diagram of resource mapping in a beam with a combination of polarization manners according to at least one embodiment;

FIG. 8 is a schematic diagram of virtual sub-beams formed in a beam by using RRM in a unit of UE in space according to at least one embodiment;

FIG. 9 is a schematic diagram of a beam in a cell according to at least one embodiment;

FIG. 10 is a schematic flowchart 2 of a communication method according to at least one embodiment;

FIG. 11 is a schematic flowchart 3 of a communication method according to at least one embodiment;

FIG. 12 is a schematic flowchart 4 of a communication method according to at least one embodiment;

FIG. 13 is a schematic diagram of RRC status switching according to at least one embodiment;

FIG. 14 is a schematic flowchart 5 of a communication method according to at least one embodiment;

FIG. 15 is a schematic flowchart 6 of a communication method according to at least one embodiment; and

FIG. 16 is a schematic diagram of a structure of a communication apparatus according to at least one embodiment.

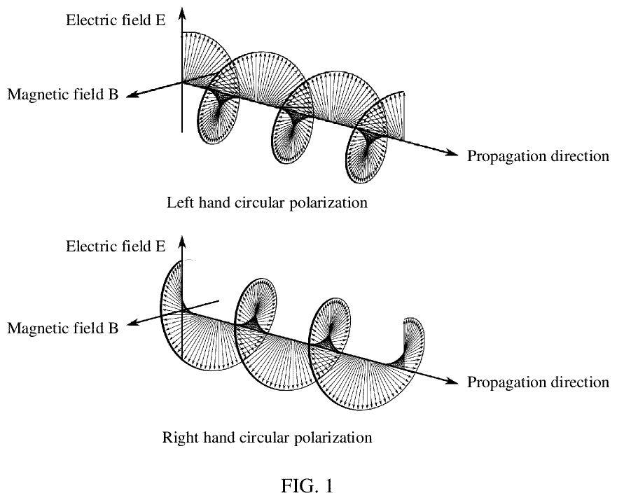

### DESCRIPTION OF EMBODIMENTS

For ease of understanding solutions in at least one embodiment, brief descriptions of conventional technologies are first provided.

### 1. Polarization Manner

In a communication system, a polarization manner for communication between two devices includes linear polarization, circular polarization, and cross polarization multiplexing. Linear polarization includes horizontal polarization, vertical polarization, +450 polarization, and −45° polarization. Circular polarization includes left hand circular polarization and right hand circular polarization.

### 2. Cross Polarization Multiplexing

In a current communication system, to improve communication efficiency, two mutually orthogonally polarized electromagnetic waves are used for communication. This manner is referred to as cross polarization multiplexing (polarization multiplexing). Cross polarization multiplexing is also referred to as polarization multiplexing or a similar concept. This is not limited in at least one embodiment.

Cross polarization multiplexing includes horizontal and vertical cross polarization multiplexing, ±45° cross polarization multiplexing, and left hand circular polarization and right hand circular polarization cross polarization multiplexing. For example, horizontal and vertical cross polarization multiplexing means that a network device and a terminal device communicate with each other through both a horizontally polarized electromagnetic wave and a vertically polarized electromagnetic wave on a frequency band. In addition, a polarization manner of linear polarization, circular polarization, or like using an electromagnetic wave with one polarization direction is referred to as a single polarization manner.

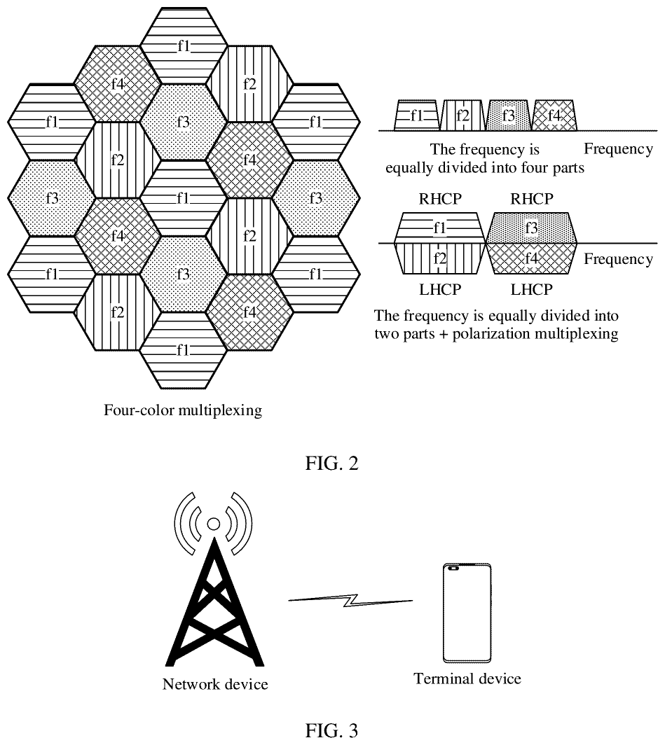

Current cross polarization multiplexing is applied to multi-color multiplexing. Four-color multiplexing is used as an example. FIG. 2 is a schematic diagram of four-color multiplexing according to at least one embodiment. As shown in FIG. 2, in a cell of an access network device (for example, a satellite or a base station), four-color multiplexing is implemented in a manner of frequency division, or four-color multiplexing is implemented in a manner of frequency division and polarization division. The following describes the manners separately.

For four-color multiplexing implemented in the manner of frequency division, a frequency band used in the cell is equally divided into four frequency bands, the four frequency bands respectively correspond to four beams f1, f2, f3, and f4, and the four beams are arranged in the cell according to a rule shown in FIG. 2.

For four-color multiplexing implemented in the manner of frequency division and polarization division, a frequency band used in the cell is equally divided into two frequency bands, and the two frequency bands respectively correspond to two beams. One frequency band corresponds to f1 and f2, and the other frequency band corresponds to f3 and f4. In addition, f1 and f2 each use a different polarization manner, and f3 and f4 each use a different polarization manner. F1 uses RHCP, f2 uses LHCP, f3 uses RHCP, and f4 uses LHCP. The four beams are arranged in the cell according to a rule shown in FIG. 2.

In response to four-color multiplexing being implemented in the manner of frequency division and polarization division, spectrum resource utilization of the cell is doubled, and communication efficiency is improved.

Currently, a network device schedules a polarization manner of a cell, so that terminal devices in the cell works in a same good polarization manner. Specifically, in response to the network device scheduling the polarization manner of the terminal devices to switch the polarization manner of the terminal devices, the network device usually indicates, by using an SIB, all the terminal devices in the cell to switch the polarization manner from one polarization manner to another polarization manner. However, this scheduling manner is used only to perform scheduling on all the terminal devices in the cell, and cannot be used to perform scheduling on a specific terminal device. Therefore, scheduling is not flexible and spectral efficiency is low. In addition, because the SIB is periodic, each scheduling is performed only in a next SIB periodicity. As a result, scheduling is delayed.

To resolve the foregoing problems, embodiments described herein provide technical solutions. The technical solutions include a communication system, a communication method and a communication apparatus that are applied to the communication system, and the like. The following describes the technical solutions provided in at least one embodiment with reference to the accompanying drawings.

The technical solutions in at least one embodiment are applied to a wireless communication system. For example, the wireless communication system is a 4^{th} generation (4G) communication system (for example, a long term evolution (LTE) system), a 5^{th} generation (5G) communication system (for example, a new radio (NR) system), or a future mobile communication system. The technical solutions in at least one embodiment are also applied to a satellite communication system or a non-terrestrial communication network (NTN) communication system. The satellite communication system or the NTN communication system is integrated with a wireless communication system.

All aspects, embodiments, or features are presented herein by describing a system that includes a plurality of devices, components, modules, and the like. Each system includes another device, component, module, and the like, and/or does not include all devices, components, modules, and the like discussed with reference to the accompanying drawings. In addition, a combination of these solutions is used.

In addition, in at least one embodiment, terms such as “example” and “for example” are used to represent giving an example, an illustration, or a description. Any embodiment or design scheme described as an “example” should not be explained as being more preferred or having more advantages than another embodiment or design scheme. Exactly, the term “example” is used to present a concept in a specific manner.

In at least one embodiment, a subscript form like W₁ is incorrectly written as a non-subscript form like W1. In response to a difference between the subscript and the non-subscript form not being emphasized, meanings to be expressed by the subscript and the non-subscript form are consistent.

A network architecture and a service scenario described in at least one embodiment are intended to describe the technical solutions in at least one embodiment more clearly, and do not constitute a limitation on the technical solutions provided in at least one embodiment. A person of ordinary skill in the art knows that: With the evolution of the network architecture and the emergence of new service scenarios, the technical solutions provided in at least one embodiment are also applicable to similar technical problems.

Embodiments described herein provide the communication system. The communication system is applicable to communication between a second communication apparatus and a first communication apparatus. The communication system provided in at least one embodiment includes one or more second communication apparatuses and one or more first communication apparatuses. A quantity of second communication apparatuses and a quantity of first communication apparatuses in the communication system are not limited in at least one embodiment. In at least one embodiment, an example in which the first communication apparatus is a terminal device and the second communication apparatus is a network device is used to describe the solutions provided in at least one embodiment. This is uniformly described herein. Details are not described below again.

For example, FIG. 3 is a schematic diagram of an architecture of a communication system according to at least one embodiment. As shown in FIG. 3, the communication system includes a network device and a terminal device, and the network device and the terminal device is a connected in a wireless manner. The network device exchanges data, control signaling, or the like with the terminal device.

Optionally, the communication system provided in at least one embodiment is also applicable to communication between network devices, communication between terminal devices, and communication between the internet of vehicles, the internet of things, and the industrial internet. Therefore, types of devices at two communication ends in the communication system are not limited in at least one embodiment.

Optionally, the network device in at least one embodiment is a device that connects the terminal device to a wireless network. The network device is a node in a radio access network, or is referred to as a base station, or is referred to as a radio access network (RAN) node (or device). The base station is a distributed antenna system, and a radio frequency head end of the base station communicates with a terminal device. For example, the network device includes an evolved NodeB (NodeB, eNB, or eNodeB, evolved NodeB) in an LTE system or an evolved LTE system (LTE-A), for example, a conventional macro base station eNB and a micro base station eNB in a heterogeneous network scenario; or includes a next generation nodeB (gNB) in a 5G NR system, or further includes a transmitting and receiving point (TRP), a transmitting point (TP), a home base station (for example, HNB), a base band unit (BBU), a baseband pool BBU pool, or a wireless fidelity (Wi-Fi) access point (AP), a mobile switching center and a device that undertakes a base station function in device-to-device (D2D), vehicle-to-everything (V2X), machine-to-machine (M2M) communication; or a base station device in a 5G network or a network device in a future evolved public land mobile network (PLMN). Alternatively, the network device is a wearable device, a vehicle-mounted device, or the like; or includes a central unit (CU) and a distributed unit (DU) in a cloud access network (CloudRAN) system; or includes a network device in an NTN, that is, is deployed on a high-altitude platform or a satellite. In the NTN, the network device is used as a layer 1 (L1) relay (relay), or is used as a base station, or is used as a DU, or is used as an integrated access and backhaul (AB) node. This is not limited in at least one embodiment. Certainly, the network device is also a node in a core network.

Optionally, the terminal device in at least one embodiment is a device configured to implement a wireless communication function, for example, a terminal or a chip that is used in the terminal. The terminal is user equipment (UE) in a 5G network or a future evolved PLMN, an access terminal, a terminal unit, a terminal station, a mobile station, a mobile console, a remote station, a remote terminal, a mobile device, a wireless communication device, a terminal agent or a terminal apparatus, various terminals (for example, a robot or a mechanical arm equipped with a wireless transmission module) in an industrial scenario, or the like. The access terminal is a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a virtual reality (VR) terminal device, an augmented reality (AR) terminal device, a wireless terminal in industrial control (industrial control), a wireless terminal in self-driving (self-driving), an unmanned aerial vehicle, a satellite terminal, a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), or the like. Alternatively, the terminal is a terminal (for example, an internet of vehicles device) in vehicle-to-everything (V2X), a terminal in device-to-device (Device-to-Device) communication, a terminal in machine-to-machine (M2M) communication, or the like. The terminal is mobile or fixed.

Optionally, in at least one embodiment, the network device and the terminal device is deployed on the land, including an indoor device, an outdoor device, a handheld device, or a vehicle-mounted device; is deployed on the water; or is deployed on an airplane, a balloon, and a satellite in the air. An application scenario of the network device and the terminal device is not limited in at least one embodiment.

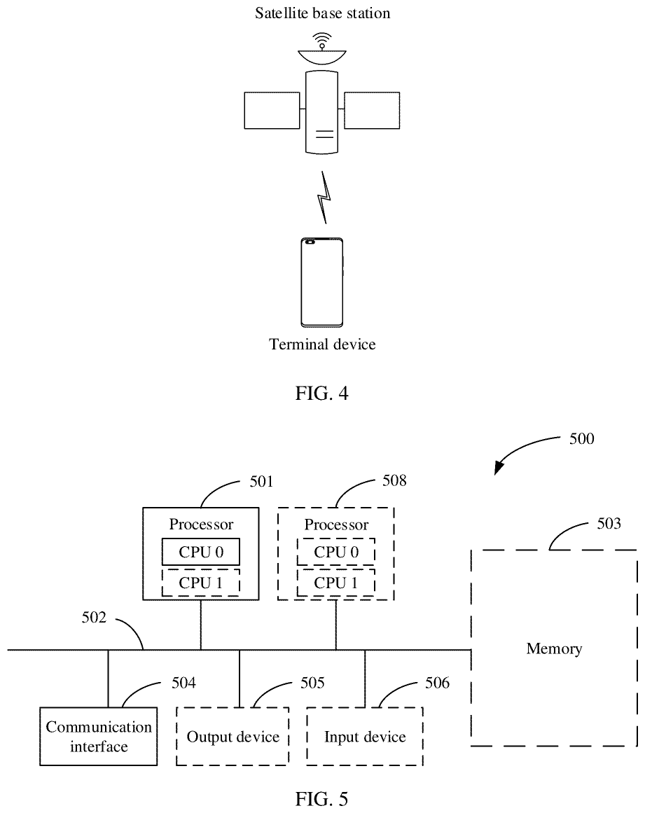

For example, in response to the technical solutions in at least one embodiment being applied to an NTN communication system, the communication system shown in FIG. 3 is shown in FIG. 4. FIG. 4 is a schematic diagram of another architecture of the communication system according to at least one embodiment. The communication system includes a satellite base station and a terminal device, and the satellite base station and the terminal device is connected in a wireless manner. The satellite base station exchanges data, control signaling, or the like with the terminal device.

A specific structure of an execution body of the method provided in at least one embodiment is not specifically limited in at least one embodiment, provided that a program that records code for the method provided in at least one embodiment is run to perform communication according to the method provided in at least one embodiment. For example, the execution body of the communication method provided in at least one embodiment is a terminal device, a network device, or a function module that invokes and executes a program in the terminal device or the network device.

In other words, a related function of the terminal device or the network device in at least one embodiment is implemented by one device, or is jointly implemented by a plurality of devices, or is implemented by one or more function modules in one device. This is not specifically limited in at least one embodiment. The foregoing function is a network element in a hardware device, is a software function running on dedicated hardware, a combination of hardware and software, or a virtualized function instantiated on a platform (for example, a cloud platform).

For example, the related function of the terminal device or the network device in at least one embodiment is implemented by a communication apparatus 500 in FIG. 5. FIG. 5 is a schematic diagram of a structure of the communication apparatus 500 according to at least one embodiment. The communication apparatus 500 includes one or more processors 501, a communication line 502, and at least one communication interface (FIG. 5 uses only an example in which a communication interface 504 and one processor 501 are included for description). Optionally, the communication apparatus further includes a memory 503.

The processor 501 is a central processing unit (CPU), a microprocessor, an application-specific integrated circuit (ASIC), or one or more integrated circuits configured to control program execution of the solutions in at least one embodiment.

The communication line 502 includes a channel, and is configured to connect different components. For example, the communication line 502 is a bus, for example, an address bus, a data bus, or a control bus.

The communication interface 504 is a transceiver module, and is configured to communicate with another device or a communication network. For example, the transceiver module is an apparatus like a transceiver or a transceiver machine. Optionally, the communication interface 504 is alternatively a transceiver circuit located in the processor 501, and is configured to implement signal input and signal output of the processor.

The memory 503 is an apparatus with a storage function. For example, the memory 503 is a read-only memory (ROM) or another type of static storage device capable of storing static information and instructions, a random access memory (RAM), or another type of dynamic storage device capable of storing information and instructions; or is an electrically erasable programmable read-only memory (EEPROM), a compact disc read-only memory (CD-ROM), other compact disc storage, optical disc storage (including a compressed optical disc, a laser disc, an optical disc, a digital versatile disc, a Blu-ray disc, or the like), a magnetic disk storage medium, or another magnetic storage device; or any other medium capable of carrying or storing desired program code in a form of instructions or a data structure and capable of being accessed by a computer. However, this is not limited. The memory exists independently and is connected to the processor through the communication line 502. The memory is alternatively integrated with the processor.

The memory 503 is configured to store computer-executable instructions for executing the solutions of at least one embodiment, and the processor 501 controls execution of the computer-executable instructions. The processor 501 is configured to execute the computer-executable instructions stored in the memory 503, to implement the communication method provided in at least one embodiment.

Alternatively, in at least one embodiment, the processor 501 implements a processing-related function in the communication method provided in the following embodiment, and the communication interface 504 is responsible for communicating with another device or communication network. This is not specifically limited in at least one embodiment.

The computer-executable instructions in at least one embodiment are also referred to as application program code. This is not specifically limited in at least one embodiment.

During specific implementation, in an embodiment, the processor 501 includes one or more CPUs, for example, a CPU 0 and a CPU 1 in FIG. 5.

During specific implementation, in an embodiment, the communication apparatus 500 includes a plurality of processors, for example, the processor 501 and a processor 508 in FIG. 5. Each of the processors is a single-core (single-CPU) processor, or is a multi-core (multi-CPU) processor. The processor herein is one or more devices, circuits, and/or processing cores configured to process data (for example, computer program instructions).

During specific implementation, in an embodiment, the communication apparatus 500 further includes an output device 505 and an input device 506. The output device 505 communicates with the processor 501, and displays information in a plurality of manners.

The foregoing describes the communication system provided in at least one embodiment. The following describes, with reference to the accompanying drawings, the communication method provided in at least one embodiment.

Based on a range of scheduled devices, the communication method provided in at least one embodiment is classified into three types, including: scheduling a polarization manner of the terminal device at a terminal level, scheduling a polarization manner of the terminal device at a beam level, and scheduling a polarization manner of the terminal device at a cell level, which are sequentially described below.

At least one embodiment schedules the polarization manner of the terminal device at the terminal level.

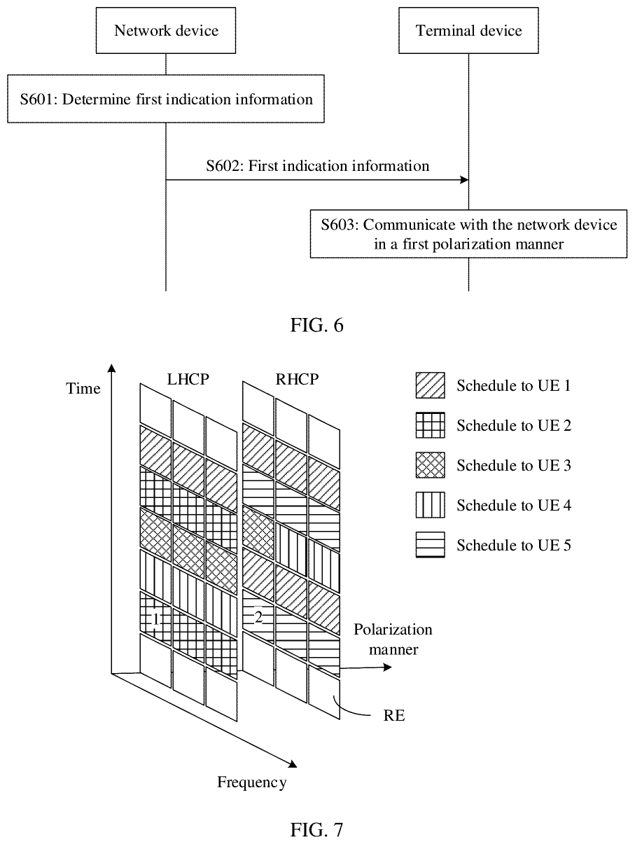

FIG. 6 is a schematic flowchart 1 of a communication method according to at least one embodiment. The communication method is applied to the foregoing communication system, and is performed by the terminal device or the network device in the foregoing communication system. According to the communication method, the polarization manner of the terminal device is scheduled at the terminal level, that is, the network device adjusts the polarization manner of the terminal device, so that scheduling of the polarization manner of the terminal device is more flexible and a scheduling granularity is finer, thereby improving spectral efficiency. The method includes S601 to S603, which are sequentially described below.

S601: The network device determines first indication information.

The first indication information indicates a first polarization manner of the terminal device. In other words, the first indication information indicates that a polarization manner of the terminal device is switched to a first polarization manner; or the first indication information indicates that the terminal device works in a first polarization manner; or the first indication information indicates that a polarization manner of the terminal device is a first polarization manner. Unless otherwise specified, meanings to be expressed in the several manners of expressing the first indication information are consistent, and is mixed.

The first polarization manner includes any one of left hand circular polarization, right hand circular polarization, linear polarization, or cross polarization multiplexing. Linear polarization includes any one of horizontal polarization, vertical polarization, +450 polarization, and −45° polarization. Cross polarization multiplexing includes any one of horizontal and vertical cross polarization multiplexing, ±45° cross polarization multiplexing, and left hand circular polarization and right hand circular polarization cross polarization multiplexing. This is uniformly described herein. Details are not described below again.

S602: The network device sends the first indication information to the terminal device. Correspondingly, the terminal device receives the first indication information from the network device.

S603: The terminal device communicates with the network device in the first polarization manner.

That the terminal device communicates with the network device in the first polarization manner is understood as that the terminal device works in the first polarization manner, or the terminal device switches the polarization manner to the first polarization manner.

For example, in response to the first polarization manner indicated by the first indication information being left hand circular polarization, the terminal device works in the left hand circular polarization manner, to implement communication with the network device. In response to the first polarization manner indicated by the first indication information being left hand circular polarization and right hand circular polarization cross polarization multiplexing, the terminal device works in the left hand circular polarization and right hand circular polarization cross polarization multiplexing polarization manner, to implement communication with the network device.

That the network device determines the first indication information in S601 is implemented in the following Manner 1 to Manner 6, which are sequentially described below.

Manner 1: The network device determines the first indication information based on a polarization manner supported by the terminal device.

Optionally, the network device determines, from the polarization manner supported by the terminal device, a polarization manner as the first polarization manner, to determine the first indication information.

The polarization manners supported by the terminal device include left hand circular polarization, right hand circular polarization, and left hand circular polarization and right hand circular polarization cross polarization multiplexing, and the network device determines the left hand circular polarization and right hand circular polarization cross polarization multiplexing as the first polarization manner, the network device generates the first indication information, where the first indication information indicates that the terminal device works in left hand circular polarization and right hand circular polarization cross polarization multiplexing.

In Manner 1, before the network device determines the first indication information, Manner 1 further includes: The network device obtains the polarization manner supported by the terminal device. An implementation process in which the network device obtains the polarization manner supported by the terminal device includes the following steps:

Step 1.1: The network device sends UE capability request (UE capability enquire) information to the terminal device. Correspondingly, the terminal device receives the UE capability request information from the network device.

Step 1.2: The terminal device generates a UE capability report (UE capability reporting) based on the UE capability request information, and feeds back the UE capability report to the network device.

In step 1.1 and step 1.2, the UE capability request information indicates the terminal device to feed back the polarization manner supported by the terminal device. The UE capability report includes the polarization manner supported by the terminal device. The UE capability report is also referred to as UE capability information (UE capability information). This is not limited herein.

For example, the polarization manner supported by the terminal device includes left hand circular polarization, right hand circular polarization, and left hand circular polarization and right hand circular polarization cross polarization multiplexing, the UE capability report generated by the terminal device includes that the terminal device supports left hand circular polarization, right hand circular polarization, and left hand circular polarization and right hand circular polarization cross polarization multiplexing.

Optionally, both the UE capability request information and the UE capability report is carried in RRC signaling.

Optionally, the UE capability report is carried on an uplink (UL) dedicated control channel (DCCH). In at least one embodiment, the UE capability report is implemented by using a radio frequency (RF) parameter or a physical layer (PHY) parameter in the UL-DCCH.

In response to the UE capability report being implemented by using the RF parameter in the UL-DCCH, a field in the RF parameter indicates the polarization manner supported by the terminal device. For example, an information format of the RF parameter in the UL-DCCH is as follows:

RF-Parameters ::= SEQUENCE {
supportedBandListNR SEQUENCE (SIZE (1...maxBands))
OF BandNR,
supportedBandCombinationList BandCombinationList
OPTIONAL,
appliedFreqBandListFilter FreqBandList OPTIONAL
Polarization ENUMERATED{LHCP, RHCP, L&RHCP Multiplexing}
OPTIONAL,
}

In the information format of the RF parameter, a polarization (Polarization) field in the RF parameter indicates the polarization manner supported by the terminal device.

In at least one embodiment, a length of the polarization field in the RF parameter being 2 bits. For example, Table 1 shows a correspondence between a polarization field and a polarization manner supported by the terminal device. Refer to Table 1. In response to the polarization field being 00, the terminal device supports left hand circular polarization; in response to the polarization field being 01, the terminal device supports right hand circular polarization; and in response to the polarization field being 10, the terminal device supports left hand circular polarization and right hand circular polarization cross polarization multiplexing.

TABLE 1

| Value of a | Polarization manner supported |
|---|---|
| polarization field | by a terminal device |
| 00 | Left hand circular polarization |
| 01 | Right hand circular polarization |
| 10 | Left hand circular polarization and |
| | right hand circular polarization |
| | cross polarization multiplexing |

In at least one embodiment, an uplink polarization manner and a downlink polarization manner that are supported by the terminal device is separately indicated. A length of a polarization field in the RF parameter is 4 bits. For example, Table 2 shows another correspondence between a polarization field and a polarization manner supported by the terminal device. Refer to Table 2. In response to the polarization field being 0000, the terminal device supports uplink left hand circular polarization and downlink left hand circular polarization, and so on. For a correspondence between a value of another polarization field and a polarization manner supported by the terminal device, refer to Table 2. Details are not described herein again.

TABLE 2

| Value of a | Polarization manner supported |
|---|---|
| polarization field | by a terminal device |
| 0000 | Uplink left hand circular polarization, and |
| | downlink left hand circular polarization |
| 0001 | Uplink left hand circular polarization, and |
| | downlink right hand circular polarization |
| 0010 | Uplink left hand circular polarization, and |
| | downlink left hand circular polarization and |
| | right hand circular polarization cross |
| | polarization multiplexing |
| 0011 | Uplink right hand circular polarization, and |
| | downlink left hand circular polarization |
| 0100 | Uplink right hand circular polarization, and |
| | downlink right hand circular polarization |
| 0101 | Uplink right hand circular polarization, and |
| | downlink left hand circular polarization and |
| | right hand circular polarization cross |
| | polarization multiplexing |
| 0110 | Uplink left hand circular polarization and |
| | right hand circular polarization cross |
| | polarization multiplexing, and downlink |
| | left hand circular polarization |
| 0111 | Uplink left hand circular polarization and |
| | right hand circular polarization cross |
| | polarization multiplexing, and downlink |
| | right hand circular polarization |
| 1000 | Uplink left hand circular polarization and |
| | right hand circular polarization cross |
| | polarization multiplexing, and downlink |
| | left hand circular polarization and right |
| | hand circular polarization cross |
| | polarization multiplexing |

In response to the UE capability report being implemented by using the PHY parameter in the UL-DCCH, a field in the PHY parameter indicates the polarization manner supported by the terminal device. For example, an information format of the PHY parameter in the UL-DCCH is as follows:

Phy-ParametersCommon ::= SEQUENCE {
csi-RS-CFRA-ForHO ENUMERATED
{supported} OPTIONAL,
Polarization ENUMERATED{LHCP, RHCP, L&RHCP Multiplexing}
OPTIONAL,
...
}

In the information format of the PHY parameter, a polarization (Polarization) field in the PHY parameter indicates the polarization manner supported by the terminal device.

In at least one embodiment, a length of the polarization field in the PHY parameter is 2 bits. For example, specific values are shown in Table 1.

In at least one embodiment, a length of the polarization field in the PHY parameter is 4 bits. For example, specific values are shown in Table 2.

The lengths of the polarization fields in both the RF parameter and the PHY parameter are merely examples. Lengths of the polarization fields in both the RF parameter and the PHY parameter are not limited in at least one embodiment. During application, the lengths of the polarization fields in both the RF parameter and the PHY parameter are set based on an actual usage. In addition, in Table 1 and Table 2, the correspondence between the polarization field in the RF parameter or the PHY parameter and the polarization manner supported by the terminal device is also an example. A correspondence between the polarization field in the RF parameter or the PHY parameter and the polarization manner supported by the terminal device is not limited in at least one embodiment. During application, the correspondence is adjusted based on an actual usage. The correspondence in Table 1 is used as an example. The correspondence in Table 1 is adjusted to a correspondence in Table 3. The correspondence in Table 2 is similar. Details are not described again.

TABLE 3

| Value of a | |
|---|---|
| polarization field | Polarization manner supported by a terminal device |
| 10 | Left hand circular polarization |
| 00 | Right hand circular polarization |
| 01 | Left hand circular polarization and right hand circular |
| | polarization cross polarization multiplexing |

In addition, in Table 1 and Table 2, the polarization manner, supported by the terminal device, that is indicated by the polarization field in the RF parameter or the PHY parameter is not limited to several types of left hand circular polarization, right hand circular polarization, and left hand circular polarization and right hand circular polarization cross polarization multiplexing. The polarization manner, supported by the terminal device, that is indicated by the polarization field in the RF parameter or the PHY parameter includes one or more of left hand circular polarization, right hand circular polarization, horizontal polarization, vertical polarization, +450 polarization, −45° polarization, horizontal and vertical cross polarization multiplexing, ±45° cross polarization multiplexing, and left hand circular polarization and right hand circular polarization cross polarization multiplexing. For a specific indication principle, refer to indication principles in Table 1 and Table 2. Examples are not provided herein one by one. As types of polarization manners, supported by the terminal device, that is indicated by the polarization field in the RF parameter or the PHY parameter increase, the length of the polarization field in the RF parameter or the PHY parameter increases accordingly, to support indication of all these types.

The RF parameter and the PHY parameter each further includes an uplink polarization field and a downlink polarization field. The uplink polarization field indicates an uplink polarization manner supported by the terminal device, and the downlink polarization field indicates a downlink polarization manner supported by the terminal device. For indication principles of the uplink polarization field and the downlink polarization field, refer to the indication principles in Table 1 and Table 2. Details are not described herein again. In this way, the terminal device separately reports to the network device by using the UL-DCCH, the supported uplink polarization manner and downlink polarization manner, thereby improving report flexibility.

In step 1.1 and step 1.2, in response to feeding back the UE capability report, the terminal device configures a value of the polarization field in the RF parameter or the PHY parameter to a value corresponding to the polarization manner supported by the terminal device, to feed back the UE capability report to the network device. Table 1 is used as an example. The terminal device supports left hand circular polarization and right hand circular polarization cross polarization multiplexing, the terminal device configures the polarization field in the RF parameter in the UL-DCCH to 10, and send the UL-DCCH to the network device, so as to feed back, to the network device, information that the terminal device supports left hand circular polarization and right hand circular polarization cross polarization multiplexing.

Manner 2: The network device determines the first indication information based on CSI of channels in different polarization manners measured by the terminal device.

Optionally, the network device determines at least one available polarization manner based on the CSI of the channels in the different polarization manners measured by the terminal device; and then determine, from the at least one available polarization manner, one available polarization manner as the first polarization manner, and generate the first indication information.

For example, the CSI of the channels in the different polarization manners measured by the terminal device includes CSI of a channel in a polarization manner A and CSI of a channel in a polarization manner B. The network device determines the at least one available polarization manner by determining the following conditions.

In at least one embodiment, in response to a first condition being met, the polarization manner B is the available polarization manner. The first condition includes: The terminal device works in the polarization manner A, and a difference between a first measurement value of the CSI of the channel in the polarization manner B and a second measurement value of the CSI of the channel in the polarization manner A is greater than (or >) a first threshold; or the first condition includes: The terminal device works in the polarization manner A, the CSI of the channel in the polarization manner A is less than (or <) a threshold 1, and the CSI of the channel in the polarization manner B is greater than (or >) a threshold 2. In other words, in response to channel quality in the polarization manner A being poorer than channel quality in the polarization manner B, the polarization manner B with better channel quality is used as the first polarization manner, to indicate the terminal device to switch to a polarization manner with better channel quality, thereby improving communication efficiency.

The first measurement value and the second measurement value are reference signal received power (reference signal received power, RSRP).

For example, in response to the polarization manner A being left hand circular polarization, the polarization manner B is right hand circular polarization, and the CSI of the channel in right hand circular polarization—the CSI of channel in the left hand circular polarization>the first threshold, the CSI of the channel in left hand circular polarization and the CSI of the channel in right hand circular polarization meet the first condition, and left hand circular polarization is the available polarization manner, and left hand circular polarization is determined as the first polarization manner. The first indication information is generated, where the first indication information indicates that the polarization manner of the terminal device is left hand circular polarization. Values of the first threshold, the threshold 1, and the threshold 2 are all determined by the network device or agreed on in a protocol. This is not limited herein.

In at least one embodiment, in response to a second condition is met, polarization manner A and polarization manner B cross polarization multiplexing is the available polarization manner, that is, The terminal device has a capability of enabling polarization multiplexing. The second condition includes: The terminal device works in a polarization manner A or a polarization manner B, and both CSI of a channel in the polarization manner A and CSI of a channel in the polarization manner B are greater than (or ≥) a second threshold. In this case, the network device determines, based on a service usage of the terminal device, whether the terminal device enables polarization multiplexing, that is, whether the terminal device works in polarization manner A and polarization manner B cross polarization multiplexing. For an implementation in which the network device determines, based on the service usage of the terminal device, whether the terminal device enables polarization multiplexing, refer to related descriptions in the following Manner 3. Details are not described herein again.

For example, in response to the polarization manner A being left hand circular polarization, the polarization manner B is right hand circular polarization, and both the CSI of the channel in right hand circular polarization and the CSI of the channel in left hand circular polarization are greater than the second threshold, left hand circular polarization and right hand circular polarization cross polarization multiplexing is the available polarization manner, that is, The terminal device has the capability of enabling polarization multiplexing. In this case, in response to the service usage of the terminal device being large, for example, a throughput of the terminal device is greater than a throughput threshold, the network device determines that the terminal device enables polarization multiplexing, that is, the network device determines that left hand circular polarization and right hand circular polarization cross polarization multiplexing is the first polarization manner, and generates the first indication information, where the first indication information indicates that the polarization manner of the terminal device is left hand circular polarization and right hand circular polarization cross polarization multiplexing, and indicates that the terminal device works in left hand circular polarization and right hand circular polarization cross polarization multiplexing. In this way, in response to the service usage of the terminal device being large and channel quality of polarization multiplexing is good, polarization multiplexing is enabled for the terminal device, to improve the throughput of the terminal device. A value of the second threshold is determined by the network device or agreed on in a protocol. This is not limited herein.

In at least one embodiment, in response to a third condition being met, a polarization manner B is an available polarization manner, and polarization manner A and polarization manner B cross polarization multiplexing is an unavailable polarization manner, that is, channel quality of polarization multiplexing by the terminal device is poor. The third condition is: The terminal device works in polarization manner A and polarization manner B cross polarization multiplexing, CSI of a channel in the polarization manner A is less than (or ≤) a third threshold, and CSI of a channel in a polarization manner B is greater than (or ≥) the third threshold. In other words, in two orthogonally polarization manners (denoted as A and B) currently used by the terminal device, in response to channel quality of A being poor, the network device indicates the terminal device to work in B, where channel quality of B is better, thereby improving communication efficiency of the terminal device.

For example, in response to the polarization manner A being left hand circular polarization, the polarization manner B is right hand circular polarization, the CSI of the channel in left hand circular polarization is less than the third threshold, and the CSI of the channel in right hand circular polarization is greater than the third threshold, the network device determines that right hand circular polarization is the available polarization manner and left hand circular polarization and right hand circular polarization cross polarization multiplexing is an unavailable polarization manner, and determine right hand circular polarization as the first polarization manner, and generate first indication information, where the first indication information indicates that the polarization manner of the terminal device is right hand circular polarization, and indicates the terminal device to work in right hand circular polarization, thereby improving channel quality and communication efficiency. A value of the third threshold is determined by the network device or agreed on in a protocol. This is not limited herein.

Both the polarization manner A and the polarization manner B are polarization manners supported by the terminal device. For types of the polarization manner A and the polarization manner B, refer to a type of the first polarization manner. Details are uniformly described herein. Details are not described below again.

In Manner 2, before determining the first indication information, the network device further obtains the CSI of the channels in different polarization manners measured by the terminal device. The network device obtains, by using the following steps, an implementation process of the CSI of the channels in the different polarization manners measured by the terminal device.

Step 2.1: The network device sends CSI request (CSI enquire) information to the terminal device. Correspondingly, the terminal device receives the CSI request information from the network device.

Step 2.2: The terminal device measures the CSI of the channels in the different polarization manners based on the CSI request information, to generate a CSI report.

Step 2.3: The terminal device sends a CSI report (CSI report) to the network device. Correspondingly, the network device receives the CSI report from the terminal device.

In step 2.1 to step 2.3, the CSI request information indicates the terminal device to feed back the CSI of the channels in the different polarization manners. The CSI report includes the CSI of the channels in the different polarization manners measured by the terminal device. The CSI request information is also referred to as CSI report configuration (CSI report configure) information. This is not limited herein.

For example, the CSI request information indicates the terminal device to feed back CSI of a channel in left hand circular polarization and CSI of a channel in right hand circular polarization, the terminal device measures the CSI of the channel in left hand circular polarization and the CSI of the channel in right hand circular polarization, and then generate the CSI report, where the CSI report includes the CSI of the channel in left hand circular polarization and the CSI of the channel in right hand circular polarization.

Optionally, in step 2.1 to step 2.3, the CSI request information further indicates the terminal device to feed back the CSI of the channels in the different polarization manners periodically (periodic), semi-persistently (semi-persistent), or aperiodically (aperiodic).

For example, in response to the CSI request information further indicates the terminal device to periodically feed back the CSI of the channels in the different polarization manners, the terminal device measures the CSI of the channels in the different polarization manners once every periodicity, and feed back, to the network device, the CSI report obtained in this measurement. A length of the periodicity is configured by the network device for the terminal device, or is agreed on in a protocol. This is not limited herein.

For another example, in response to the CSI request information further indicates the terminal device to aperiodically feed back the CSI of the channels in the different polarization manners, the terminal device measures the CSI of the channels in the different polarization manners once, and feed back, to the network device, the CSI report obtained in this measurement.

For still another example, in response to the CSI request information further indicates the terminal device to semi-persistently feed back the CSI of the channels in the different polarization manners, the terminal device measures the CSI of the channels in the different polarization manners once every half periodicity, and feed back, to the network device, the CSI report obtained in this measurement. A length of the half periodicity is configured by the network device for the terminal device, or is agreed on in a protocol. This is not limited herein.

Optionally, the CSI request information is carried in RRC signaling. In at least one embodiment, the network device configures a polarization measurement field in a CSI ReportConfig field to carry the CSI request information, so as to use the terminal device to feed back the CSI of the channels in the different polarization manners. An information format of the CSI ReportConfig field is as follows:

CSI-ReportConfig ::= SEQUENCE {
reportConfigId CSI-ReportConfigId,
...
Polarization Config ENUMERATED{LHCP,RHCP,LHCP&RHCP}
OPTIONAL,
...
}

The polarization measurement (Polarization Config) field in the CSI ReportConfig field indicates the terminal device to feed back the CSI of the channels in the different polarization manners.

In at least one embodiment, a length of the polarization measurement field in the CSI ReportConfig field is 2 bits. For example, Table 4 shows a correspondence between a polarization measurement field in a CSI ReportConfig field and information fed back by a terminal device. Refer to Table 4. In response to the polarization measurement field being 00, the terminal device to feed back CSI of a channel in left hand circular polarization; in response to the polarization measurement field being 01, the terminal device to feed back CSI of a channel in right hand circular polarization; and in response to the polarization measurement field being 10, the terminal device to feed back CSI of a channel in left hand circular polarization and CSI of a channel in right hand circular polarization.

TABLE 4

| Polarization | Indicate information fed |
|---|---|
| measurement field | back by a terminal device |
| 00 | CSI of a channel in left |
| | hand circular polarization |
| 01 | CSI of a channel in right |
| | hand circular polarization |
| 10 | CSI of a channel in left |
| | hand circular polarization and |
| | CSI of a channel in right |
| | hand circular polarization |

Optionally, the CSI report is carried on a physical uplink control channel (physical uplink control channel, PUCCH) or a physical uplink shared channel (physical uplink shared channel, PUSCH). This is not limited herein.

According to an Xx protocol, the CSI report includes a part 1 and a part 2. In at least one embodiment, in response to the terminal device feeding back the CSI report, in response to the CSI request information indicating the terminal device to feed back CSI of channels in two polarization manners, in response to the terminal device feeding back the CSI report, the terminal device performs the following steps.

The terminal device transmits, in the part 1 and the part 2 in the CSI report, CSI of a channel in one polarization manner, further configures two part fields in the CSI report, which are respectively a part 3 and a part 4, and transmits, in the part 3 and the part 4, CSI of a channel in the other polarization manner.

Alternatively, the terminal device transmits, in the part 1 in the CSI report, CSI of a channel in one polarization manner, and transmits, in the part 2 in the CSI report, CSI of a channel in the other polarization manner. In response to the CSI of the channel in one polarization manner being transmitted in the part 1, the part 1 no longer carries other information. In this case, information with a lower priority in the part 1 is discarded. For example, in response to the terminal device not performing multiple input multiple output (multiple input multiple output, MIMO) transmission, MIMO information is information with a lower priority, and the MIMO information is discarded from the part 1 during transmission, so that the CSI of the channel in one polarization manner is transmitted in the part.

Further, in response to the CSI of the channels in the two polarization manners being transmitted, the CSI of the channel in one polarization manner is a change amount relative to the CSI of the channel in the other polarization manner. For example, in response to the CSI of the channel in one polarization manner being transmitted in the part 1 in the CSI report, and the CSI of the channel in the other polarization manner is transmitted in the part 2 in the CSI report, the CSI of the channel in the other polarization manner in the part 2 is the change amount relative to the CSI of the channel in the polarization manner in the part 1. This reduces overheads of the CSI report.

Manner 3: The network device determines the first indication information based on a service usage of the terminal device.

The service usage of the terminal device includes an uplink service throughput of the terminal device and/or a downlink service throughput of the terminal device. In addition, the service usage herein is a current service usage of the terminal device. This is uniformly described herein. Details are not described below again.

Optionally, the network device determines at least one available polarization manner based on the service usage of the terminal device; and then determine, from the at least one available polarization manner, one available polarization manner as the first polarization manner, and generate the first indication information.

That the network device determines the at least one available polarization manner based on the service usage of the terminal device is implemented in the following manners:

Manner 3.1: In response to a fourth condition being met, downlink cross polarization multiplexing is an available polarization manner. The fourth condition includes: A current downlink polarization manner of the terminal device is a single polarization manner, and the downlink throughput of the terminal device is greater than (or ≥) a first throughput threshold. In this way, in response to a downlink service usage of the terminal device being large, the network device enables downlink polarization multiplexing for the terminal device, to improve a throughput of the terminal device.

For example, polarization manners supported by the terminal device include a left hand circular polarization manner, a right hand circular polarization manner, and left hand circular polarization and right hand circular polarization cross polarization multiplexing. In response to the downlink polarization manner of the terminal device being the left hand circular polarization manner, and the downlink throughput of the terminal device is greater than the first throughput threshold, downlink left hand circular polarization and right hand circular polarization cross polarization multiplexing is the available polarization manner, and downlink left hand circular polarization and right hand circular polarization cross polarization multiplexing is the first polarization manner. The first indication information is generated, where the first indication information indicates that the downlink polarization manner of the terminal device is left hand circular polarization and right hand circular polarization cross polarization multiplexing. A value of the first throughput threshold is determined by the network device or agreed on in a protocol. This is not limited herein.

Manner 3.2: In response to a fifth condition being met, uplink cross polarization multiplexing is an available polarization manner. The fifth condition includes: A current uplink polarization manner of the terminal device is a single polarization manner, and the uplink throughput of the terminal device is greater than (or ≥) a second throughput threshold. In this way, in response to an uplink service usage of the terminal device being large, the network device enables uplink polarization multiplexing for the terminal device, to improve a throughput of the terminal device.

For an example in Manner 3.2, refer to the example in Manner 3.1. Details are not described herein again.

Manner 3.1 and Manner 3.2 are performed together, so that the network device enables uplink and downlink polarization multiplexing for the terminal device in response to both the uplink and downlink service usage of the terminal device being large, thereby improving the throughput of the terminal device.

Manner 3.3: In response to a sixth condition being met, a downlink single polarization manner is an available polarization manner. The sixth condition includes: A current downlink polarization manner of the terminal device is cross polarization multiplexing, and the downlink throughput of the terminal device is less than (or ≤) a third throughput threshold. In this way, in response to a downlink service usage of the terminal device being small, the network device disables downlink polarization multiplexing for the terminal device, to further reduce power consumption of the terminal device.

For example, polarization manners supported by the terminal device include a left hand circular polarization manner, a right hand circular polarization manner, and left hand circular polarization and right hand circular polarization cross polarization multiplexing. In response to the downlink polarization manner of the terminal device being left hand circular polarization and right hand circular polarization cross polarization multiplexing, and the downlink throughput of the terminal device is less than the third throughput threshold, downlink left hand circular polarization manner is the available polarization manner, and the downlink left hand circular polarization manner is the first polarization manner. The first indication information is generated, where the first indication information indicates that the downlink polarization manner of the terminal device is the left hand circular polarization manner. A value of the third throughput threshold is determined by the network device or agreed on in a protocol. This is not limited herein.

Manner 3.4: In response to a seventh condition being met, an uplink single polarization manner is an available polarization manner. The seventh condition includes: A current uplink polarization manner of the terminal device is cross polarization multiplexing, and the uplink throughput of the terminal device is less than (or ≤) a second throughput threshold. In this way, in response to an uplink service usage of the terminal device being small, the network device disables uplink polarization multiplexing for the terminal device, to avoid a waste of air interface resources and reduce power consumption of the terminal.

For an example in Manner 3.4, refer to the example in Manner 3.3. Details are not described herein again.

Manner 3.3 and Manner 3.4 are performed together, so that the network device disables uplink and downlink polarization multiplexing for the terminal device in response to both the uplink and downlink service usage of the terminal device being small, thereby further reducing a throughput of the terminal device.

In Manner 3, before determining the first indication information, the network device further obtains the service usage of the terminal device. An implementation process in which the network device obtains the service usage of the terminal device includes obtaining the uplink service throughput of the terminal device and/or the downlink service throughput of the terminal device.

Manner 4: The network device determines the first indication information based on a polarization manner expected by the terminal device.

The polarization manner expected by the terminal device is a polarization manner that is desired to be scheduled by the network device to the terminal device and that is determined by the terminal device based on a service usage of the terminal device.

Optionally, the network device determines at least one available polarization manner based on the polarization manner expected by the terminal device; and then determine, from the at least one available polarization manner, one available polarization manner as the first polarization manner, and generate the first indication information.

Optionally, the network device determines the polarization manner expected by the terminal device as the available polarization manner. For example, in response to the polarization manner expected by the terminal device being left hand circular polarization, the network device determines left hand circular polarization as the available polarization manner, determine left hand circular polarization as the first polarization manner, and generate the first indication information, where the first indication information indicates that the polarization manner of the terminal device is left hand circular polarization.

In response to a polarization manner of the terminal device being left hand circular polarization and right hand circular polarization cross polarization, in response to the terminal device determines that a service throughput of the terminal device decreasing, the terminal device determines that the polarization manner expected by the terminal device is left hand circular polarization, and request the network device to use left hand circular polarization, thereby reducing device power consumption. For another example, in response to a polarization manner of the terminal device being left hand circular polarization, in response to the terminal device determines that a service throughput of the terminal device increasing, the terminal device determines that the polarization manner expected by the terminal device is left hand circular polarization and right hand circular polarization cross polarization, and request the network device to use left hand circular polarization and right hand circular polarization cross polarization, thereby improving the throughput. In this way, the terminal device applies, based on the service usage of the terminal device, to the network device for whether to use cross polarization multiplexing, so as to flexibly adjust between low power consumption and the high throughput, and improve spectrum efficiency of the polarization manner of the terminal device.

In Manner 4, before determining the first indication information, the network device further obtains the polarization manner expected by the terminal device. For obtaining, by the network device, the polarization manner expected by the terminal device, refer to S1501 to S1503 in the following communication method shown in FIG. 15. Details are not described herein again. The polarization manner expected by the terminal device is carried in various information, for example, a PUCCH or a PUSCH, and sent to the network device. This is not limited herein.

Manner 5: The network device determines the first indication information based on weather information.

The weather information is a weather condition on a signal propagation path between the network device and the terminal device, and the weather condition includes a rainfall (snow) amount and/or a cloud layer thickness. In other words, the weather information includes a rainfall (snow) amount and/or a cloud layer thickness. This is uniformly described herein. Details are not described below again.

Optionally, the network device determines at least one available polarization manner based on the weather information; and then determine, from the at least one available polarization manner, one available polarization manner as the first polarization manner, and generate the first indication information.

In at least one embodiment, in response to an eighth condition being met, the network device determines a single polarization manner as the available polarization manner. The eighth condition includes: The terminal device works in cross polarization multiplexing, and the rainfall (snow) amount is greater than (or ≥) a rainfall (snow) threshold, and/or the cloud layer thickness is greater than (or ≥) a thickness threshold. A value of the thickness threshold is determined by the network device or agreed on in a protocol. This is not limited herein.

In other words, in response to the terminal device working in cross polarization multiplexing, and weather on the signal propagation path between the network device and the terminal device is poor, the network device indicates the terminal device to work in the single polarization manner (for example, left hand circular polarization), to reduce signal interference and improve communication quality.

In Manner 5, before determining the first indication information, the network device further obtains the weather information. That the network device obtains the weather information is implemented as follows: The network device receives current meteorological information from a weather station, and determines, based on the current meteorological information and locations of both the network device and the terminal device, the weather information on the signal propagation path between the network device and the terminal device; or the network device receives current meteorological information from a weather station, and determines, based on the current meteorological information and a coverage area of the network device, the weather information on a signal propagation path of the coverage area of the network device.

Manner 6: The network device determines the first indication information based on a crosstalk status between orthogonally polarized channels.

The crosstalk status between the orthogonally polarized channels includes a crosstalk value between the orthogonally polarized channels, and the crosstalk value is also referred to as a crosstalk degree. This is uniformly described herein. Details are not described below again. A manner of measuring the crosstalk degree between the orthogonally polarized channels is also obtained by performing a mathematical operation on another parameter, for example, “cross polarization discrimination” or “isolation”. A manner of measuring the crosstalk degree by using specific values of these quantities as thresholds is equivalent to that of measuring the crosstalk degree by using the crosstalk value. Details are not described herein again.

Manner 6 includes: The network device determines an available polarization manner and an unavailable polarization manner based on the crosstalk status between the orthogonally polarized channels, and then determines one of the available polarization manners as the first polarization manner by using one or more of the foregoing Manners 1 to 5, to determine the first indication information.

In at least one embodiment, in response to a ninth condition being met, the network device determines a single polarization manner as the available polarization manner, and determine cross polarization multiplexing as the unavailable polarization manner. The ninth condition includes: The crosstalk value between the orthogonally polarized channels corresponding to the terminal device is greater than (or ≥) a first crosstalk threshold. A value of the first crosstalk threshold is determined by the network device or agreed on in a protocol. This is not limited herein. In this way, in response to crosstalk between the orthogonally polarized channels between the network device and the terminal device being severe, the network device limits the polarization manner of the terminal device to the single polarization manner, thereby reducing signal interference and improving communication quality.

In at least one embodiment, in response to a tenth condition being met, the network device determines cross polarization multiplexing as the available polarization manner. The tenth condition includes: The crosstalk value between the orthogonally polarized channels is less than (or ≤) a second crosstalk threshold. A value of the second crosstalk threshold of the terminal device is determined by the network device or agreed on in a protocol. This is not limited herein. In this way, in response to the crosstalk between the orthogonally polarized channels between the network device and the terminal device not being severe, the network device adjusts the polarization manner of the terminal device to cross polarization multiplexing, thereby improving a throughput.

In Manner 6, before determining the first indication information, the network device further obtains crosstalk status information between the orthogonally polarized channels.

Manner 6 is implemented in combination with one or more of the foregoing Manners 1 to 5. For a related combination manner, refer to the following examples including Manner 6 in Example 1 to Example 13.

In at least one embodiment, in response to a trigger condition being met, the network device determines the first indication information based on the trigger condition. The trigger condition includes any one of the first condition to the ninth condition in Manner 2 to Manner 6, and the trigger condition triggers the network device to schedule the polarization manner of the terminal device. In other words, in response to any one of the first condition to the ninth condition being met, the network device determines the first indication information based on a process corresponding to the met condition, and schedule the polarization manner of the terminal device.

In this way, the network device discovers a problem in the polarization manner of the terminal device in time, and adjust a polarization manner of a terminal device in time, so that scheduling of the polarization manner of the terminal device is more flexible, and a scheduling granularity is finer, thereby improving spectral efficiency.

The foregoing Manner 1 to Manner 6 are separately implemented, or is implemented in combination. This is not limited in at least one embodiment. A combination implementation of Manner 1 to Manner 3, Manner 5, and Manner 6 is described below by using several examples.

Example 1: In response to Manner 1, Manner 2, Manner 3, Manner 5, and Manner 6 being combined for implementation, the network device determines, from the polarization manners supported by the terminal device, one polarization manner as the first polarization manner based on the CSI of the channels in the different polarization manners measured by the terminal device, the service usage of the terminal device, the weather information, and the crosstalk status between the orthogonally polarized channels, to determine the first indication information.

That the network device determines, from the polarization manners supported by the terminal device, one polarization manner as the first polarization manner based on the CSI of the channels in the different polarization manners measured by the terminal device, the service usage of the terminal device, the weather information, and the crosstalk status between the orthogonally polarized channels includes: The network device determines at least one available polarization manner (denoted as a first set) based on the CSI of the channels in the different polarization manners measured by the terminal device; the network device determines at least one available polarization manner (denoted as a second set) based on the service usage of the terminal device; the network device determines at least one available polarization manner (denoted as a third set) based on the weather information; the network device determines at least one available polarization manner (denoted as a fourth set) based on the crosstalk status between the orthogonally polarized channels; and the network device uses, in polarization manners included in the first set to the fifth set, one of the polarization manners supported by the terminal device as the first polarization manner.

The network device determines the at least one available polarization manner based on different information (including any one of the CSI of the channels in the different polarization manners measured by the terminal device, the service usage of the terminal device, the weather information, and the crosstalk status between the orthogonally polarized channels). For details, refer to a process in which the network device determines the at least one available polarization manner in Manner 2 to Manner 6. Details are not described herein again.

In other words, in response to the foregoing plurality of manners being implemented in combination, the network device separately determines a plurality of polarization manner sets based on different information, and use, as the first polarization manner, one of the polarization manners supported by the terminal device, in polarization manners included in the plurality of polarization manner sets.

Example 2: In response to Manner 1 and Manner 2 being combined for implementation, the network device determines, from the polarization manners supported by the terminal device, one polarization manner as the first polarization manner based on the CSI of the channels in the different polarization manners measured by the terminal device, to determine the first indication information. For example, the network device selects, from one or more polarization manners in response to the CSI of the channels being greater than (or ≥) the CSI threshold, one of the polarization manners supported by the terminal device as the first polarization manner, to determine the first indication information.

In response to Manner 1 to Manner 3, Manner 5, and Manner 6 being combined for implementation, a plurality of manners are randomly selected for combination implementation. For a specific implementation process, refer to the foregoing examples. Examples are not provided herein one by one.

With reference to the foregoing descriptions of Manner 1 to Manner 6, the network device determines the first indication information based on one or more of the polarization manner supported by the terminal device, the CSI of the channels in the different polarization manners measured by the terminal device, the service usage of the terminal device, the polarization manner expected by the terminal device, the weather condition between the terminal device and the network device, and the crosstalk status between the orthogonally polarized channels. In other words, the first indication information is determined based on one or more of the following: the polarization manner supported by the terminal device, the CSI of the channels in the different polarization manners measured by the terminal device, the service usage of the terminal device, the polarization manner expected by the terminal device, the weather condition between the terminal device and the network device, or the crosstalk status between the orthogonally polarized channels.

In Manner 1 to Manner 6, the network device determines, with reference to a plurality of types of information, a polarization manner that is more appropriate for the terminal device, and schedule the polarization manner for the terminal device by using the first indication information. This enables, in one aspect, the terminal device to work in a better polarization manner, improve communication quality, and reduce power consumption, in another aspect, scheduling of the polarization manner for the terminal device is more flexible, and a scheduling granularity is finer, thereby improving spectral efficiency.

Optionally, the first polarization manner includes a first uplink polarization manner and/or a first downlink polarization manner. The first uplink polarization manner includes any one of uplink left hand circular polarization, uplink right hand circular polarization, uplink horizontal polarization, uplink vertical polarization, uplink +45° polarization, uplink −45° polarization, uplink horizontal and vertical cross polarization multiplexing, uplink ±450 cross polarization multiplexing, and uplink left hand circular polarization or right hand circular polarization cross polarization multiplexing. The first downlink polarization manner includes any one of downlink left hand circular polarization, downlink right hand circular polarization, downlink horizontal polarization, downlink vertical polarization, downlink +45° polarization, downlink −45° polarization, downlink horizontal and vertical cross polarization multiplexing, downlink ±45° cross polarization multiplexing, and downlink left hand circular polarization or right hand circular polarization cross polarization multiplexing. Similarly, a second polarization manner to a fourth polarization manner below is also classified into an uplink polarization manner and a downlink polarization manner. For a division principle, refer to the foregoing first polarization manner. This is uniformly described herein. Details are not described below again.

At least one embodiment includes the foregoing Manner 1 to Manner 6 and the following Manner 7 to Manner 30. For a polarization manner that is not specified as an uplink polarization manner and/or a downlink polarization manner, the polarization manner is not limited in at least one embodiment to an uplink polarization manner and/or a downlink polarization manner. In other words, the polarization manner that is not specified as the uplink polarization manner and/or the downlink polarization manner is any one of an uplink polarization manner, a downlink polarization manner, or an uplink/downlink polarization manner. For example, left hand circular polarization is uplink left hand circular polarization, downlink left hand circular polarization, or uplink and downlink left hand circular polarization. In at least one embodiment, the first polarization manner, the second polarization manner, a third polarization manner, the fourth polarization manner, the polarization manner A, the polarization manner B, a polarization manner C, and a polarization manner D are similar. Details are not described again.

Optionally, the first indication information further indicates duration of the first polarization manner.

The duration of the first polarization manner is understood as a time length for the terminal device to continuously work in the first polarization manner. The duration of the first polarization manner is also referred to as a timer of the first polarization manner. In response to the timer expiring, the terminal device restores a default polarization manner of a cell broadcast by the network device.

In this way, the network device indicates the duration in which the terminal device works in the first polarization manner, and after the duration indicated by the first indication information expires, the terminal device is restored to a previous polarization manner. The network device no longer indicates, by using one piece of indication signaling, the terminal device to restore to the previous polarization manner. This reduces signaling overheads, avoids the network device waiting for a long time for feedback of the terminal device on the indication signaling, and further improves flexibility of scheduling the polarization manner of the terminal device.

That the first indication information indicates the duration of the first polarization manner is implemented in the following Manner 7 and Manner 8.

Manner 7: The first indication information includes duration information, and the duration information indicates the duration of the first polarization manner. For example, the first indication information indicates that the polarization manner of the terminal device is left hand circular polarization, and the duration information included in the first indication information is 5 seconds (second, s), the first indication information further indicates that the terminal device works in the left hand circular polarization manner for 5s. After 5s expire, the terminal device is restored to the default polarization manner of the cell broadcast by the network device.

Manner 8: The first indication information includes a timer index (which is also referred to as an index for short), and the timer index indicates the duration of the first polarization manner. A timer index 1 is determined based on timer configuration information to indicate that the duration of the first polarization manner is 5s, and the first indication information indicates that the polarization manner of the terminal device is left hand circular polarization, and the timer index included in the first indication information is 1. In this case, the first indication information further indicates that the terminal device works in the left hand circular polarization manner for 5s. After 5s expires, the terminal device is restored to the default polarization manner of the cell broadcast by the network device.

A manner of obtaining the timer configuration information includes: The network device and the terminal device obtain the same timer configuration information through negotiation or in a manner of configuring by the network device for the terminal device. The timer configuration information includes a correspondence between at least one timer index and at least one timer, and the timer indicates the duration of the first polarization manner. For example, as shown in Table 5, Table 5 shows a one-to-one correspondence between three timer indexes and three timers. As shown in Table 5, timer indexes 1, 2, and 3 respectively correspond to timers 5s, 10s, and 15s.

TABLE 5

| Timer index | Timer |
|---|---|
| 1 | 5 s |
| 2 | 10 s |
| 3 | 15 s |

A quantity of bits for transmitting the timer index is usually less than a quantity of bits for transmitting the duration information. The timer index is introduced, which reduces overheads of the first indication information.

Optionally, the network device broadcasts the default polarization manner of the cell. Correspondingly, the terminal device accepts the default polarization manner of the cell broadcast by the network device. For example, the network device sends the default polarization manner of the cell to all terminal devices in the cell by using an SIB. In this way, the terminal device works in the default polarization manner, to communicate with the network device.

In response to broadcasting the default polarization manner of the cell, the network device periodically broadcasts the default polarization manner of the cell. A length of the periodicity herein is determined by the network device or agreed on in a protocol. This is not limited herein.

Further, the network device determines the default polarization manner based on polarization manners supported by all the terminal devices in the cell, and broadcasts the default polarization manner.

For example, the network device determines, as the default polarization manner based on the polarization manners supported by all the terminal devices in the cell, one of the polarization manners supported by all the terminal devices in the cell, and broadcast the default polarization manner; or the network device determines, as the default polarization manner based on the polarization manners supported by all the terminal devices in the cell, one of the polarization manners supported by terminal devices whose proportion is greater than (or ≥) a first proportion (for example, 80%) in the cell, and broadcast the default polarization manner. The first proportion herein is determined by the network device or agreed on in a protocol. This is not limited herein.

Further, the network device periodically determines the default polarization manner based on the polarization manners supported by all the terminal devices in the cell, and broadcast the default polarization manner. A length of the periodicity herein is determined by the network device or agreed on in a protocol. This is not limited herein.

Optionally, the network device broadcasts the timer configuration information. The timer configuration information includes a correspondence between at least one timer index and at least one timer, and the timer indicates the duration of the first polarization manner. For example, the network device sends the timer configuration information to all the terminal devices in the cell by using an SIB.

The timer configuration information is implemented in the following two manners.

In a first manner, the timer configuration information includes a one-to-one correspondence between at least one timer index and at least one timer. As shown in Table 5, the timer indexes 1, 2, and 3 respectively correspond to the duration of the first polarization manner being 5s, 10s, and 15s.

In a second manner, the timer configuration information includes a correspondence between at least one timer index and at least one timer, where one or more indexes correspond to one timer.

Optionally, the network device determines the default polarization manner of the cell based on CSI of channels in different polarization manners measured by all the terminal devices in the cell. For example, the network device determines, from polarization manners supported by all the terminal devices in the cell, a polarization manner that meets a condition 1 as the default polarization manner. The condition 1 includes: CSI of a channel in a polarization manner is greater than (or ≥) a CSI threshold.

Optionally, the network device determines the timer configuration information based on historical data.

Further, the network device periodically determines the default polarization manner of the cell based on the CSI of the channels in the different polarization manners measured by all the terminal devices in the cell. A length of the periodicity herein is determined by the network device or agreed on in a protocol. This is not limited herein.

Further, the network device periodically determines the timer configuration information based on the historical data. A length of the periodicity herein is determined by the network device or agreed on in a protocol. This is not limited herein.

Optionally, the network device sends default polarization indication information to the terminal device, where the default polarization indication information indicates the default polarization manner of the terminal device. The default polarization manner of the terminal device is a polarization manner of the terminal device in response to the network device not indicating the polarization manner of the terminal device.

In at least one embodiment, in response to the duration of the first polarization manner indicated by the first indication information expiring, the terminal device switches the polarization manner to a previous first polarization manner that is performed by the terminal device and whose duration is not indicated, that is, switch to a previous first polarization manner configured without a timer. In other words, the terminal device is restored to a previous first polarization manner configured without a timer.

Alternatively, in response to the duration of the first polarization manner indicated by the first indication information expiring, the terminal device switches the polarization manner to the default polarization manner of the terminal device indicated by the network device. In other words, the terminal device restores the default polarization manner of the terminal device.

Optionally, in response to a tenth condition being met, the network device determines that cross polarization multiplexing is the first polarization manner; and the network device further obtains first service usage time of the terminal device, and determine the first indication information based on the first service usage time. The first indication information indicates that the polarization manner of the terminal device is the first polarization manner (namely, cross polarization multiplexing), and the first indication information further indicates the duration of the first polarization manner. The duration of the first polarization manner is greater than (or ≥) the first service usage time.

The tenth condition includes: A current polarization manner of the terminal device is a single polarization manner, and a throughput of the terminal device is greater than (or ≥) a first throughput threshold. The first service usage time is time in which the throughput of the terminal device is continuously greater than (or ≥) the first throughput threshold. For example, in response to time in which the throughput of the terminal device being continuously greater than the first throughput threshold in a future period of time is 10s, the first service usage time is 10s. A service throughput of the terminal device in the future 10s is large.

For example, the polarization manners supported by the terminal device include a left hand circular polarization manner, a right hand circular polarization manner, and left hand circular polarization and right hand circular polarization cross polarization multiplexing. In response to the polarization manner of the terminal device being the left hand circular polarization manner, and the throughput of the terminal device is greater than the first throughput threshold (that is, the tenth condition is met), the network device determines that left hand circular polarization and right hand circular polarization cross polarization multiplexing is the first polarization manner. The network device further obtains the first service usage time of the terminal device. The first service usage time is 10s, the network device determines the first indication information based on the first service usage time, where the first indication information indicates that the polarization manner of the terminal device is left hand circular polarization and right hand circular polarization cross polarization multiplexing, and the first indication information further indicates that the duration in which the terminal device works in left hand circular polarization and right hand circular polarization cross polarization multiplexing is 10s.

In this way, after the duration indicated by the first indication information expires, the terminal device returns from cross polarization multiplexing to the single polarization manner, so that the terminal device automatically disables cross polarization multiplexing in response to the first service usage time of the terminal device ending, thereby reducing power consumption. In addition, the network device no longer indicates, by using one piece of indication signaling, the terminal device to restore to the previous polarization manner. This reduces signaling overheads, and avoids the network device waiting for a long time for feedback of the terminal device on the indication signaling.

Optionally, in response to an eleventh condition being met, the network device determines that a single polarization manner is the first polarization manner; and the network device further obtains second service usage time of the terminal device, and determine the first indication information based on the second service usage time. The first indication information indicates that the polarization manner of the terminal device is the first polarization manner (namely, the single polarization manner), and the first indication information further indicates the duration of the first polarization manner. The duration of the first polarization manner is greater than (or ≥) the second service usage time.

The eleventh condition includes: A current polarization manner of the terminal device is cross polarization multiplexing, and a throughput of the terminal device is less than (or ≤) a third throughput threshold. The second service usage time is time in which the throughput of the terminal device is continuously less than (or ≤) the third throughput threshold. For example, in response to time in which the throughput of the terminal device being continuously less than the third throughput threshold in a future period of time being 10s, the second service usage time is 10s. A service throughput of the terminal device in the future 10s is small.

For example, the polarization manners supported by the terminal device include a left hand circular polarization manner, a right hand circular polarization manner, and left hand circular polarization and right hand circular polarization cross polarization multiplexing. In response to the polarization manner of the terminal device being left hand circular polarization and right hand circular polarization cross polarization multiplexing, and the throughput of the terminal device is less than the third throughput threshold (that is, the eleventh condition is met), the network device determines that the left hand circular polarization manner is the first polarization manner. The network device further obtains the second service usage time of the terminal device. The second service usage time is 10s, the network device determines the first indication information based on the second service usage time, where the first indication information indicates that the polarization manner of the terminal device is the left hand circular polarization manner, and the first indication information further indicates that the duration in which the terminal device works in the left hand circular polarization manner is 10s.

In this way, after the duration indicated by the first indication information expires, the terminal device returns from the single polarization manner to cross polarization multiplexing, so that the terminal device automatically wakes up cross polarization multiplexing in response to the second service usage time of the terminal device ends, thereby improving the throughput. In addition, the network device no longer indicates, by using one piece of indication signaling, the terminal device to restore to the previous polarization manner. This reduces signaling overheads, and avoids the network device waiting for a long time for feedback of the terminal device on the indication signaling.

In at least one embodiment, the first indication information is carried in terminal-level information.

The terminal-level information is understood as information sent by the network device for a specific terminal device. The first indication information is carried in the terminal-level information, and indicates that a device scheduled by using the first indication information is a terminal device.

Optionally, the terminal-level information is any one of RRC signaling, a MAC CE, a CSI-RS, and DCI. In other words, the first indication information is carried in any one of RRC signaling, a MAC CE, a CSI-RS, and DCI. The following separately describes at least one embodiment.

In response to the first indication information being carried in the RRC signaling, the first indication information is carried in UE specific RRC signaling. For example, one or more bits in the UE specific RRC signaling is used to carry the first indication information.

In response to the first indication information being carried in the MAC CE, the first indication information is implemented by using an index of the MAC CE. For example, one or more bits corresponding to the index of the MAC CE is used to carry the first indication information.

For example, Table 6 corresponds to a downlink shared channel (downlink shared channel, DL-SCH) logical channel identifier (logical channel ID, LCID) value (value), and Table 7 corresponds to an uplink shared channel (uplink shared channel, UL-SCH) LCID value. Refer to Table 6 and Table 7. In response to the first indication information indicating the first downlink polarization manner of the terminal device, one or more bits in reserved fields 01011 to 11011 in Table 6 is used to carry the first indication information; in response to the first indication information indicating the first uplink polarization manner of the terminal device, one or more bits in reserved fields 01011 to 11001 in Table 7 is used to carry the first indication information; or in response to the first indication information indicating the first downlink polarization manner and the first uplink polarization manner of the terminal device, one or more bits in reserved fields 01011 to 11011 in Table 6 and one or more bits in reserved fields 01011 to 11001 in Table 7 are used to carry the first indication information.

TABLE 6

| Index (index) | LCID value |
|---|---|
| 00000 | Common control channel (common control channel, |
| | CCCH) |
| 00001~01010 | Identity of the logical channel (identity of the |
| | logical channel) |
| 01011~11011 | Reserved (reserved) |
| 11100 | UE contention resolution identity (UE contention |
| | resolution identity) |
| 11101 | Timing advance command (timing advance command) |
| 11110 | Discontinuous reception (discontinuous reception, |
| | DRX) command (command) |
| 11111 | Padding (padding) |

TABLE 7

| Index | LCID value |
|---|---|
| 00000 | CCCH |
| 00001~01010 | Identity of the logical channel |
| 01011~11001 | Reserved |
| 11010 | Power headroom report (power headroom report) |
| 11011 | Cell radio network temporary identifier (cell radio |
| | network temporary identifier, C-RNTI) |
| 11100 | Truncated (truncated) buffer status report (buffer |
| | status report, BSR) |
| 11101 | Short (short) BSR |
| 11110 | Long (long) BSR |
| 11111 | Padding |

In response to the first indication information being carried in the DCI, the first indication information is implemented by using control signaling carried in a DCI format (format). For example, the first indication information is carried by using a DCI format X. One or more bits in a DCI format 1 are used to carry the first indication information. A value of “X” in the DCI format X is 00, 01, 1_0, 1_1, 2_0, or the like. With development of communication technologies, X is more values. A value of X is not limited in at least one embodiment.

In response to the first indication information being carried in the CSI-RS, a time-frequency distribution characteristic in the CSI-RS is used to carry the first indication information. For example, the first indication information is one or more of a carrier of the CSI-RS and a resource element, and the one or more of the carrier and the resource element indicates the first polarization manner. The network device configures, for the terminal device in advance, a correspondence between a plurality of polarization manners and one or more of a carrier of the CSI-RS and a resource element. In response to determining that the first indication information indicates the first polarization manner of the terminal device, the network device indicates the first polarization manner of the terminal device by using the one or more of the carrier and the resource element of the CSI-RS. In other words, the one or more of the carrier of the CSI-RS and the resource element implicitly indicate the first polarization manner. In at least one embodiment, time-frequency is understood as a time domain resource and a frequency domain resource.

For example, the resource element of the CSI-RS indicates the first polarization manner of the terminal device. The network device configures in advance a correspondence between the resource elements of the CSI-RS and a plurality of polarization manners for the terminal device, as shown in Table 8, and in response to the network device determining, in any one of the foregoing manners, that the first indication information indicates that the polarization manner of the terminal device is left hand circular polarization, the network device indicates the first indication information by using a frequency f0+300 of the CSI-RS.

TABLE 8

| CSI-RS index | Indicated polarization manner |
|---|---|
| Frequency f0 + 100 | Left hand circular polarization and right |
| | hand circular polarization cross |
| | polarization multiplexing |
| Frequency f0 + 200 | Right hand circular polarization |
| Frequency f0 + 300 | Left hand circular polarization |

For another example, the network device configures in advance a correspondence between the resource elements of the CSI-RS and a plurality of polarization manners for the terminal device, as shown in Table 9, and in response to the network device determining, in any one of the foregoing manners, that the first indication information indicates that the polarization manner of the terminal device is left hand circular polarization, the network device implements the first indication information by using a frequency range f0+300˜400 of the CSI-RS.

TABLE 9

| CSI-RS index | Indicated polarization manner |
|---|---|
| Frequency range f0 + 100~200 | Left hand circular polarization and |
| | right hand circular polarization |
| | cross polarization multiplexing |
| Frequency range f0 + 200~300 | Right hand circular polarization |
| Frequency range f0 + 300~400 | Left hand circular polarization |

With reference to the examples corresponding to Table 8 and Table 9, in response to the resource unit indicating the first polarization manner, a frequency is used to indicate the first polarization manner, or a frequency range is used to indicate the first polarization manner. This is not limited herein.

With reference to the foregoing implementation of carrying the first indication information, one or more bits in the terminal-level information is used to carry the first indication information, and values of the one or more bits in the terminal-level information is used to indicate the first polarization manner of the terminal device. For how to use the one or more bits in the terminal-level information to carry the first indication information, the following separately describes at least one embodiment.

Manner 9: Two bits in the terminal-level information are used to carry the first indication information. The two bits indicate the first polarization manner of the terminal device in an indication manner shown in Table 10. That the polarization manner of the terminal device is unchanged means that the polarization manner of the terminal device is the default polarization manner of the cell, or the polarization manner of the terminal device remains unchanged. This is not limited herein.

TABLE 10

| Value of bits carrying first | |
|---|---|
| indication information | Indication |
| 00 | The downlink polarization manner of the |
| | terminal device is unchanged. |
| 01 | The downlink polarization manner of the |
| | terminal device is left hand circular |
| | polarization. |
| 10 | The downlink polarization manner of the |
| | terminal device is right hand circular |
| | polarization. |
| 11 | The downlink polarization manner of the |
| | terminal device is left hand circular |
| | polarization and right hand circular |
| | polarization cross polarization |
| | multiplexing. |

In Table 10, the value of the bits carrying the first indication information indicates the first downlink polarization manner of the terminal device. For example, in response to the value of the bits carrying the first indication information being 01, the downlink polarization manner of the terminal device is left hand circular polarization. In this case, an uplink polarization manner of the terminal device is not indicated, and the uplink polarization manner of the terminal device is the same as the downlink polarization manner. In other words, in Table 10, the value of the bits carrying the first indication information implicitly indicates the first uplink polarization manner of the terminal device. For example, in response to the value of the bits carrying the first indication information being 01, the downlink polarization manner of the terminal device is left hand circular polarization, and implicitly indicates that an uplink polarization manner of the terminal device is left hand circular polarization.

Alternatively, two bits are used to indicate the downlink polarization manner of the terminal device, and another two bits are used to indicate an uplink polarization manner of the terminal device. For the two bits indicating the downlink polarization manner of the terminal device, refer to Table 10, and the another two bits indicate the first polarization manner of the terminal device in an indication manner shown in Table 11.

TABLE 11

| Value of bits carrying first | |
|---|---|
| indication information | Indication |
| 00 | An uplink polarization manner of a |
| | terminal device is unchanged. |
| 01 | The uplink polarization manner of the |
| | terminal device is left hand circular |
| | polarization. |
| 10 | The uplink polarization manner of the |
| | terminal device is right and circular |
| | polarization. |
| 11 | The uplink polarization manner of the |
| | terminal device is left hand circular |
| | polarization and right hand circular |
| | polarization cross polarization |
| | multiplexing. |

Manner 9 is applied to a process in which the network device determines the first indication information in Manner 2.

Manner 10: One bit in the terminal-level information is used to carry the first indication information. The bit indicates the first polarization manner of the terminal device in an indication manner shown in Table 12.

TABLE 12

| Value of a bit carrying first | |
|---|---|
| indication information | Indication |
| 0 | A polarization manner of a terminal |
| | device is a first single polarization |
| | manner. |
| 1 | The polarization manner of the terminal |
| | device is cross polarization multiplexing |
| | corresponding to the first single |
| | polarization manner. |

The first single polarization manner is the single polarization manner scheduled by the network device to the terminal device, for example, left hand circular polarization. This is uniformly described herein. Details are not described below again. Cross polarization multiplexing corresponding to the first single polarization manner means that one of two orthogonal single polarization manners in cross polarization multiplexing is the first single polarization manner. This is uniformly described herein. Details are not described below again. For example, in response to the first single polarization manner being left hand circular polarization, cross polarization multiplexing corresponding to the first single polarization manner is left hand circular polarization and right hand circular polarization cross polarization multiplexing.

Manner 11: Two bits in the terminal-level information are used to carry the first indication information. The two bits indicate the first polarization manner of the terminal device in an indication manner shown in Table 13.

TABLE 13

| Value of bits carrying first | |
|---|---|
| indication information | Indication |
| 00 | Both an uplink polarization manner and a |
| | downlink polarization manner of a terminal |
| | device are a first single polarization manner. |
| 01 | The uplink polarization manner of the |
| | terminal device is the first |
| | single polarization manner, and the |
| | downlink polarization manner of the |
| | terminal device is cross polarization |
| | multiplexing corresponding to the first |
| | single polarization manner. |
| 10 | The uplink polarization manner of the |
| | terminal device is cross polarization |
| | multiplexing corresponding to the first |
| | single polarization manner, and the |
| | downlink polarization manner of the |
| | terminal device is the first single |
| | polarization manner. |
| 11 | Both the uplink polarization manner and |
| | the downlink polarization manner of the |
| | terminal device are cross polarization |
| | multiplexing corresponding to the first |
| | single polarization manner. |

Manner 12: Two bits in the terminal-level information are used to carry the first indication information. The two bits indicate the first polarization manner of the terminal device in an indication manner shown in Table 14.

TABLE 14

| Value of bits carrying first | |
|---|---|
| indication information | Indication |
| 00 | A downlink polarization manner of a |
| | terminal device is cross polarization |
| | multiplexing corresponding to a first single |
| | polarization manner, and an uplink |
| | polarization manner is the first single |
| | polarization manner. |
| 01 | The downlink polarization manner of the |
| | terminal device is the first single |
| | polarization manner, and the uplink |
| | polarization manner is cross polarization |
| | multiplexing corresponding to the first |
| | single polarization manner. |
| 10 | Both the uplink polarization manner and |
| | the downlink polarization manner of the |
| | terminal device are cross polarization |
| | multiplexing corresponding to the first |
| | single polarization manner. |
| 11 | Both the downlink polarization manner |
| | and the uplink polarization manner of the |
| | terminal device are the default |
| | polarization manner of the cell. |

Manner 10 to Manner 12 are applied to a process in which the network device determines the first indication information in Manner 3, for example, Manner 3.1 to Manner 3.4.

The foregoing implementation of using one or more bits in the terminal-level information to carry the first indication information is merely an example, and is not limited herein. In actual application, the implementation is adjusted based on a usage, and an adjusted implementation is not enumerated herein.

In at least one embodiment, the first indication information indicates that a polarization manner corresponding to a first resource is the first polarization manner, and the first resource includes any one of a time-frequency domain resource, a time domain resource, and a frequency domain resource.

For example, the first resource includes the time-frequency domain resource. The UE specific RRC, MAC CE and DCI is used to jointly indicate that the polarization manner corresponding to the first resource is the first polarization manner.

For example, the DCI is used to indicate the time-frequency domain resource of the terminal device, and the UE-specific RRC is used to indicate that the polarization manner corresponding to the time-frequency domain resource is the first polarization manner.

For another example, the DCI is used to indicate the time-frequency domain resource of the terminal device, and the MAC CE is used to indicate that the polarization manner corresponding to the time-frequency domain resource is the first polarization manner.

Certainly, physical resources that have different polarization directions but a same time-frequency is also used as different physical resources, and are indicated by using any one of the UE specific RRC, MAC CE and DCI.

In other words, based on the first indication information, for one time-frequency domain resource, the network device divides the time-frequency domain resource into time-frequency domain resources corresponding to different polarization manners. For example, for an RE, the network device divides the RE into an RE corresponding to left hand circular polarization and an RE corresponding to right hand circular polarization, and schedule the RE corresponding to left hand circular polarization and the RE corresponding to right hand circular polarization to same UE or different UE. In this way, the network device flexibly schedules resources to different UEs in time domain, frequency domain, and a polarization manner domain, thereby improving scheduling flexibility and spectral efficiency, and meeting different service usages.

In response to the first resource including the time domain resource or the frequency domain resource, an indication manner of the first indication information is similar. Details are not described herein again.

A figure shows an example. FIG. 7 is a schematic diagram of resource mapping in a beam with a combination of polarization manners according to at least one embodiment. As shown in FIG. 7, each grid in a coordinate system in FIG. 7 represents one RE. The network device allocates, by using radio resource management (radio resource management, RRM), LHCP and RHCP corresponding to a same RE to same UE, or LHCP and RHCP corresponding to a same RE to different UE. For example, in FIG. 7, an RE (denoted as an RE 1) numbered 1 and an RE (denoted as an RE 2) numbered 2 have a same time-domain location and a same frequency-domain location, but a polarization manner corresponding to the RE 1 is left hand circular polarization, and a polarization manner corresponding to the RE 2 is right hand circular polarization. The RE 1 is scheduled to UE 2, and the RE 2 is scheduled to UE 5. Scheduling of another RE in FIG. 7 is similar to that of the RE 1 and the RE 2. Details are not described herein again.

The foregoing uses a minimum unit RE of resource scheduling as an example for description. In an actual system, a granularity of resource scheduling is greater than an RE, for example, an RE block (block) or an RE group (group). Details are not described herein again.

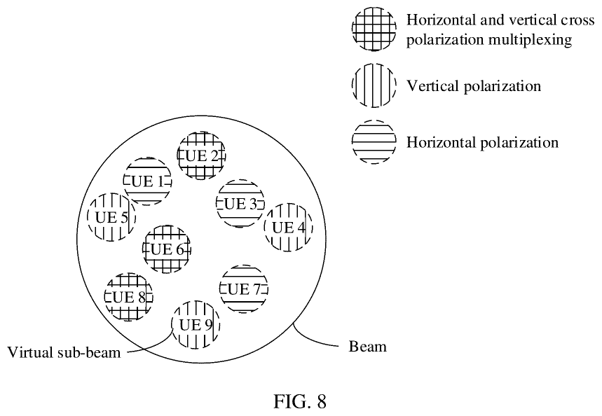

FIG. 8 is a schematic diagram of virtual sub-beams formed in a beam by using RRM in a unit of UE in space according to at least one embodiment. As shown in FIG. 8, the virtual sub-beams with different physical resources are scheduled for different UE in the beam by using RRM based on the first indication information. Time-frequency domain resources of these virtual sub-beams are the same or different. The formed virtual sub-beams change with a resource scheduling process of the UE. In this way, in at least one embodiment, the polarization manner domain (or a polarization domain for short) is added in time domain and frequency domain, and the resources are flexibly scheduled to different REs in time domain, frequency domain, and the polarization manner domain, thereby improving scheduling flexibility and spectral efficiency, and meeting different service usages.

The network device (for example, a satellite) simultaneously enables two orthogonally polarization directions for one beam, but does not indicate that all UE in a beam range uses cross polarization multiplexing.

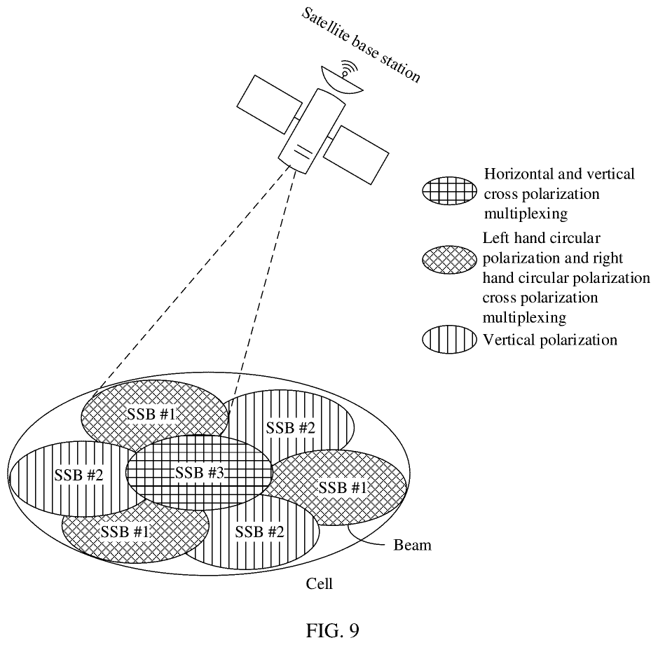

In addition, as shown in FIG. 9, different SSBs (or bandwidth parts (bandwidth parts, BWPs)) in the cell correspond to frequency domain resources that are not totally the same. Cross polarization multiplexing is used for at least one beam in the cell shown in FIG. 9. For example, a beam using horizontal and vertical cross polarization multiplexing is an SSB #3 in FIG. 9. In a coverage area of the beam represented by the SSB #3, in response to UE 1 working in horizontal and vertical cross polarization multiplexing, both a horizontal polarization resource and a vertical polarization resource of a resource block (resource block, RB) used by the UE 1 in the beam represented by the SSB #3 are occupied by the UE 1. For another UE, in response to UE 2 working in a horizontal polarization manner, a horizontal polarization manner of an RB used by the UE 2 in the beam represented by the SSB #3 is occupied by the UE 2, and a vertical polarization manner of the RB is allocated to another UE (for example, UE 3). For polarization manners corresponding to the UE 1 to the UE 3 and indication manners of time-frequency domain resources, refer to the foregoing description in which the UE specific RRC, MAC CE and DCI are jointly used to indicate that the polarization manner corresponding to the first resource is the first polarization manner. In this way, the network device implements the irregular UE-level virtual sub-beams in the same beam by using RRM based on the first indication information, so that the UE uses one RB in the cross polarization multiplexing manner, thereby improving the throughput. In addition, some UE flexibly uses a single polarization manner in cross polarization multiplexing to share an RB, thereby avoiding interference between UE and improving resource utilization.

Further, the first resource includes a first uplink resource and/or a first downlink resource. In response to the first resource including the first uplink resource, the first indication information indicates that a polarization manner corresponding to the first uplink resource of the terminal device is the first uplink polarization manner. In response to the first resource including the first downlink resource, the first indication information indicates that a polarization manner corresponding to the first downlink resource of the terminal device is the first downlink polarization manner. In response to the first resource including the first uplink resource and the first downlink resource, the first indication information indicates that a polarization manner corresponding to the first uplink resource of the terminal device is the first uplink polarization manner and a polarization manner corresponding to the first downlink polarization manner is the first downlink polarization manner.

In the communication method shown in FIG. 6, the first indication information is used to schedule the polarization manner of the terminal device and is carried in the terminal-level information, such as the RRC signaling, DCI, and MAC CE. In this way, the network device schedules the polarization manner of the terminal device at the terminal level, that is, the network device adjusts a polarization manner of a terminal device, so that scheduling of the polarization manner of the terminal device is more flexible, and a scheduling granularity is finer, thereby improving spectral efficiency.

Embodiments described herein schedule the polarization manner of the terminal device at the beam level.

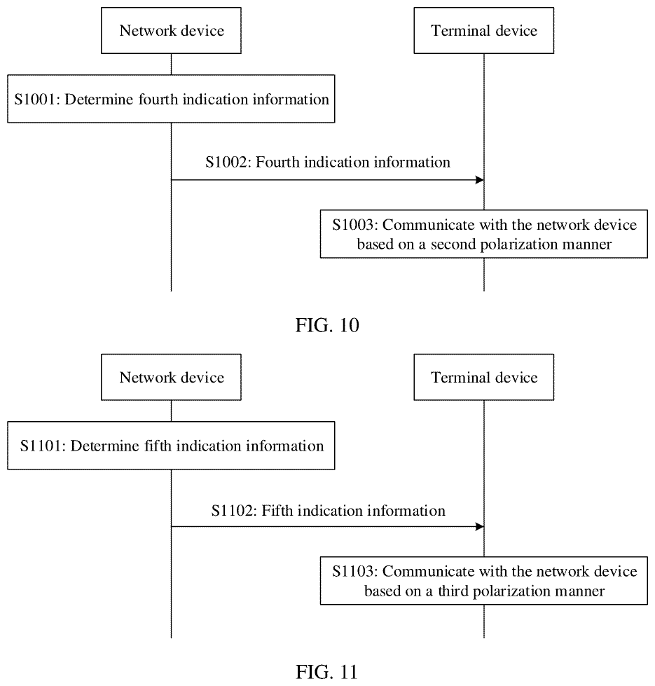

FIG. 10 is a schematic flowchart of a communication method according to at least one embodiment. The communication method is applied to the foregoing communication system, and is performed by the terminal device or the network device in the foregoing communication system. According to the communication method, the polarization manner of the terminal device is scheduled at the beam level, that is, the network device adjusts the polarization manner of the terminal device in a beam, so that scheduling of the polarization manner of the terminal device is more flexible and a scheduling granularity is finer, thereby improving spectral efficiency. The method includes S1001 to S1003, which are sequentially provided below.

S1001: The network device determines fourth indication information.

The fourth indication information indicates a second polarization manner of a first beam. In other words, the fourth indication information indicates that a polarization manner of a first beam is switched to a second polarization manner; or the fourth indication information indicates that a first beam works in a second polarization manner; or the fourth indication information indicates that a polarization manner of a first beam is a second polarization manner; or the fourth indication information indicates that a polarization manner of the terminal device in a first beam is a second polarization manner. Unless otherwise specified, meanings to be expressed in the several manners of expressing the fourth indication information are consistent, and is mixed. The first beam herein is any beam in a beam set of the network device, and includes an uplink beam and/or a downlink beam.

The second polarization manner includes any one of left hand circular polarization, right hand circular polarization, linear polarization, or cross polarization multiplexing. Linear polarization includes any one of horizontal polarization, vertical polarization, +45° polarization, and −45° polarization. Cross polarization multiplexing includes any one of horizontal and vertical cross polarization multiplexing, ±45° cross polarization multiplexing, and left hand circular polarization and right hand circular polarization cross polarization multiplexing.

S1002: The network device sends the fourth indication information to the terminal device in the first beam. Correspondingly, the terminal device in the first beam receives the fourth indication information from the network device.

S1003: The terminal device in the first beam communicates with the network device based on the second polarization manner.

That the terminal device in the first beam communicates with the network device based on the second polarization manner is understood as that the terminal device in the first beam works in the second polarization manner, or is understood as that the terminal device in the first beam switches the polarization manner to the second polarization manner.

For example, in response to the second polarization manner, of the first beam, indicated by the fourth indication information being left hand circular polarization, the terminal device in the first beam works in the left hand circular polarization manner, to implement communication with the network device. In response to the second polarization manner, of the first beam, indicated by the fourth indication information being left hand circular polarization and right hand circular polarization cross polarization multiplexing, the terminal device in the first beam works in the left hand circular polarization and right hand circular polarization cross polarization multiplexing polarization manner, to implement communication with the network device.

That the network device determines the fourth indication information in S1001 is implemented in the following Manner 13 to Manner 18, which are sequentially described below.

Manner 13: The network device determines the fourth indication information based on polarization manners supported by all terminal devices in the first beam.

Optionally, the network device determines, from the polarization manners supported by all the terminal devices in the first beam, one polarization manner as the second polarization manner, and determines the fourth indication information.

Specifically, the network device determines at least one polarization manner supported by all the terminal devices in the first beam, and determines one polarization manner from the at least one polarization manner as the second polarization manner.

In Manner 13, before determining the fourth indication information, the network device further obtains the polarization manners supported by all the terminal devices in the first beam. The network device sequentially obtains a polarization manner supported by each terminal device in the first beam, and then obtains the polarization manners supported by all the terminal devices in the first beam. For obtaining, by the network device, a polarization manner supported by one terminal device in the first beam, refer to step 1.1 and step 1.2. Details are not described herein again.

Manner 14: The network device determines the fourth indication information based on CSI of channels in different polarization manners measured by all terminal devices in the first beam.

Optionally, the network device determines at least one available polarization manner based on the CSI of channels in the different polarization manners measured by all the terminal devices in the first beam; and then determine, from the at least one available polarization manner, one available polarization manner as the second polarization manner, and generate the fourth indication information.

In at least one embodiment, in response to a twentieth condition being met, the network device determines a polarization manner C as the available polarization manner. The twentieth condition includes: In a set of the different polarization manners measured by all the terminal devices in the first beam, channel quality corresponding to a polarization manner (denoted as the polarization manner C) with optimal channel quality is better than a fifth threshold.

In this way, the network device determines, from the set of the different polarization manners measured by all the terminal devices in the first beam, a polarization manner with best CSI of a channel as the polarization manner of the first beam, thereby improving beam quality.

In Manner 14, before determining the fourth indication information, the network device further obtains the CSI of the channels in the different polarization manners measured by all the terminal devices in the first beam. The network device sequentially obtains CSI of a channel in a different polarization manner measured by each terminal device in the first beam, and then obtain the CSI of the channels in the different polarization manners measured by all the terminal devices in the first beam. For obtaining, by the network device, CSI of a channel in a different polarization manner measured by one terminal device in the first beam, refer to step 2.1 to step 2.3. Details are not described herein again.

Manner 15: The network device determines the fourth indication information based on service usages of all terminal devices in the first beam.

Optionally, the network device determines at least one available polarization manner based on the service usages of all the terminal device in the first beam; and then determine, from the at least one available polarization manner, one available polarization manner as the second polarization manner, and generate the fourth indication information.

In at least one embodiment, in response to a twenty-first condition being met, the network device determines cross polarization multiplexing as the available polarization manner. The twenty-first condition includes: Throughputs of terminal devices whose proportion exceeds (or ≥) a second proportion in all the terminal devices in the first beam are greater than (or ≥) a throughput threshold. In this way, in response to the service usage in the first beam being large, the network device enables cross polarization multiplexing for the terminal device in the first beam, thereby improving a throughput of the terminal device in the first beam.

In at least one embodiment, in response to a twenty-second condition being met, the network device determines a single polarization manner as the available polarization manner. The twenty-second condition includes: Throughputs of terminal devices whose proportion exceeds (or ≥) a third proportion in all the terminal devices in the first beam are less than (or ≤) a throughput threshold. In this way, in response to the service usage in the first beam being small, the network device disables cross polarization multiplexing for the terminal device in the first beam, thereby reducing power consumption of the terminal device in the first beam.

In Manner 15, before determining the fourth indication information, the network device further obtains the service usages of all the terminal devices in the first beam. The network device sequentially obtains a service usage of each terminal device in the first beam, and then obtains the service usages of all the terminal devices in the first beam.

Manner 16: The network device determines the fourth indication information based on polarization manners expected by all terminal devices in the first beam.

Optionally, the network device determines at least one available polarization manner based on the polarization manners expected by all the terminal devices in the first beam; and then determine, from the at least one available polarization manner, one available polarization manner as the second polarization manner, and generate the fourth indication information.

That the network device determines the at least one available polarization manner based on the polarization manners expected by all the terminal devices in the first beam is implemented in the following manner.

Manner 16.1: In response to a twenty-third condition being met, the network device determines a polarization manner D as the available polarization manner. The twenty-third condition includes: Terminal devices whose proportion exceeds (or ≥) a fourth proportion in all the terminal devices in the first beam expect a same polarization manner (denoted as the polarization manner D).

In this way, the network device uses, in a set of the polarization manners expected by all the terminal devices in the first beam, the polarization manner expected by most terminal devices as the polarization manner of the first beam, thereby improving beam quality.

In Manner 16, before determining the fourth indication information, the network device further obtains the polarization manners expected by all the terminal devices in the first beam. The network device sequentially obtains a polarization manner expected by each terminal device in the first beam, and then obtains the polarization manners expected by all the terminal devices in the first beam.

Manner 17: The network device determines the fourth indication information based on a weather condition in a coverage area of the first beam.

Optionally, the network device determines at least one available polarization manner based on the weather condition in the coverage area of the first beam; and then determine, from the at least one available polarization manner, one available polarization manner as the second polarization manner, and generate the fourth indication information.

That the network device determines the at least one available polarization manner based on the weather condition in the coverage area of the first beam is implemented in the following manner.

Manner 17.1: In response to a twenty-fourth condition being met, the network device determines a single polarization manner as the available polarization manner. The twenty-fourth condition includes: An average rainfall (snow) amount in the coverage area of the first beam is greater than (or ≥) a rainfall (snow) threshold, and/or an average cloud layer thickness is greater than (or ≥) a thickness threshold.

In this way, the network device adjusts the polarization manner of the first beam to the single polarization manner in response to the weather condition in the coverage area of the first beam being poor, thereby reducing signal interference and improving communication quality.

In Manner 17, before the network device determines the fourth indication information, Manner 17 further includes: The network device obtains the weather condition in the coverage area of the first beam. The network device directly obtains directly obtain meteorological information of a specific spatial scale in the beam coverage area.

Manner 18: The network device determines the fourth indication information based on crosstalk statuses between orthogonally polarized channels of all terminal devices in the first beam.

Optionally, the network device determines at least one available polarization manner based on the crosstalk statuses between all the orthogonally polarized channels in the first beam; and then determine, by using one or more of the foregoing Manner 13 to Manner 17, one available polarization manner from the at least one available polarization manner as the second polarization manner, and generate the fourth indication information.

In at least one embodiment, in response to a twenty-fifth being met, the network device determines a single polarization manner as the available polarization manner, and determines cross polarization multiplexing as an unavailable polarization manner. The twenty-fifth condition includes: A crosstalk value between orthogonally polarized channels of terminal devices whose proportion exceeds (or ≥) a sixth proportion in all the terminal devices in the first beam is greater than (or ≥) a first crosstalk threshold. In this way, the network device limits the polarization manner of the first beam to the single polarization manner in response to crosstalk between orthogonally polarized channels between most terminal devices and the network device in the first beam being severe, thereby reducing signal interference and improving communication quality.

In at least one embodiment, in response to a twenty-sixth condition being met, the network device determines cross polarization multiplexing as the available polarization manner. The twenty-sixth condition includes: A crosstalk value between orthogonally polarized channels of terminal devices whose proportion exceeds (or ≥) a seventh proportion in all the terminal devices in the first beam is less than (or ≤) a first crosstalk threshold. In this way, the network device adjusts the polarization manner of the first beam to cross polarization multiplexing in response to crosstalk between orthogonally polarized channels between most terminal devices and the network device in the first beam not being severe, thereby improving a throughput.

In Manner 18, before determining the fourth indication information, the network device further obtains the crosstalk statuses between the orthogonally polarized channels between all the terminal devices and the network device in the first beam. The network device sequentially obtains a crosstalk status between orthogonally polarized channels between each terminal device and the network device in the first beam, and then obtain the crosstalk statuses between the orthogonally polarized channels between all the terminal devices and the network device in the first beam.

Manner 18 is implemented in combination with one or more of the foregoing Manners 13 to 17. For a related combination manner, refer to the following examples including Manner 18 in Example 14 to Example 26.

In at least one embodiment, in response to a trigger condition being met, the network device determines the fourth indication information based on the trigger condition. The trigger condition includes any one of the twentieth condition to the twenty-sixth condition in Manner 14 to Manner 18, and the trigger condition triggers the network device to schedule the polarization manner of the first beam. In other words, in response to any one of the twentieth condition to the twenty-sixth condition being met, the network device determines the fourth indication information based on a process corresponding to the condition that is met, so as to schedule the polarization manner of the first beam.

In this way, the network device discovers a problem in the polarization manner of the first beam in time, and adjust the polarization manner of the first beam in time, so that scheduling of the polarization manner of the first beam is more flexible, and a scheduling granularity is finer, thereby improving spectral efficiency.

The foregoing Manner 13 to Manner 18 are separately implemented, or are implemented in combination. This is not limited in at least one embodiment. A combination implementation of Manner 13 to Manner 15, Manner 17, and Manner 18 is described below by using several examples.

Example 3: In response to Manner 13, Manner 14, Manner 15, Manner 17, and Manner 18 being combined for implementation, the network device determines, as the second polarization manner based on the CSI of the channels in the different polarization manners measured by all the terminal devices in the first beam, the service usages of all the terminal devices in the first beam, the weather conditions between all the terminal devices and the network device in the first beam, and the crosstalk statuses between the orthogonally polarized channels of all the terminal devices in the first beam, one polarization manner from the polarization manners supported by all the terminal devices in the first beam, and determine the fourth indication information.

That the network device determines, as the second polarization manner based on the CSI of the channels in the different polarization manners measured by all the terminal devices in the first beam, the service usages of all the terminal devices in the first beam, the weather conditions between all the terminal devices and the network device in the first beam, and the crosstalk statuses between the orthogonally polarized channels of all the terminal devices in the first beam, one polarization manner from the polarization manners supported by all the terminal devices in the first beam includes: The network device determines at least one available polarization manner (denoted as a first set) based on the CSI of the channels in the different polarization manners measured by all the terminal devices in the first beam; the network device determines at least one available polarization manner (denoted as a second set) based on the service usages of all the terminal devices in the first beam; the network device determines at least one available polarization manner (denoted as a third set) based on the weather conditions between all the terminal devices and the network device in the first beam; the network device determines at least one available polarization manner (denoted as a fourth set) based on the crosstalk statuses between the orthogonally polarized channels of all the terminal devices in the first beam; and the network device uses, in polarization manners included in the first set to the fifth set, one of the polarization manners supported by all the terminal devices in the first beam as the second polarization manner.

The network device determines the at least one available polarization manner based on different information (including any one of the CSI of the channels in the different polarization manners measured by all the terminal devices in the first beam, the service usages of all the terminal devices in the first beam, the weather conditions between all the terminal devices and the network device in the first beam, and the crosstalk statuses between the orthogonally polarized channels of all the terminal devices in the first beam). For details, refer to the process of determining the at least one available polarization manner by the network device in the foregoing Manner 14 to Manner 18. Details are not described herein again.

In other words, in response to the foregoing plurality of manners being implemented in combination, the network device separately determines a plurality of polarization manner sets based on the different information, and use, as the second polarization manner, one of the polarization manners supported by all the terminal devices in the first beam, in the polarization manners included in the plurality of polarization manner sets.

Example 4: In response to Manner 13 and Manner 14 being combined for implementation, the network device determines, based on the CSI of the channels in the different polarization manners measured by all the terminal devices in the first beam, a polarization manner from the polarization manners supported by all the terminal devices in the first beam, as the second polarization manner, and determine the fourth indication information.

In response to Manner 1 to Manner 3, Manner 5, and Manner 6 being combined for implementation, a plurality of manners is randomly selected for combination implementation. For a specific implementation process, refer to the foregoing examples. Examples are not provided herein one by one.

With reference to the foregoing descriptions of Manner 13 to Manner 18, the network device determines the fourth indication information based on one or more of the polarization manners supported by all the terminal devices in the first beam, the channel state information of the channels in the different polarization manners measured by all the terminal devices in the first beam, the service usages of all the terminal devices in the first beam, the polarization manners expected by all the terminal devices in the first beam, the weather conditions between all the terminal devices and the network device in the first beam, and the crosstalk statuses between all the orthogonally polarized channels in the first beam. In other words, the fourth indication information is determined based on one or more of the following: the polarization manners supported by all the terminal devices in the first beam, the channel state information of the channels in the different polarization manners measured by all the terminal devices in the first beam, the service usages of all the terminal devices in the first beam, the polarization manners expected by all the terminal devices in the first beam, the weather conditions between all the terminal devices and the network device in the first beam, or the crosstalk statuses between all the orthogonally polarized channels in the first beam.

In Manner 13 to Manner 18, the network device determines, with reference to a plurality of types of information, a polarization manner that is more appropriate for all the terminal devices in the first beam, and schedule the polarization manner for all the terminal devices in the first beam by using the fourth indication information. This enables, in one aspect, all the terminal devices in the first beam to work in a better polarization manner, improve communication quality, and reduce power consumption, in another aspect, scheduling of the polarization manner for all the terminal devices in the first beam is more flexible, and a scheduling granularity is finer, thereby improving spectral efficiency.

Optionally, the fourth indication information further indicates duration of the second polarization manner.

The duration of the second polarization manner is understood as a time length in which the polarization manner of the first beam lasts for the second polarization manner. The duration of the second polarization manner is also referred to as a timer of the second polarization manner. In response to the timer expiring, the first beam is restored to a default polarization manner.

In this way, the network device indicates the duration in which all the terminal devices in the first beam work in the second polarization manner. After the duration indicated by the fourth indication information expires, all the terminal devices in the first beam are restored to the previous polarization manner. Therefore, the network device no longer indicates, by using one piece of indication signaling, the terminal device in the first beam to restore to the previous polarization manner, thereby reducing signaling overheads. This further improves flexibility of scheduling the polarization manner of the terminal device.

For an implementation in which the fourth indication information indicates the duration of the second polarization manner, refer to the description of the “implementation in which the first indication information indicates the duration of the first polarization manner” in the method embodiment shown in FIG. 6, for example, Manner 7 and Manner 8. Details are not described herein again.

Optionally, the network device broadcasts timer configuration information. The timer configuration information includes a correspondence between at least one timer index and at least one timer, and the timer indicates the duration of the second polarization manner. For example, the network device sends the timer configuration information to all the terminal devices in a cell by using an SIB.

For an implementation of the timer configuration information, refer to the description of the “implementation of the timer configuration information” in the method embodiment shown in FIG. 6. Details are not described herein again.

Optionally, the fourth indication information includes an SSB index, and the SSB index corresponds to the second polarization manner.

SSB indexes configured by the network device in the first beam are consistent. In this way, in response to receiving the fourth indication information, each terminal device in the first beam determines, based on the correspondence between the SSB index and the second polarization manner, that the fourth indication information indicates that the polarization manner of the first beam is the second polarization manner, so that the network device switches the polarization manner of the first beam to the second polarization manner, that is, the polarization manner of the terminal device in the first beam is switched to the second polarization manner, and a polarization manner of a terminal device in a beam is scheduled at a beam level.

Specifically, the network device configures in advance a correspondence between at least one SSB index and at least one polarization manner for all the terminal devices in the cell. For example, the network device configures in advance the correspondence between the at least one SSB index and the at least one polarization manner for all the terminal devices in the cell as follows: An even-numbered SSB index indicates that the second polarization manner is left hand circular polarization, and an odd-numbered SSB index indicates that the second polarization manner is right hand circular polarization. Then, the network device configures the SSB index corresponding to the first beam to 1, and send the fourth indication information to the terminal device in the first beam, where the SSB index included in the fourth indication information is an SSB 1, to indicate that the polarization manner of the terminal device in the first beam is switched to right hand circular polarization.

Optionally, the fourth indication information is carried in any one of RRC, DCI, or a MAC CE. This is not limited herein.

Optionally, the fourth indication information includes a BWP index, and the BWP index corresponds to the second polarization manner.

For an implementation in which the BWP index corresponds to the second polarization manner, refer to the foregoing implementation in which the SSB index corresponds to the second polarization manner. Details are not described herein again.

Optionally, the fourth indication information includes a CSI-RS time-frequency location, and the CSI-RS time-frequency location corresponds to the second polarization manner.

For an implementation in which the CSI-RS time-frequency location corresponds to the second polarization manner, refer to the foregoing implementation in which the SSB index corresponds to the second polarization manner. Details are not described herein again.

Optionally, the fourth indication information includes a CSI-RS measurement identifier (measurement identifier), and the CSI-RS measurement identifier corresponds to the second polarization manner. The measurement identifier is also referred to as an identifier (identifier) for short. This is not limited herein.

For an implementation in which the CSI-RS measurement identifier corresponds to the second polarization manner, refer to the foregoing implementation in which the SSB index corresponds to the second polarization manner. Details are not described herein again.

Optionally, the communication method shown in FIG. 10 further includes: The network device sends a first mapping relationship to the terminal device. The first mapping relationship includes a mapping relationship between at least one SSB index and at least one polarization manner, or the first mapping relationship includes a mapping relationship between at least one CSI-RS time-frequency location and at least one polarization manner.

In actual application, the correspondence between the SSB index and the second polarization manner is adjusted based on a usage. For example, an SSB 3 indicates the second polarization manner at a first moment, and an SSB 4 indicates the second polarization manner after a period of time. This is not limited in at least one embodiment.

The first mapping relationship is carried in SIB signaling.

In the communication method shown in FIG. 10, the fourth indication information is used to schedule the polarization manner of the terminal device and is carried in the beam-level information, such as a reference signal. In this way, the network device schedules the polarization manner of the terminal device at the beam level, that is, the network device adjusts a polarization manner of a terminal device in a beam, so that scheduling of the polarization manner of the terminal device is more flexible, and a scheduling granularity is finer, thereby improving spectral efficiency.

At least one embodiment provides still another embodiment, to schedule the polarization manner of the terminal device at the cell level.

FIG. 11 is a schematic flowchart 11 of a communication method according to at least one embodiment. The communication method is applied to the foregoing communication system, and is performed by the terminal device or the network device in the foregoing communication system. According to the communication method, the polarization manner of the terminal device is scheduled at the cell level, that is, the network device adjusts the polarization manner of the terminal device in the cell. The method includes S1101 to S1103, which are sequentially provided below.

S1101: The network device determines fifth indication information.

The fifth indication information indicates a third polarization manner of a first cell. In other words, the fifth indication information indicates that a polarization manner of a first cell is switched to a third polarization manner; or the fifth indication information indicates that a first cell works in a third polarization manner; or the fifth indication information indicates that a polarization manner of a first cell is a third polarization manner. Unless otherwise specified, meanings to be expressed in the several manners of expressing the fifth indication information are consistent, and is mixed. The first cell herein is a cell of the network device.

The third polarization manner includes any one of left hand circular polarization, right hand circular polarization, linear polarization, or cross polarization multiplexing. Linear polarization includes any one of horizontal polarization, vertical polarization, +45° polarization, and −45° polarization. Cross polarization multiplexing includes any one of horizontal and vertical cross polarization multiplexing, ±45° cross polarization multiplexing, and left hand circular polarization and right hand circular polarization cross polarization multiplexing.

S1102: The network device sends the fifth indication information to the terminal device in the first cell. Correspondingly, the terminal device in the first cell receives the fifth indication information from the network device.

S1103: The terminal device in the first cell communicates with the network device in the third polarization manner.

That the terminal device in the first cell communicates with the network device in the third polarization manner is understood as that the terminal device in the first cell works in the third polarization manner, or is understood as that the terminal device in the first cell switches a polarization manner to the third polarization manner.

For example, in response to the third polarization manner indicated by the fifth indication information being left hand circular polarization, the terminal device in the first cell works in the left hand circular polarization manner, to implement communication with the network device. In response to the third polarization manner indicated by the fifth indication information being left hand circular polarization and right hand circular polarization cross polarization multiplexing, the terminal device in the first cell works in the left hand circular polarization and right hand circular polarization cross polarization multiplexing polarization manner, to implement communication with the network device.

In S1101, that the network device determines the fifth indication information is implemented in the following Manner 19 to Manner 24.

Manner 19: The network device determines the fifth indication information based on polarization manners supported by all terminal devices in the first cell.

Manner 20: The network device determines the fifth indication information based on CSI of channels in different polarization manners measured by all terminal devices in the first cell.

In Manner 20, the network device determines, from a set of the different polarization manners measured by all the terminal devices in the first cell, a polarization manner with best CSI of a channel as the polarization manner of the first cell, thereby improving cell communication quality.

Manner 21: The network device determines the fifth indication information based on service usages of all terminal devices in the first cell.

In Manner 21, in response to the service usage in the first cell being large, the network device enables cross polarization multiplexing for the terminal device in the first cell, thereby improving a throughput of the terminal device in the first cell. In addition, in response to the service usage in the first cell being small, the network device disables cross polarization multiplexing for the terminal device in the first cell, thereby reducing power consumption of the terminal device in the first cell.

Manner 22: The network device determines the fifth indication information based on polarization manners expected by all terminal devices in the first cell.

In Manner 22, the network device uses, in a set of the polarization manners expected by all the terminal devices in the first cell, a polarization manner expected by most terminal devices as the polarization manner of the first cell, thereby improving cell communication quality.

Manner 23: The network device determines the fifth indication information based on weather conditions between all terminal devices and the network device in the first cell.

In Manner 23, the network device adjusts the polarization manner of the first cell to a single polarization manner in response to weather conditions between most terminal devices and the network device in the first cell being poor, thereby reducing signal interference and improving communication quality.

Manner 24: The network device determines the fifth indication information based on crosstalk statuses between orthogonally polarized channels of all terminal devices in the first cell.

In Manner 24, the network device limits the polarization manner of the first cell to the single polarization manner in response to crosstalk between orthogonally polarized channels between most terminal devices and the network device in the first cell being severe, thereby reducing signal interference and improving communication quality. In addition, the network device adjusts the polarization manner of the first cell to cross polarization multiplexing in response to crosstalk between orthogonally polarized channels between most terminal devices and the network device in the first cell not being severe, thereby improving a throughput. For a specific implementation of determining the fifth indication information in Manner 19 to Manner 24, refer to that of determining the fourth indication information in the foregoing Manner 13 to Manner 18. A difference lies in that the fourth indication information is determined based on a related parameter in a beam range, and the fifth indication information is determined based on a related parameter in a cell range. Details are not described herein. For example, for an implementation process of Manner 20, refer to the foregoing Manner 14. The “first beam” in Manner 14 is replaced with the “first cell”, the “second polarization manner” is replaced with the “third polarization manner”, and the “fourth indication information” is replaced with the “fifth indication information”.

In at least one embodiment, in response to a trigger condition being met, the network device determines the fifth indication information based on the trigger condition. The trigger condition includes any one in the foregoing Manner 20 to Manner 24, and the trigger condition triggers the network device to schedule the polarization manner of the first cell. In other words, in response to any condition in Manner 20 to Manner 24 being met, the network device determines the fifth indication information based on a process corresponding to the condition that is met, so as to schedule the polarization manner of the first cell.

The foregoing Manner 19 to Manner 24 are separately implemented, or are implemented in combination. This is not limited in at least one embodiment. Similarly, for a specific example, refer to the foregoing Examples 3 and 4. Details are not described herein again.

With reference to the foregoing descriptions of Manner 19 to Manner 24, the network device determines the fifth indication information based on one or more of the polarization manners supported by all the terminal devices in the first cell, the channel state information of the channels in the different polarization manners measured by all the terminal devices in the first cell, the service usages of all the terminal devices in the first cell, the polarization manners expected by all the terminal devices in the first cell, the weather conditions between all the terminal devices and the network device in the first cell, and the crosstalk statuses between all the orthogonally polarized channels in the first cell. In other words, the fifth indication information is determined based on one or more of the following: the polarization manners supported by all the terminal devices in the first cell, the channel state information of the channels in the different polarization manners measured by all the terminal devices in the first cell, the service usages of all the terminal devices in the first cell, the polarization manners expected by all the terminal devices in the first cell, the weather conditions between all the terminal devices and the network device in the first cell, or the crosstalk statuses between all the orthogonally polarized channels in the first cell.

In Manner 19 to Manner 24, the network device determines, with reference to a plurality of types of information, a polarization manner that is more appropriate for all the terminal devices in the first cell, and schedule the polarization manner for all the terminal devices in the first cell by using the fifth indication information. This enables, in one aspect, all the terminal devices in the first cell to work in a better polarization manner, thereby improving communication quality, reducing power consumption, and improving spectral efficiency.

Optionally, the fifth indication information further indicates duration of the third polarization manner.

The duration of the third polarization manner is understood as a time length in which the polarization manner of the first cell lasts for the third polarization manner. The duration of the third polarization manner is also referred to as a timer of the third polarization manner. In response to the timer expiring, the first cell is restored to a default polarization manner.

In this way, the network device indicates the duration in which all the terminal devices in the first cell work in the third polarization manner. After the duration indicated by the fifth indication information expires, all the terminal devices in the first cell are restored to a previous polarization manner. Therefore, the network device no longer indicates, by using one piece of indication signaling, the terminal device in the first cell to restore to the previous polarization manner, thereby reducing signaling overheads. This further improves flexibility of scheduling the polarization manner of the terminal device.

For an implementation in which the fifth indication information indicates the duration of the third polarization manner, refer to the description of the “implementation in which the first indication information indicates the duration of the first polarization manner” in the method embodiment shown in FIG. 6, for example, Manner 7 and Manner 8. Details are not described herein again.

Optionally, the network device broadcasts timer configuration information. The timer configuration information includes a correspondence between at least one timer index and at least one timer, and the timer indicates the duration of the third polarization manner. For example, the network device sends the timer configuration information to all the terminal devices in the cell by using an SIB.

For an implementation of the timer configuration information, refer to the description of the “implementation of the timer configuration information” in the method embodiment shown in FIG. 6. Details are not described herein again.

In at least one embodiment, the fifth indication information is carried in cell-level information.

The cell-level information is understood as information sent by the network device to a terminal device in a cell. Except the terminal device in the cell, another terminal device cannot successfully decode the terminal-level information. The fifth indication information is carried in the cell-level information, and indicates that a device scheduled by using the fifth indication information is the terminal device in the cell.

Optionally, the cell-level information is an SIB. In other words, the fifth indication information is carried in an SIB.

Optionally, one or more bits in the SIB are used to carry the fifth indication information. Values of the one or more bits in the SIB are used to indicate the third polarization manner. The following separately describes at least one embodiment.

Example 5: Four bits in the SIB are used to carry the fifth indication information. The four bits indicate the third polarization manner in an indication manner shown in Table 15.

TABLE 15

| | Uplink/ | | |
|---|---|---|---|
| | Downlink | Value | Indication |
| SIBx field, | Downlink | 00 | A third downlink polarization |
| where x is | | | manner is left hand circular |
| any value | | | polarization. |
| from | | 01 | The third downlink polarization |
| 0 to 14 | | | manner is right hand circular |
| | | | polarization. |
| | | 10 | The third downlink polarization |
| | | | manner is left hand circular |
| | | | polarization and right hand |
| | | | circular polarization cross |
| | | | polarization multiplexing. |
| | | 11 | Reserved |
| | Uplink | 00 | The third uplink polarization |
| | | | manner is left hand circular |
| | | | polarization. |
| | | 01 | The third uplink polarization |
| | | | manner is right hand circular |
| | | | polarization. |
| | | 10 | The third uplink polarization |
| | | | manner is left hand circular |
| | | | polarization and right hand |
| | | | circular polarization cross |
| | | | polarization multiplexing. |
| | | 11 | Reserved |

A format of an SIBx message (message) in Example 5 is shown as follows:

```
  SIBx message
  -- ASN1START (-- ASN1START)
  -- TAG-MEAS-CONFIG-START (-- TAG-MEAS-CONFIG-START)
  SIBx (SIBx):: = Sequence (sequence) {
  Downlink Polarization (DL Polarization) manner ENUMERATED
(ENUMERATED) {left hand circular polarization (LHCP), right hand circular polarization (RHCP),
and left hand circular polarization and right hand circular polarization cross polarization multiplexing
(LHCP&RHCP Multiplexing)} ,
  Uplink Polarization (UL Polarization) manner ENUMERATED (ENUMERATED)
{left hand circular polarization (LHCP), right hand circular polarization (RHCP), and left hand
circular polarization and right hand circular polarization cross polarization multiplexing
(LHCP&RHCP Multiplexing)}
  ...
  }
  -- TAG-MEAS-CONFIG-STOP (-- TAG-MEAS-CONFIG-STOP)
  -- ASN1STOP (-- ASN1STOP)
```

Example 6: Three bits in the SIB are used to carry the fifth indication information. The three bits indicate the third polarization manner in an indication manner shown in Table 16. In Table 16, x1 and x2 in an SIBx1 and an SIBx2 are different. In response to the SIB not including an SIBx2 field, an uplink polarization manner is implicitly indicated to be the same as a downlink polarization manner.

TABLE 16

| | Uplink/ | | |
|---|---|---|---|
| | Downlink | Value | Indication |
| SIBx1 field, | Downlink | 00 | A third downlink polarization |
| where x1 is | | | manner is left hand circular |
| any value | | | polarization. |
| from | | 01 | The third downlink polarization |
| 0 to 14 | | | manner is right hand circular |
| | | | polarization. |
| | | 10 | The third downlink polarization |
| | | | manner is left hand circular |
| | | | polarization and right hand |
| | | | circular polarization cross |
| | | | polarization multiplexing. |
| | | 11 | Reserved |
| SIBx2 field, | Uplink | 0 | Cross opposite to a current |
| where x2 is | | | downlink polarization direction |
| any value | | | of the terminal device. |
| from | | 1 | The third uplink polarization |
| 0 to 14 | | | manner is left hand circular |
| | | | polarization and right hand |
| | | | circular polarization cross |
| | | | polarization multiplexing. |

A format of an SIBx message in Example 6 is shown as follows:

```
  SIBx message
  -- ASN1START (-- ASN1START)
  -- TAG-MEAS-CONFIG-START (-- TAG-MEAS-CONFIG-START)
  SIBx (SIBx) ::= Sequence (Sequence) {
  Downlink Polarization (DL Polarization) manner ENUMERATED
(ENUMERATED) {left hand circular polarization (LHCP), right hand circular polarization (RHCP),
and left hand circular polarization and right hand circular polarization cross polarization multiplexing
(LHCP&RHCP Multiplexing)},
  Uplink polarization (UL Polarization) manner ENUMERATED (ENUMERATED)
{cross (cross) opposite to the downlink polarization direction, and left hand circular polarization and
right hand circular polarization cross polarization multiplexing (LHCP&RHCP Multiplexing)}
  ...
  }
  -- TAG-MEAS-CONFIG-STOP (-- TAG-MEAS-CONFIG-STOP)
  -- ASN1STOP (-- ASN1STOP)
```

Example 7: Four bits in the SIB are used to carry the fifth indication information. The four bits indicate the third polarization manner in an indication manner shown in Table 17.

TABLE 17

| | Value | |
|---|---|---|
| | (4 bits) | Indication |
| SIBx field, | 0000 | A third polarization manner includes downlink |
| where x | | left hand circular polarization, and uplink left |
| is any value | | hand circular polarization. |
| from | 0001 | The third polarization manner includes |
| 0 to 14 | | downlink left hand circular polarization, and |
| | | uplink right hand circular polarization. |
| | 0010 | The third polarization manner includes |
| | | downlink left hand circular polarization, and |
| | | uplink left hand circular polarization and right |
| | | hand circular polarization cross polarization |
| | | multiplexing. |
| | 0011 | The third polarization manner includes |
| | | downlink right hand circular polarization, |
| | | and uplink left hand circular polarization. |
| | 0100 | The third polarization manner includes |
| | | downlink right hand circular polarization, |
| | | and uplink right hand circular polarization. |
| | 0101 | The third polarization manner includes |
| | | downlink right hand circular polarization, |
| | | and uplink left hand circular polarization |
| | | and right hand circular polarization cross |
| | | polarization multiplexing. |
| | 0110 | The third polarization manner includes |
| | | downlink left hand circular polarization |
| | | and right hand circular polarization cross |
| | | polarization multiplexing, and uplink left |
| | | hand circular polarization. |
| | 0111 | The third polarization manner includes |
| | | downlink left hand circular polarization |
| | | and right hand circular polarization cross |
| | | polarization multiplexing, and uplink right |
| | | hand circular polarization. |
| | 1000 | The third polarization manner includes |
| | | downlink left hand circular polarization |
| | | and right hand circular polarization cross |
| | | polarization multiplexing, and uplink left |
| | | hand circular polarization and right hand |
| | | circular polarization cross polarization |
| | | multiplexing. |

A format of an SIBx message in Example 7 is shown as follows:

```
  SIBx message
  -- ASN1START (-- ASN1START)
  -- TAG-MEAS-CONFIG-START (-- TAG-MEAS-CONFIG-START)
  SIBx (SIBx) ::= Sequence (Sequence) {
  Polarization (DL Polarization) manner ENUMERATED (ENUMERATED)
{downlink left hand circular polarization (LHCP), uplink left hand circular polarization (LHCP),
downlink left hand circular polarization (LHCP), uplink right hand circular polarization (RHCP),
downlink left hand circular polarization (LHCP), uplink left hand circular polarization and right hand
circular polarization cross polarization multiplexing (LHCP&RHCP Multiplexing), downlink right
hand circular polarization (LHCP), uplink left hand circular polarization (LHCP), downlink right
hand circular polarization (LHCP), uplink right hand circular polarization (RHCP), downlink right
hand circular polarization (LHCP), uplink left hand circular polarization and right hand circular
polarization cross polarization multiplexing (LHCP&RHCP Multiplexing), downlink left hand
circular polarization and right hand circular polarization cross polarization multiplexing
(LHCP&RHCP Multiplexing), uplink left hand circular polarization (LHCP), downlink left hand
circular polarization and right hand circular polarization cross polarization multiplexing
(LHCP&RHCP Multiplexing), uplink right hand circular polarization (RHCP), downlink left hand
circular polarization and right hand circular polarization cross polarization multiplexing
(LHCP&RHCP Multiplexing), and uplink left hand circular polarization and right hand circular
polarization cross polarization multiplexing (LHCP&RHCP Multiplexing) },
  ...
  }
  -- TAG-MEAS-CONFIG-STOP (-- TAG-MEAS-CONFIG-STOP)
  -- ASN1STOP (-- ASN1STOP)
```

Optionally, the four bits in Table 22 further indicate more polarization manners, as shown in Table 18 below.

TABLE 18

| | Value | |
|---|---|---|
| | (4 bits) | Indication |
| SIBx field, | 1000 | A third polarization manner includes downlink |
| where x is | | left hand circular polarization, and uplink left |
| any value | | hand circular polarization. |
| from | 1001 | The third polarization manner includes downlink |
| 0 to 14 | | left hand circular polarization, and uplink right |
| | | hand circular polarization. |
| | 1010 | The third polarization manner includes downlink |
| | | left hand circular polarization, and uplink left |
| | | hand circular polarization and right hand |
| | | circular polarization cross polarization |
| | | multiplexing. |
| | 1011 | The third polarization manner includes downlink |
| | | right hand circular polarization, and uplink left |
| | | hand circular polarization. |
| | 1100 | The third polarization manner includes downlink |
| | | right hand circular polarization, and uplink right |
| | | hand circular polarization. |
| | 1101 | The third polarization manner includes downlink |
| | | right hand circular polarization, and uplink left |
| | | hand circular polarization and right hand |
| | | circular polarization cross polarization |
| | | multiplexing. |
| | 1110 | The third polarization manner includes downlink |
| | | left hand circular polarization and right hand |
| | | circular polarization cross polarization |
| | | multiplexing, and uplink left hand circular |
| | | polarization. |
| | 1111 | The third polarization manner includes downlink |
| | | left hand circular polarization and right hand |
| | | circular polarization cross polarization |
| | | multiplexing, and uplink right hand circular |
| | | polarization. |

In the communication method shown in FIG. 11, the fifth indication information is used to schedule the polarization manner of the terminal device and is carried in the cell-level information, such as the SIB. In this way, the network device schedules the polarization manner of the terminal device at the cell level, that is, the network device adjusts a polarization manner of a terminal device in a cell, so that scheduling of the polarization manner of the terminal device is more flexible.

The communication methods shown in FIG. 6, FIG. 10, and FIG. 11 are separately implemented, or are implemented in combination. This is not limited herein.

At least one embodiment implements a network device that sends a polarization manner of a neighboring cell to the terminal device, thereby accelerating neighboring cell handover of the terminal device.

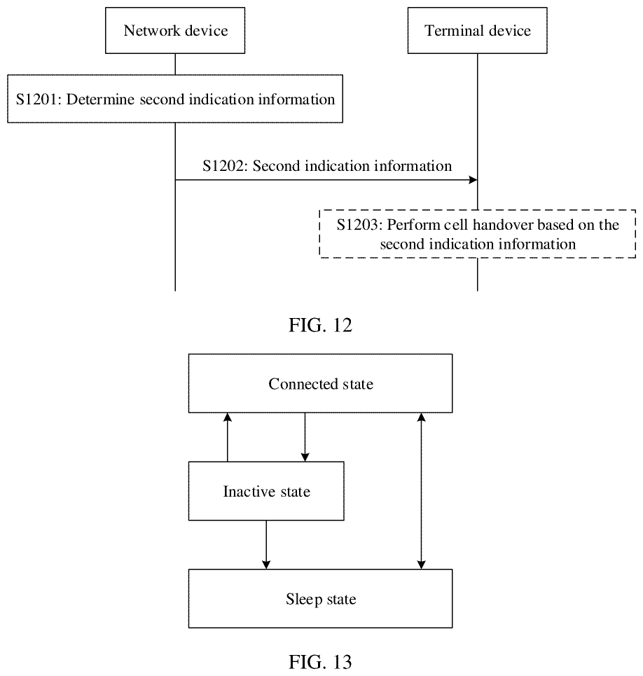

In at least one embodiment, to accelerate cell handover, a communication method. FIG. 12 is a schematic flowchart 4 of the communication method according to at least one embodiment. The method includes S1201 to S1203, which are sequentially described below.

S1201: The network device determines second indication information.

The second indication information indicates the polarization manner of the neighboring cell of a cell in which the terminal device is located. In other words, the second indication information indicates the polarization manner for signal measurement of the neighboring cell of the cell in which the terminal device is located.

The polarization manner of the neighboring cell includes one or more of left hand circular polarization, right hand circular polarization, linear polarization, or cross polarization multiplexing. The cell in which the terminal device is located directly obtains have one or more neighboring cells. In response to the cell in which the terminal device being located has one neighboring cell, the polarization manner of the neighboring cell includes any one of left hand circular polarization, right hand circular polarization, linear polarization, or cross polarization multiplexing. In response to the cell in which the terminal device being located has a plurality of neighboring cells, the polarization manners of the neighboring cells include one or more of left hand circular polarization, right hand circular polarization, linear polarization, or cross polarization multiplexing.

The second indication information is also referred to as indication information of the polarization manner of the neighboring cell. This is not limited herein.

Optionally, a manner in which the network device determines the second indication information includes: The network device determines the cell in which the terminal device is located; and obtains a polarization manner of at least one neighboring cell around the cell in which the terminal device is located, and generates the second indication information. In other words, the second indication information indicates a polarization manner of at least one neighboring cell around the cell in which the terminal device is located.

Optionally, the second indication information is carried in terminal-level information or cell-level information. The terminal-level information includes DCI, a MAC CE, RRC, or the like, and the cell-level information includes an SIB.

Optionally, the second indication information further indicates a polarization manner of a neighboring cell of a cell in which the terminal device in a first status is located, the first status includes a connected state or an inactive state, and the second indication information is carried in the terminal-level information.

For example, the second indication information is carried in UE-specific RRC. FIG. 13 is a schematic diagram of RRC status switching according to at least one embodiment. Refer to FIG. 13. The terminal device is in the following several states: the connected state, the inactive state, and an idle state. The connected state is denoted as RRC_connected, the inactive state is denoted as RRC_inactive, and the idle state is denoted as RRC_idle. The terminal device switches between different states.

For the terminal device in the connected state, the second indication information is carried in RRC reconfiguration (RRCReconfiguration). The network device sends RRCReconfiguration to the terminal device, where RRCReconfiguration indicates a polarization manner of the neighboring cell of the cell in which the terminal device in the connected state is located, that is, indicates the polarization manner used in response to the terminal device measuring signal quality of the neighboring cell during cell handover.

For the terminal device in the inactive state, the second indication information is carried in RRC resume (RRCResume). The network device sends RRCResume to the terminal device, where RRCResume indicates a polarization manner of a neighboring cell of a cell in which the terminal device in the inactive state is located, that is, indicates the polarization manner used in response to the terminal device in the inactive state measuring signal quality of the neighboring cell during cell handover and is switched to the connected state.

In response to the second indication information being carried in RRCReconfiguration or RRCResume, the second indication information is, for example, an RRC information element (radio resource control information element, RRC IE) carried in RRCReconfiguration or RRCResume. Specifically, the second indication information is an SSB frequency (ssbFrequency) field in a measurement object new radio (MeasObjectNR) in the RRC IE, and the ssbFrequency field indicates the polarization manner of the neighboring cell of the cell in which the terminal device is located.

During implementation, the network device configures, for the terminal device in advance, a correspondence between a reference signal (reference signal, RS) measurement frequency of the neighboring cell in the ssbFrequency field and the polarization manner of the neighboring cell, and then send the RS measurement frequency of the neighboring cell to the terminal device in the ssbFrequency field, to indicate the polarization manner of the neighboring cell of the cell in which the terminal device is located. The RS herein is an SSB or a CSI-RS. This is not limited herein.

The network device configures, for the terminal device in a polarization configuration (polarCongfig) field, the correspondence between the RS measurement frequency of the neighboring cell in the ssbFrequency field and the polarization manner of the neighboring cell. For example, Table 19 shows a correspondence between an RS measurement frequency of a neighboring cell in an ssbFrequency field and a polarization manner of the neighboring cell. Refer to Table 19. In response to the polarization manner of the neighboring cell of the cell in which the terminal device being located is left hand circular polarization, the network device sends, to the terminal device in the ssbFrequency field, the RS measurement frequency F0 of the neighboring cell, to indicate that the polarization manner of the neighboring cell of the cell in which the terminal device is located is left hand circular polarization. In Table 19, an object is a to-be-measured object, and the to-be-measured object is a cell or a beam. This is uniformly described herein, and is not limited below.

TABLE 19

| | RS | |
|---|---|---|
| | measurement | |
| | frequency of | |
| | a neighboring | |
| | cell in an | |
| Object | ssbFrequency | |
| (object) | field | Indication |
| To-be- | F0 | A measured polarization manner of the |
| measured | | to-be-measured object 0 includes left |
| object 0 | | hand circular polarization, and right |
| | | hand circular polarization. |
| To-be- | F1 | A measured polarization manner of the |
| measured | | to-be-measured object 1 includes none. |
| object 1 | | |
| To-be- | F2 | A measured polarization manner of the |
| measured | | to-be-measured object 2 includes left |
| object 2 | | hand circular polarization and right |
| | | hand circular polarization cross |
| | | polarization multiplexing. |

In response to configuring the correspondence between the RS measurement frequency of the neighboring cell in the ssbFrequency field and the polarization manner of the neighboring cell for the terminal device, the network device further adds or deletes a correspondence. For example, in Table 19, the network device deletes, from Table 19 by using a polar removal list (polarToRemoveList), the correspondence of “right hand circular polarization” indicated by “F0”. The network device adds, by using a polar addition list (polarToAddList), a correspondence between an RS measurement frequency of a neighboring cell and a polarization manner of the neighboring cell to Table 19. Refer to a correspondence between “F1” and “right hand circular polarization” in the following Table 20.

TABLE 20

| | RS | |
|---|---|---|
| | measurement | |
| | frequency of | |
| | a neighboring | |
| | cell in an | |
| Object | ssbFrequency | |
| (object) | field | Indication |
| To-be- | F0 | A measured polarization manner of the to- |
| measured | | be-measured object 0 includes left hand |
| object 0 | | circular polarization. |
| To-be- | F1 | A measured polarization manner of the to- |
| measured | | be-measured object 1 includes right hand |
| object 1 | | circular polarization. |
| To-be- | F2 | A measured polarization manner of the to- |
| measured | | be-measured object 2 includes left hand |
| object 2 | | circular polarization and right hand |
| | | circular polarization cross polarization |
| | | multiplexing. |

In this way, based on the second indication information, the terminal device in the connected state or the inactive state obtains in advance the polarization manner of the neighboring cell, that is, obtains in advance the polarization manner used in response to the signal quality of the neighboring cell being used. In this case, during cell handover, the terminal device measures the signal quality of the neighboring cell based on the polarization manner of the neighboring cell indicated by the second indication information, and implements cell handover. This improves a speed and precision of measuring a signal of the neighboring cell by the terminal device, quickly and accurately feed back a measurement result, improve a cell handover success rate, reduce a probability of initiating cell reselection due to a radio link failure (radio link failure, RLF), avoid requesting a polarization manner of the neighboring cell from the network device again during the handover, and accelerate cell handover.

Optionally, the second indication information further indicates a polarization manner of a neighboring cell of a cell in which the terminal device in a second status is located, the second status includes an inactive state or an idle state, and the second indication information is carried in cell-level information.

Refer to FIG. 13, for the terminal device in the inactive state or the idle state, the second indication information is carried in a SIB, and an SIB index (SIB X) indicates the polarization manner of the neighboring cell of the cell in which the terminal device is located. A value of “X” in the SIB X is any one of 0 to 14. With development of communication technologies, X is more values. A value of X is not limited in at least one embodiment. For example, an SIB 4 or an SIB 11 indicates the polarization manner of the neighboring cell of the cell in which the terminal device is located.

For example, the polarization manner of the neighboring cell of the cell in which the terminal device is located is indicated by using a measurement idle carrier list new radio (measIdleCarrierListNR) in the SIB 11 or an inter frequency carrier frequency list (interFreqCarrierFreqList) in the SIB 4.

During implementation, measIdleCarrierListNR in the SIB 11 or interFreqCarrierFreqList in the SIB 4 is used to indicate a measurement frequency of an RS (including a CSI-RS and an SSB) of the neighboring cell, and the measurement frequency corresponds to the to-be-measured cell. A polarization indication field is added to a measIdleConfigSIB field or another field in the SIB 11, or a polarization indication field is added to the SIB 4, to indicate the polarization manner. The polarization indication field indicates a list including added and removed polarization manners, or is an arrangement group of different polarization measurement manners indicated by using a separate field.

The current cell obtains, based on the second indication information, polarization and RS information of the neighboring cell through an Xn interface between core networks or gNodeBs or in a manner of internal communication of the gNodeB, to indicate, to UE in different RRC states covered by the current cell, how to measure the signal quality of the neighboring cell.

In this way, based on the second indication information, the terminal device in the inactive state or the idle state obtains the polarization manner of the neighboring cell in advance, that is, obtains, in advance, the polarization manner used in response to the signal quality of the neighboring cell being measured. In this case, during cell reselection, the terminal device measures the signal quality of the neighboring cell based on the polarization manner of the neighboring cell indicated by the second indication information, and then implements cell reselection. This improves a cell reselection success rate, avoid requesting the polarization manner of the neighboring cell from the network device again during reselection, and accelerates cell reselection.

S1202: The network device sends the second indication information to the terminal device. Correspondingly, the terminal device receives the second indication information from the network device.

Optionally, after S1202, the communication method shown in FIG. 12 further includes the following step:

S1203: In response to performing cell handover, the terminal device performs cell handover based on the second indication information.

In S1201 to S1203, based on the second indication information, the terminal device obtains the polarization manner of the neighboring cell in advance, that is, obtains, in advance, the polarization manner used in response to the signal quality of the neighboring cell being measured. In this case, during cell handover, the terminal device measures the signal quality of the neighboring cell based on the polarization manner of the neighboring cell indicated by the second indication information, and then implements cell handover. This improves a cell handover success rate, avoid requesting the polarization manner of the neighboring cell again from the network device during handover, and accelerates cell handover.

At least one embodiment implements a network device that sends a polarization manner of an adjacent beam to the terminal device, thereby accelerating adjacent beam handover of the terminal device.

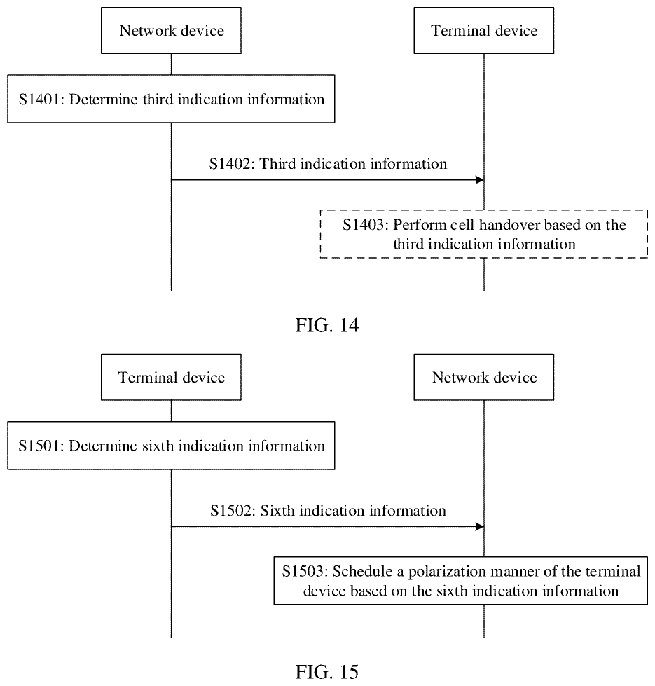

To accelerate beam handover, embodiments described herein further provide a communication method. FIG. 14 is a schematic flowchart 5 of the communication method according to at least one embodiment. The method includes S1401 to S1403, which are sequentially described below.

S1401: The network device determines third indication information.

The third indication information indicates the polarization manner of the adjacent beam of a beam on which the terminal device is located. In other words, the third indication information indicates the polarization manner for signal measurement on the adjacent beam of the beam on which the terminal device is located.

The polarization manner of the adjacent beam includes one or more of left hand circular polarization, right hand circular polarization, linear polarization, or cross polarization multiplexing. The beam on which the terminal device is located directly obtains have one or more adjacent beams. In response to the beam on which the terminal device being located has one adjacent beam, the polarization manner of the adjacent beam includes any one of left hand circular polarization, right hand circular polarization, linear polarization, or cross polarization multiplexing. In response to the beam on which the terminal device being located has a plurality of adjacent beams, the polarization manners of the adjacent beams include one or more of left hand circular polarization, right hand circular polarization, linear polarization, or cross polarization multiplexing.

The third indication information is also referred to as indication information of the polarization manner of the adjacent beam. This is not limited herein.

Optionally, a manner in which the network device determines the third indication information includes: The network device determines the beam on which the terminal device is located; and obtains a polarization manner of at least one adjacent beam around the beam on which the terminal device is located, and generates the third indication information. In other words, the third indication information indicates a polarization manner of at least one adjacent beam around the beam on which the terminal device is located.

Optionally, the third indication information is carried in DCI, a MAC CE, or RRC. This is not limited herein. The third indication information is carried in a DCI format, a MAC CE index, or an RRC IE.

For example, the third indication information is carried in the RRC IE.

For example, the third indication information is added to CSI-MeasConfig in the RRC IE. In this manner, one piece of the third indication information indicates polarization manners of a plurality of adjacent beams. Bits are reduced.

For another example, the third indication information is added to CSI-SSB-ResourceSet in the RRC IE.

For still another example, the third indication information is added to NZP-CSI-RS-Resource or NZP-CSI-RS-ResourceSet.

During application, the third indication information further indicates that information indicated by the third indication information takes effect; or the third indication information further indicates that information indicated by the third indication information does not take effect, and the network device indicates, by using other information (for example, RRC, DCI, or a MAC CE), that the information indicated by the third indication information takes effect. This is not limited herein.

S1402: The network device sends the third indication information to the terminal device. Correspondingly, the terminal device receives the third indication information from the network device.

Optionally, after S1402, the communication method shown in FIG. 14 further includes the following step:

S1403: In response to performing beam handover, the terminal device performs beam handover based on the third indication information.

In S1401 to S1403, based on the third indication information, the terminal device obtains the polarization manner of the adjacent beam in advance, that is, obtains, in advance, the polarization manner used in response to the signal quality of the adjacent beam being measured. Therefore, during beam handover, the terminal device measures the signal quality of the adjacent beam based on the polarization manner of the adjacent beam indicated by the third indication information, and then implements beam handover. This improves a beam handover success rate, avoids requesting a polarization manner of the adjacent beam again from the network device during handover, and accelerates beam handover.

At least one embodiment implements a terminal device that actively requests a network device to schedule a polarization manner of the terminal device.

FIG. 15 is a schematic flowchart 6 of a communication method according to at least one embodiment. The method includes S1501 to S1503, which are sequentially described below.

S1501: The terminal device determines sixth indication information.

The sixth indication information indicates a fourth polarization manner expected (or desired) by the terminal device. In other words, the sixth indication information indicates that the terminal device desires to switch a polarization manner to a fourth polarization manner; or the sixth indication information indicates that the terminal device desires to work in a fourth polarization manner; or the sixth indication information indicates that a polarization manner desired by the terminal device is a fourth polarization manner. Unless otherwise specified, meanings to be expressed in the several manners of expressing the sixth indication information are consistent, and is mixed.

The fourth polarization manner includes any one of left hand circular polarization, right hand circular polarization, linear polarization, or cross polarization multiplexing.

S1502: The terminal device sends the sixth indication information to the network device. Correspondingly, the network device receives the sixth indication information from the terminal device.

S1503: The network device schedules the polarization manner of the terminal device based on the sixth indication information.

For an implementation of S1503, refer to the foregoing Manner 4. Details are not described herein again.

That the terminal device determines the sixth indication information in S1501 is implemented in the following Manner 25 to Manner 29, which are sequentially described below.

Manner 25: The terminal device determines the sixth indication information based on a polarization manner supported by the terminal device.

Manner 26: The terminal device determines the sixth indication information based on CSI of channels in different polarization manners measured by the terminal device.

In Manner 26, in response to channel quality in one polarization manner being poorer than channel quality in another polarization manner, the polarization manner with better channel quality is used as the fourth polarization manner, so that the terminal device applies to the network device for switching to the polarization manner with the better channel quality, thereby improving communication efficiency. In Manner 26, in response to a service usage of the terminal device being large and channel quality of polarization multiplexing is good, the terminal device further applies to the network device for enabling polarization multiplexing, thereby improving a throughput of the terminal device. In Manner 26, in response to in two orthogonally polarization manners (denoted as A and B) currently used by the terminal device, channel quality of A being poor, the terminal device applies to the network device for working in B, where channel quality of B is better, thereby improving communication efficiency of the terminal device.

Manner 27: The terminal device determines the sixth indication information based on a service usage of the terminal device.

In Manner 27, in response to the service usage of the terminal device being large, the terminal device applies to the network device for enabling polarization multiplexing, thereby improving a throughput of the terminal device. In response to the service usage of the terminal device being small, the terminal device applies to the network device for disabling polarization multiplexing, thereby further reducing power consumption of the terminal device.

Manner 28: The terminal device determines the sixth indication information based on weather information.

In Manner 28, in response to the terminal device working in cross polarization multiplexing, and weather on a signal propagation path between the network device and the terminal device is poor, the terminal device applies to the network device for working in a single polarization manner (for example, left hand circular polarization), thereby reducing signal interference and improving communication quality.

Manner 29: The terminal device determines the sixth indication information based on a crosstalk status between orthogonally polarized channels.

In Manner 29, in response to crosstalk between the orthogonally polarized channels between the network device and the terminal device being severe, the terminal device applies to the network device for limiting a polarization manner to a single polarization manner, thereby reducing signal interference and improving communication quality. In response to crosstalk between the orthogonally polarized channels between the network device and the terminal device not being severe, the terminal device applies to the network device for adjusting a polarization manner to cross polarization multiplexing, thereby improving a throughput.

For a specific implementation of determining the sixth indication information in the foregoing Manner 25 to Manner 29, refer to that of determining the first indication information in the foregoing Manners 1, 2, 3, 5, and 6. A difference lies in that the first indication information is determined by the network device, and the sixth indication information is determined by the terminal device. Details are not described herein.

In at least one embodiment, in response to a trigger condition being met, the terminal device determines the sixth indication information based on the trigger condition. The trigger condition includes any one of the foregoing Manner 25 to Manner 29, and the trigger condition triggers the terminal device to apply to the network device for scheduling the polarization manner of the terminal device. In other words, in response to the trigger condition being met, the terminal device determines the sixth indication information based on a process corresponding to the condition that is met, and then apply to the network device for scheduling the polarization manner of the terminal device.

In this way, the terminal device discovers a problem in the polarization manner of the terminal device in time, and apply to the network device in time for adjusting the polarization manner of the terminal device, so that scheduling of the polarization manner of the terminal device is more flexible, thereby improving spectral efficiency.

The foregoing Manner 25 to Manner 29 is separately implemented, or is implemented in combination. This is not limited in at least one embodiment. Similarly, for a specific example, refer to the foregoing Examples 3 and 4. Details are not described herein again. With reference to the foregoing descriptions of Manner 25 to Manner 29, the terminal device determines the sixth indication information based on one or more of the polarization manner supported by the terminal device, the CSI of the channels in the different polarization manners measured by the terminal device, the service usage of the terminal device, the polarization manner expected by the terminal device, the weather condition between the terminal devices, and the crosstalk status between the orthogonally polarized channels. In other words, the sixth indication information is determined based on one or more of the following: the polarization manner supported by the terminal device, the CSI of the channels in the different polarization manners measured by the terminal device, the service usage of the terminal device, the polarization manner expected by the terminal device, the weather condition between the terminal devices, or the crosstalk status between the orthogonally polarized channels.

In Manner 25 to Manner 29, the terminal device determines, with reference to a plurality of types of information, a polarization manner that is more appropriate for the terminal device, and apply to the network device by using the sixth indication information for scheduling the polarization manner for the terminal device. This enables, in one aspect, the terminal device to work in a better polarization manner, improve communication quality, and reduce power consumption, in another aspect, scheduling of the polarization manner for the terminal device is more flexible, and a scheduling granularity is finer, thereby improving spectral efficiency.

Optionally, the sixth indication information further indicates duration of the fourth polarization manner.

The duration of the fourth polarization manner is understood as a time length in which the terminal device expects to continuously work in the fourth polarization manner. The duration of the fourth polarization manner is also referred to as a timer of the fourth polarization manner. In response to the timer expiring, the terminal device restores a default polarization manner of a cell broadcast by the network device.

In this way, the terminal device applies to the network device for the duration in which the terminal device works in the fourth polarization manner. After the duration indicated by the sixth indication information expires, the terminal device restores to a previous polarization manner. Therefore, the network device no longer indicates, by using one piece of indication signaling, the terminal device to restore to the previous polarization manner. This reduces signaling overheads, avoids the network device waiting for a long time for feedback of the terminal device on the indication signaling, and further improves flexibility of scheduling the polarization manner of the terminal device.

For an implementation in which the sixth indication information indicates the duration of the fourth polarization manner, refer to the description of the “implementation in which the first indication information indicates the duration of the first polarization manner” in the method embodiment shown in FIG. 6, for example, Manner 7 and Manner 8. Details are not described herein again.

Optionally, in response to a twenty-seventh condition being met, the terminal device determines cross polarization multiplexing as the fourth polarization manner; and the terminal device further obtains first service usage time of the terminal device, and determine the sixth indication information based on the first service usage time. The sixth indication information indicates that the polarization manner expected by the terminal device is the fourth polarization manner (namely, cross polarization multiplexing), and the sixth indication information further indicates the duration of the fourth polarization manner. The duration of the fourth polarization manner is greater than (or ≥) the first service usage time.

The twenty-seventh condition includes: A current polarization manner of the terminal device is a single polarization manner, and a throughput of the terminal device is greater than (or ≥) a first throughput threshold. The first service usage time is time in which the throughput of the terminal device is continuously greater than (or ≥) the first throughput threshold. For example, in response to time in which the throughput of the terminal device being continuously greater than the first throughput threshold in a future period of time is 10s, the first service usage time is 10s. A service throughput of the terminal device in the future 10s is large.

For example, the polarization manners supported by the terminal device include a left hand circular polarization manner, a right hand circular polarization manner, and left hand circular polarization and right hand circular polarization cross polarization multiplexing. In response to the polarization manner of the terminal device being the left hand circular polarization manner, and the throughput of the terminal device is greater than the first throughput threshold (that is, the twenty-seventh condition is met), the terminal device determines that left hand circular polarization and right hand circular polarization cross polarization multiplexing is the fourth polarization manner. The terminal device further obtains the first service usage time of the terminal device. The first service usage time is 10s, the terminal device determines the sixth indication information based on the first service usage time, where the sixth indication information indicates that the polarization manner expected by the terminal device is left hand circular polarization and right hand circular polarization cross polarization multiplexing, and the sixth indication information further indicates that the duration in which the terminal device expects to work in left hand circular polarization and right hand circular polarization cross polarization multiplexing is 10s.

In this way, after the duration indicated by the sixth indication information expires, the terminal device returns from cross polarization multiplexing to the single polarization manner, so that the terminal device automatically disables cross polarization multiplexing in response to the first service usage time of the terminal device ending, thereby reducing power consumption and releasing an air interface resource. In addition, the network device no longer indicates, by using one piece of indication signaling, the terminal device to restore to the previous polarization manner. This reduces signaling overheads, and avoids the network device waiting for a long time for feedback of the terminal device on the indication signaling.

Optionally, in response to a twenty-eighth condition being met, the terminal device determines that a single polarization manner is the fourth polarization manner; and the terminal device further obtains second service usage time of the terminal device, and determine the sixth indication information based on the second service usage time. The sixth indication information indicates that the polarization manner expected by the terminal device is the fourth polarization manner (namely, the single polarization manner), and the sixth indication information further indicates the duration of the fourth polarization manner. The duration of the fourth polarization manner is greater than (or ≥) the second service usage time.

The twenty-eighth condition includes: A current polarization manner of the terminal device is cross polarization multiplexing, and a throughput of the terminal device is less than (or ≤) a third throughput threshold. The second service usage time is time in which the throughput of the terminal device is continuously less than (or ≤) the third throughput threshold. For example, in response to time in which the throughput of the terminal device being continuously less than the first throughput threshold in a future period of time being 10s, the second service usage time is 10s. A service throughput of the terminal device in the future 10s is small.

For example, the polarization manners supported by the terminal device include a left hand circular polarization manner, a right hand circular polarization manner, and left hand circular polarization and right hand circular polarization cross polarization multiplexing. In response to the polarization manner of the terminal device being left hand circular polarization and right hand circular polarization cross polarization multiplexing, and the throughput of the terminal device is less than the third throughput threshold (that is, the twenty-eighth is met), the terminal device determines that the left hand circular polarization manner is the fourth polarization manner. The terminal device further obtains the second service usage time of the terminal device. The second service usage time is 10s, the terminal device determines the sixth indication information based on the second service usage time, where the sixth indication information indicates that the polarization manner expected the terminal device is the left hand circular polarization manner, and the sixth indication information further indicates that the duration in which the terminal device expects to work in the left hand circular polarization manner is 10s.

In this way, after the duration indicated by the sixth indication information expires, the terminal device returns from the single polarization manner to cross polarization multiplexing, so that the terminal device automatically wakes up cross polarization multiplexing in response to the second service usage time of the terminal device ending, thereby improving the throughput. In addition, the network device no longer indicates, by using one piece of indication signaling, the terminal device to restore to the previous polarization manner. This reduces signaling overheads, avoids the network device waiting for a long time for feedback of the terminal device on the indication signaling, and accelerates scheduling of the network device.

In at least one embodiment, in response to the sixth indication information further indicating the duration of the fourth polarization manner, in response to receiving the sixth indication information, the network device performs explicit acknowledge or implicit acknowledge on the sixth indication information, which is sequentially described below.

Explicit acknowledgment: The network device sends acknowledgment information (for example, an acknowledgment (acknowledgment, ACK) message or a negative acknowledgment (negative acknowledgment, NACK) message) to the terminal device, to indicate that the sixth indication information is received.

Implicit acknowledgment: In response to receiving the sixth indication information, the network device communicates with the terminal device in the fourth polarization manner indicated by the sixth indication information.

In at least one embodiment, in a case of the explicit acknowledgment, start time of the duration of the fourth polarization manner is time at which the network device sends the acknowledgment information to the terminal device.

In a case of the implicit acknowledgment, for downlink, in response to the terminal device receiving a data packet from the network device in the fourth polarization manner, the network device performs implicit acknowledgment, and start time of the duration of the fourth polarization manner is time at which a first data packet from the network device is received in the fourth polarization manner; and for uplink, the terminal device sends a data packet (denoted as an uplink data packet) to the network device in the fourth polarization manner, in response to the terminal device receiving acknowledgment information (for example, ACK or NACK) fed back by the network device for the uplink data packet, the network device performs implicit acknowledgment, and start time of the duration of the fourth polarization manner is sending time of the uplink data packet corresponding to the acknowledgment information fed back by the network device for the uplink data packet.

In at least one embodiment, the sixth indication information is carried in any one of RRC signaling, a MAC CE, a CSI-RS, and uplink control information (uplink control information, UCI).

In FIG. 15, the terminal device applies to the network device for adjusting the polarization manner. This flexibly adjusts the polarization manner of the terminal device, enables the terminal device to work in a better polarization manner, and improves spectral efficiency of the polarization manner of the terminal device.

In at least one embodiment, the communication methods shown in FIG. 6, FIG. 10 to FIG. 12, and FIG. 14 are separately implemented, or are implemented in combination. This is not limited herein.

The first polarization indication information to the fifth polarization indication information is implemented in a same field, or is implemented in different fields. This is not limited herein.

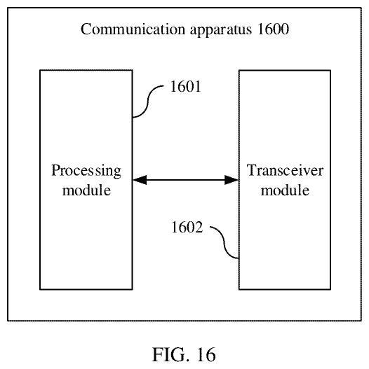

With reference to FIG. 6 to FIG. 15, the foregoing describes the communication methods provided in at least one embodiment in detail. The following describes, in detail with reference to FIG. 16, a communication apparatus configured to perform the communication methods provided in at least one embodiment.

As shown in FIG. 16, at least one embodiment provides a communication apparatus 1600. The communication apparatus 1600 is a terminal or a network device, is an apparatus in the terminal device or the network device, or is an apparatus that is used together with the terminal device or the network device. In at least one embodiment, the communication apparatus 1600 includes modules or units that are in a one-to-one correspondence with the methods/operations/steps/actions performed by the first communication apparatus or the second communication apparatus in the foregoing method embodiments. The unit is implemented by a hardware circuit, software, or a combination of a hardware circuit and software. In at least one embodiment, the communication apparatus 1600 includes a processing module 1601 and a transceiver module 1602. For ease of description, FIG. 16 shows only main components of the communication apparatus.

In some embodiments, the communication apparatus 1600 is applied to the communication system shown in FIG. 3, and performs functions of the network device in the communication methods shown in FIG. 6, FIG. 10 to FIG. 12, FIG. 13, and FIG. 15.

The processing module 1601 is configured to determine first indication information, where the first indication information is carried in terminal-level information, the first indication information indicates a first polarization manner of a first communication apparatus, and the first polarization manner includes any one of left hand circular polarization, right hand circular polarization, linear polarization, or cross polarization multiplexing. The transceiver module 1602 is configured to send the first indication information.

In at least one embodiment, the processing module 1601 is further configured to determine second indication information, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing. The transceiver module 1602 is further configured to send the second indication information.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information. Optionally, the cell-level information is an SIB.

In at least one embodiment, the first indication information includes a mapping relationship between a plurality of SSB indexes and a plurality of polarization manners.

In at least one embodiment, the first indication information further indicates duration of the first polarization manner.

In at least one embodiment, the first indication information is determined based on one or more of the following: a polarization manner supported by the first communication apparatus, CSI of channels in different polarization manners measured by the first communication apparatus, a service usage of the first communication apparatus, a polarization manner expected by the first communication apparatus, a weather condition between the first communication apparatus and a second communication apparatus, or a crosstalk status between orthogonally polarized channels.

In at least one embodiment, the terminal-level information is RRC signaling.

Optionally, the terminal-level information is alternatively any one of a MAC CE, a CSI-RS, DCI, or the like.

In at least one embodiment, the first indication information is one or more of a carrier of the CSI-RS and an RE, and the one or more of the carrier and the resource element indicate the first polarization manner.

In at least one embodiment, the processing module 1601 is further configured to determine third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing. The transceiver module 1602 is further configured to send the third indication information.

In at least one embodiment, the first indication information indicates a first polarization manner corresponding to a first resource of the first communication apparatus, and the first resource includes a time-frequency domain resource.

In some other embodiments, the communication apparatus 1600 is applied to the communication system shown in FIG. 3, and performs functions of the terminal device in the communication methods shown in FIG. 6, FIG. 10 to FIG. 12, FIG. 13, and FIG. 15.

The transceiver module 1602 is configured to receive first indication information from a second communication apparatus, where the first indication information indicates a first polarization manner of a first communication apparatus, the first polarization manner includes any one of left hand circular polarization, right hand circular polarization, linear polarization, or cross polarization multiplexing, and the first indication information is carried in terminal-level information. The processing module 1601 is configured to communicate with the second communication apparatus in the first polarization manner.

In at least one embodiment, the transceiver module 1602 is further configured to receive second indication information from the second communication apparatus, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information. Optionally, the cell-level information is an SIB.

In at least one embodiment, the first indication information includes a mapping relationship between a plurality of SSB indexes and a plurality of polarization manners.

In at least one embodiment, the first indication information further indicates duration of the first polarization manner.

In at least one embodiment, the first indication information is determined based on one or more of the following: a polarization manner supported by the first communication apparatus, channel state information of channels in different polarization manners measured by the first communication apparatus, a service usage of the first communication apparatus, a polarization manner expected by the first communication apparatus, a weather condition between the first communication apparatus and the second communication apparatus, or a crosstalk status between orthogonally polarized channels.

In at least one embodiment, the terminal-level information is RRC signaling.

Optionally, the terminal-level information is alternatively any one of a MAC CE, a CSI-RS, DCI, or the like.

In at least one embodiment, the transceiver module 1602 is further configured to receive third indication information from the second communication apparatus, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing.

In at least one embodiment, the first indication information indicates a first polarization manner corresponding to a first resource of the first communication apparatus, and the first resource includes a time-frequency domain resource.

In some still another embodiments, the communication apparatus 1600 is applied to the communication system shown in FIG. 3, and performs functions of the network device in the communication methods shown in FIG. 6, FIG. 10 to FIG. 12, FIG. 13, and FIG. 15.

The processing module 1601 is configured to determine fourth indication information, where the fourth indication information indicates a second polarization manner of a first beam, and the second polarization manner includes any one of left hand circular polarization, right hand circular polarization, linear polarization, or cross polarization multiplexing. The transceiver module 1602 is configured to send the fourth indication information.

In at least one embodiment, the fourth indication information includes an SSB index, and the SSB index corresponds to the second polarization manner; or the fourth indication information includes a CSI-RS time-frequency location, and the CSI-RS time-frequency location corresponds to the second polarization manner.

In at least one embodiment, the transceiver module 1602 is further configured to send a first mapping relationship, where the first mapping relationship includes a mapping relationship between at least one SSB index and at least one polarization manner, or the first mapping relationship includes a mapping relationship between at least one CSI-RS time-frequency location and at least one polarization manner.

In at least one embodiment, the fourth indication information is carried in any one of RRC, DCI, or a MAC CE.

In at least one embodiment, the processing module 1601 is further configured to determine second indication information, where the second indication information indicates a polarization manner of a neighboring cell of a cell in which a first communication apparatus is located, and the polarization manner of the neighboring cell includes one or more of left hand circular polarization, right hand circular polarization, linear polarization, or cross polarization multiplexing. The transceiver module 1602 is further configured to send the second indication information.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information.

In at least one embodiment, the fourth indication information further indicates duration of the second polarization manner.

In at least one embodiment, the fourth indication information is determined based on one or more of the following: polarization manners supported by all first communication apparatuses in the first beam, channel state information of channels in different polarization manners measured by all the first communication apparatuses in the first beam, service usages of all the first communication apparatuses in the first beam, polarization manners expected by all the first communication apparatuses in the first beam, a weather condition in a coverage area of the first beam, or a crosstalk status between all orthogonally polarized channels in the first beam.

In at least one embodiment, the processing module 1601 is further configured to determine third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing. The transceiver module 1602 is further configured to send the third indication information.

In some yet another embodiments, the communication apparatus 1600 is applied to the communication system shown in FIG. 3, and performs functions of the terminal device in the communication methods shown in FIG. 6, FIG. 10 to FIG. 12, FIG. 13, and FIG. 15.

The transceiver module 1602 is configured to receive fourth indication information from a second communication apparatus, where the fourth indication information indicates a second polarization manner of a first beam, and the second polarization manner includes any one of left hand circular polarization, right hand circular polarization, linear polarization, or cross polarization multiplexing. The processing module 1601 is configured to communicate with the second communication apparatus based on the second polarization manner.

In at least one embodiment, the fourth indication information includes an SSB index, and the SSB index corresponds to the second polarization manner; or the fourth indication information includes a CSI-RS time-frequency location, and the CSI-RS time-frequency location corresponds to the second polarization manner.

In at least one embodiment, the transceiver module 1602 is further configured to receive second indication information from the second communication apparatus, where the second indication information indicates a polarization manner of a neighboring cell of a cell in which a first communication apparatus is located, and the polarization manner of the neighboring cell includes one or more of left hand circular polarization, right hand circular polarization, linear polarization, or cross polarization multiplexing.

In at least one embodiment, the fourth indication information is carried in any one of RRC, DCI, or a MAC CE.

In at least one embodiment, the transceiver module 1602 is further configured to receive second indication information from the second communication apparatus, where the second indication information indicates a polarization manner of a neighboring cell of a cell in which the first communication apparatus is located, and the polarization manner of the neighboring cell includes one or more of left hand circular polarization, right hand circular polarization, linear polarization, or cross polarization multiplexing.

Optionally, the second indication information further indicates a polarization manner of a neighboring cell of a cell in which the first communication apparatus in a first status is located, the first status includes a connected state or an inactive state, and the second indication information is carried in terminal-level information.

Optionally, the second indication information further indicates a polarization manner of a neighboring cell of a cell in which the first communication apparatus in a second status is located, the second status includes an inactive state or an idle state, and the second indication information is carried in cell-level information.

In at least one embodiment, the fourth indication information further indicates duration of the second polarization manner.

In at least one embodiment, the fourth indication information is determined based on one or more of the following: polarization manners supported by all first communication apparatuses in the first beam, channel state information of channels in different polarization manners measured by all the first communication apparatuses in the first beam, service usages of all the first communication apparatuses in the first beam, polarization manners expected by all the first communication apparatuses in the first beam, a weather condition in a coverage area of the first beam, or a crosstalk status between all orthogonally polarized channels in the first beam.

In at least one embodiment, the transceiver module 1602 is further configured to receive third indication information, where the third indication information indicates a polarization manner of an adjacent beam of a beam on which the first communication apparatus is located, and the polarization manner of the adjacent beam includes one or more of left hand circular polarization, right hand circular polarization, linear polarization, or cross polarization multiplexing.

Optionally, the transceiver module 1602 includes a receiving module and a sending module (not shown in FIG. 16). The sending module is configured to implement a sending function of the communication apparatus 1600, and the receiving module is configured to implement a receiving function of the communication apparatus 1600.

Optionally, the communication apparatus 1600 further includes a storage module (not shown in FIG. 16), and the storage module stores a program or instructions. In response to the processing module 1601 executing the program or the instructions, the communication apparatus 1600 performs a function of the terminal device or the network device in the communication method shown in any one of FIG. 6, FIG. 10 to FIG. 12, FIG. 13, and FIG. 15.

The processing module 1601 in the communication apparatus 1600 is implemented by a processor or a processor-related circuit component, and is a processor or a processing unit; and the transceiver module 1602 is implemented by a transceiver or a transceiver-related circuit component, and is a transceiver or a transceiver unit.

The communication apparatus 1600 is a terminal device or a network device, or is a chip (system) or another part or component disposed in the terminal device or the network device, or is an apparatus including the terminal device or the network device. This is not limited in at least one embodiment. The terminal device is configured to perform the communication method according to at least one embodiment in FIG. 6, FIG. 10 to FIG. 12, FIG. 13, and FIG. 15. The network device is configured to perform the communication method according to at least one embodiment in FIG. 6, FIG. 10 to FIG. 12, FIG. 13, and FIG. 15.

In addition, for technical effect of the communication apparatus 1600, refer to technical effect of the communication method shown in any one of FIG. 6, FIG. 10 to FIG. 12, FIG. 13, and FIG. 15. Details are not described herein again.

In response to the communication apparatus 1600 provided in at least one embodiment being the chip, the transceiver module 1602 in the communication apparatus 1600 separately corresponds to input and output of the chip. For example, the receiving module in the transceiver module 1602 corresponds to input of the chip, and the sending module in the transceiver module 1602 corresponds to output of the chip. This is not limited in at least one embodiment.

At least one embodiment further provides a chip system, including a processor, where the processor is coupled to a memory. The memory is configured to store a program or instructions. In response to the program or the instructions being executed by the processor, the chip system is enabled to implement the method according to any one of the foregoing method embodiments.

Optionally, there is one or more processors in the chip system. The processor is implemented by using hardware, or is implemented by using software. In response to the processor being implemented by using the hardware, the processor is a logic circuit, an integrated circuit, or the like. In response to the processor being implemented by using the software, the processor is a general-purpose processor, and is implemented by reading software code stored in the memory.

Optionally, there is also one or more memories in the chip system. The memory is integrated with the processor, or is disposed separately from the processor. This is not limited in at least one embodiment. For example, the memory is a non-transitory processor, for example, a read-only memory ROM. The memory and the processor are integrated into a same chip, or are separately disposed on different chips. A type of the memory and a manner of disposing the memory and the processor are not specifically limited in at least one embodiment.

For example, the chip system is a field programmable gate array (field programmable gate array, FPGA), an ASIC, a system on chip (system on chip, SoC), a CPU, a network processor (network processor, NP), a digital signal processor (digital signal processor, DSP), a microcontroller (micro controller unit, MCU), a programmable controller (programmable logic device, PLD), or another integrated chip.

At least one embodiment provides a communication system. The communication system includes one or more terminal devices and one or more network devices. The terminal device and the network device are combined to perform the foregoing method embodiments. For a specific execution process, refer to the foregoing method embodiments. Details are not described herein again.

At least one embodiment further provides a computer-readable storage medium. The computer-readable storage medium stores a computer program. In response to the computer-readable storage medium being executed by a computer, a function of any one of the foregoing method embodiments is implemented.

At least one embodiment further provides a computer program product. In response to the computer program product being executed by a computer, functions of any one of the foregoing method embodiments are implemented.

In at least one embodiment, the processor is a CPU, or is another general-purpose processor, a DSP, an ASIC, an FPGA or another programmable logic device, a discrete gate or transistor logic device, a discrete hardware component, or the like. The general-purpose processor is a microprocessor, or the processor is any conventional processor, or the like.

The memory in at least one embodiment is a volatile memory or a non-volatile memory, or includes a volatile memory and a non-volatile memory. The non-volatile memory is a ROM, a programmable read-only memory (PROM), an erasable programmable read-only memory (EPROM), an, an EEPROM, or a flash memory. The volatile memory is a RAM, and serves as an external cache. By way of example and not limitation, RAMs in many forms is used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or some of the foregoing embodiments are implemented using software, hardware (for example, circuit), firmware, or any combination thereof. In response to software being used to implement embodiments, all or some of the foregoing embodiments are implemented in a form of a computer program product. The computer program product includes one or more computer instructions or computer programs. In response to the program instructions or the computer programs being loaded and executed on the computer, the procedure or functions according to at least one embodiment are all or partially generated. The computer is a general-purpose computer, a dedicated computer, a computer network, or other programmable apparatuses. The computer instructions are stored in a computer-readable storage medium or are transmitted from a computer-readable storage medium to another computer-readable storage medium. For example, the computer instructions are transmitted from a website, computer, server, or data center to another website, computer, server, or data center in a wired (for example, infrared, radio, and microwave, or the like) manner. The computer-readable storage medium is any usable medium accessible by a computer, or a data storage device, such as a server or a data center, integrating one or more usable media. The usable medium is a magnetic medium (for example, a floppy disk, a hard disk, or a magnetic tape), an optical medium (for example, a DVD), or a semiconductor medium. The semiconductor medium is a solid-state drive.

In at least one embodiment, claims, and accompanying drawings, the terms “first”, “second”, “third”, and the like are intended to distinguish between different objects but do not limit a particular order.

The term “and/or” in at least one embodiment describes only an association relationship between associated objects and represents that three relationships exist. For example, A and/or B represents the following three cases: Only A exists, both A and B exist, and only B exists. A and B is singular or plural. In addition, the character “/” in at least one embodiment usually indicates an “or” relationship between the associated objects, but also indicates an “and/or” relationship. For details, refer to the context for understanding.

In at least one embodiment, “at least one” means one or more, and “a plurality of” means two or more. “At least one of the following items (pieces)” or a similar expression thereof indicates any combination of these items, including a single item (piece) or any combination of a plurality of items (pieces). For example, at least one item (piece) of a, b, or c indicates: a, b, c, a and b, a and c, b and c, or a, b, and c, where a, b, and c is singular or plural.

Sequence numbers of the foregoing processes do not mean execution sequences in at least one embodiment. The execution sequences of the processes should be determined according to functions and internal logic of the processes, and should not be construed as any limitation on the implementation processes of at least one embodiment.

A person of ordinary skill in the art is aware that, in combination with the examples described in embodiments disclosed herein, units and algorithm steps are implemented by electronic hardware or a combination of computer software and electronic hardware. Whether the functions are performed by hardware or software depends on particular applications and design constraint conditions of the technical solutions. A person skilled in the art uses different methods to implement the described functions for each particular application, but the implementation should not be considered to go beyond the scope of embodiments described herein.

A person skilled in the art understands that, for the purpose of convenient and brief description, for a detailed working process of the foregoing system, apparatus, and unit, refer to a corresponding process in the foregoing method embodiments. Details are not described herein again.

In the several embodiments provided in at least one embodiment, the disclosed system, apparatus, and method is implemented in other manners. For example, the described apparatus embodiment is merely an example. For example, division into the units is merely logical function division and is other division in actual implementation. For example, a plurality of units or components are combined or integrated into another system, or some features are ignored or not performed. In addition, the displayed or discussed mutual couplings or direct couplings or communication connections is implemented by using some interfaces. The indirect couplings or communication connections between the apparatuses or units are implemented in electronic, mechanical, or other forms.

The units described as separate parts is or is not physically separate, and parts displayed as units is or is not be physical units, is located in one position, or is distributed on a plurality of network units. Some or all of the units are selected based on actual usages to achieve the objectives of the solutions of embodiments.

In addition, functional units in at least one embodiment are integrated into one processing unit, each of the units exists alone physically, or two or more units are integrated into one unit.

In response to the functions being implemented in the form of a software functional unit and sold or used as an independent product, the functions are stored in a computer-readable storage medium. Based on such an understanding, the technical solutions of at least one embodiment essentially, or the part contributing to the conventional technology, or some of the technical solutions is implemented in a form of a software product. The computer software product is stored in a storage medium, and includes several instructions for instructing a computer device (which is a personal computer, a server, or a network device) to perform all or some of the steps of the methods described in at least one embodiment. The foregoing storage medium includes any medium that stores program code, such as a USB flash drive, a removable hard disk, a ROM, a RAM, a magnetic disk, or an optical disc.

The foregoing descriptions are merely specific implementations of at least one embodiment, but are not intended to limit the protection scope of embodiments described herein. Any variation or replacement readily figured out by a person skilled in the art within the technical scope disclosed in at least one embodiment shall fall within the protection scope of the claims. Therefore, the protection scope of at least one embodiment shall be subject to the protection scope of the claims.

What is claimed is:

1. A communication method, comprising:
receiving, by a first communication apparatus, second indication information from a second communication apparatus, wherein the second indication information indicates a polarization manner of a neighboring cell of a cell in which the first communication apparatus in an inactive state is located, the polarization manner of the neighboring cell comprises one or more of left hand circular polarization, right hand circular polarization, linear polarization, or cross polarization multiplexing, and the second indication information is carried in terminal-level information; and
performing, by the first communication apparatus, signal measurement on the neighboring cell based on the second indication information.

2. The method according to claim 1, wherein the method further comprises:
receiving, by the first communication apparatus, fifth indication information from the second communication apparatus, wherein the fifth indication information indicates a third polarization manner of a first cell, and the third polarization manner comprises any one of left hand circular polarization, right hand circular polarization, linear polarization, or cross polarization multiplexing; and
communicating, by the first communication apparatus, with the second communication apparatus in the third polarization manner.

3. The method according to claim 2, wherein the method further comprises:
sending, by the first communication apparatus, sixth indication information to the second communication apparatus, wherein the sixth indication information indicates a fourth polarization manner expected by the first communication apparatus, and the fourth polarization manner comprises any one of left hand circular polarization, right hand circular polarization, linear polarization, or cross polarization multiplexing.

4. The method according to claim 1, wherein the terminal-level information is radio resource control signaling.

5. The method according to claim 4, wherein the radio resource control signaling is radio resource control reconfiguration or radio resource control resume.

6. The method according to claim 5, wherein the second indication information is carried in a MeasConfig field or a MeasObjectNR field in the radio resource control reconfiguration or the radio resource control resume.

7. The method according to claim 2, wherein the fifth indication information is carried in a system information block.

8. A communication method, comprising:
determining, by a second communication apparatus, second indication information, wherein the second indication information indicates a polarization manner of a neighboring cell of a cell in which a first communication apparatus in an inactive state is located, and the polarization manner of the neighboring cell comprises one or more of left hand circular polarization, right hand circular polarization, linear polarization, or cross polarization multiplexing; and
sending, by the second communication apparatus, the second indication information, wherein the second indication information is carried in terminal-level information.

9. The method according to claim 8, wherein the method further comprises:
determining, by the second communication apparatus, fifth indication information, wherein the fifth indication information indicates a third polarization manner of a first cell, and the third polarization manner comprises any one of left hand circular polarization, right hand circular polarization, linear polarization, or cross polarization multiplexing; and
sending, by the second communication apparatus, the fifth indication information.

10. The method according to claim 9, wherein the method further comprises:
receiving, by the second communication apparatus, sixth indication information from the first communication apparatus, wherein the sixth indication information indicates a fourth polarization manner expected by the first communication apparatus, and the fourth polarization manner comprises any one of left hand circular polarization, right hand circular polarization, linear polarization, or cross polarization multiplexing.

11. The method according to claim 8, wherein the terminal-level information is radio resource control signaling.

12. The method according to claim 11, wherein the radio resource control signaling is radio resource control reconfiguration or radio resource control resume.

13. The method according to claim 12, wherein the second indication information is carried in a MeasConfig field or a MeasObjectNR field in the radio resource control reconfiguration or the radio resource control resume.

14. A communication apparatus, at least one processor configured to execute a computer program or executable instructions stored in a memory, wherein the computer program or the executable instructions, when executed by the at least one processor, cause the communication apparatus to perform operations including:
receiving second indication information from a second communication apparatus, wherein the second indication information indicates a polarization manner of a neighboring cell of a cell in which the communication apparatus in an inactive state is located, the polarization manner of the neighboring cell comprises one or more of left hand circular polarization, right hand circular polarization, linear polarization, or cross polarization multiplexing, and the second indication information is carried in terminal-level information; and
performing signal measurement on the neighboring cell based on the second indication information.

15. The communication apparatus according to claim 14, wherein the communication apparatus further comprises:
receiving, fifth indication information from the second communication apparatus, wherein the fifth indication information indicates a third polarization manner of a first cell, and the third polarization manner comprises any one of left hand circular polarization, right hand circular polarization, linear polarization, or cross polarization multiplexing; and
communicating, with the second communication apparatus in the third polarization manner.

16. The communication apparatus according to claim 15, wherein the communication apparatus further comprises:
sending, sixth indication information to the second communication apparatus, wherein the sixth indication information indicates a fourth polarization manner expected by the communication apparatus, and the fourth polarization manner comprises any one of left hand circular polarization, right hand circular polarization, linear polarization, or cross polarization multiplexing.

17. The communication apparatus according to claim 14, wherein the terminal-level information is radio resource control signaling.

18. The communication apparatus according to claim 17, wherein the radio resource control signaling is radio resource control reconfiguration or radio resource control resume.

19. The communication apparatus according to claim 18, wherein the second indication information is carried in a MeasConfig field or a MeasObjectNR field in the radio resource control reconfiguration or the radio resource control resume.

20. The communication apparatus according to claim 15, wherein the fifth indication information is carried in a system information block.
